(19) United States
(12) Patent Application Publication
(10) Pub. No.: US 2010/0204053 A1
(43) Pub. Date: Aug. 12, 2010

(54) ASSAYS FOR THE IDENTIFICATION OF COMPOUNDS THAT MODULATE BONE FORMATION AND MINERALIZATION

(75) Inventor: Laurie H. Glimcher, West Newton, MA (US)

Correspondence Address: LAHIVE & COCKFIELD, LLP;FLOOR 30, SUITE 3000, ONE POST OFFICE SQUARE, BOSTON, MA, 02109, US

(73) Assignee: PRESIDENT AND FELLOWS OF HARVARD COLLEGE, Cambridge, MA (US)

(21) Appl. No.: 12/595,911

(22) PCT Filed: Apr. 24, 2008
(86) PCT No.: PCT/US2008/005280

§ 371 Date: Apr. 15, 2010

Related U.S. Application Data
(60) Provisional application No. 60/926,245, filed on Apr. 26, 2007.

(51) Int. Cl. C40B 30/04

(52) U.S. Cl. 506/9

(57) ABSTRACT

This invention demonstrates that KRC molecules have multiple important functions as modulating agents in regulating a wide variety of cellular processes including bone formation and mineralization. TGF-β signaling in osteoblasts promotes the formation of a multimeric complex between KRC, Runx2, Smad3, and the E3 ubiquitin ligase, WWP1 which inhibits Runx2 function due to the ability of WWP1 to promote Runx2 polyubiquitination and proteasome-dependent degradation. Furthermore, KRC and WWP1 form a complex with RSK2 which inhibits RS K2 function due to the ability of WWP1 to promote RSK2 ubiquitination. Methods for identifying modulators of KRC activity are provided. Methods for modulating an immune response, bone formation and mineralization and KRC-associated disorders using agents that modulate KRC expression and/or activity are also provided.

### RELATED APPLICATIONS

This application claims priority to U.S. Provisional Application No. 60/926,245, filed Apr. 26, 2007, titled “ASSAYS FOR THE IDENTIFICATION OF COMPOUNDS THAT MODULATE BONE FORMATION AND MINERALIZATION”.

This application is related to U.S. Provisional Application No. PCT/US08/02082, filed on Feb. 15, 2008, titled “METHODS FOR MODULATING BONE FORMATION AND MINERALIZATION”. This application is also related to PCT/US2006/014295, filed on Apr. 14, 2006, titled “METHODS FOR MODULATING BONE FORMATION AND MINERALIZATION BY MODULATING KRC ACTIVITY”. This application is also related to PCT/US2004/036641, filed Nov. 3, 2004, which is a continuation-in-part of U.S. application Ser. No. 10/701,401, filed Nov. 3, 2003, which claims the benefit of priority to PCT application PCT/US02/14166, filed May 3, 2002, and U.S. Provisional Application Ser. No. 60/288,369, filed May 3, 2001. The entire contents of each of these applications are incorporated herein by this reference.

### GOVERNMENT FUNDING

Work described herein was supported, at least in part, by the National Institutes of Health (NIH) under grant numbers AI29673, AR46983. The government may have certain rights to this invention.

### BACKGROUND OF THE INVENTION

Transcription factors are a group of molecules within the cell that function to connect the pathways from extracellular signals to intracellular responses. Immediately after an environmental stimulus, these proteins which reside predominantly in the cytosol are translocated to the nucleus where they bind to specific DNA sequences in the promoter elements of target genes and activate the transcription of these target genes. One family of transcription factors, the ZAS (zinc finger-acidic domain structures) DNA binding protein family is involved in the regulation of gene transcription, DNA recombination, and signal transduction (Mak, C. H., et al. 1998. Immunogenetics 48: 32-39).

Zinc finger proteins are identified by the presence of highly conserved Cys2His2 zinc fingers (Mak, C. H., et al. 1998. Immunogenetics 48: 32-39). The zinc fingers are an integral part of the DNA binding structure called the ZAS domain. The ZAS domain is comprised of a pair of zinc fingers, a glutamic acid/aspartic acid-rich acidic sequence and a serine/threonine rich sequence (Mak, C. H., et al. 1998. Immunogenetics 48: 32-39). The ZAS domains have been shown to interact with the kB like cis-acting regulatory elements found in the promoter or enhancer regions of genes. The ZAS proteins recognize nuclear factor kB binding sites which are present in the enhancer sequences of many genes, especially those involved in immune responses (Bachmeyer, et al. 1999. Nuc. Acid Res. 27, 643-648). The ZAS DNA binding proteins have been shown to be transcription regulators of these target genes (Bachmeyer, et al. 1999. Nuc. Acid Res. 27, 643-648; Wu et al. 1998. Science 281, 998-1001).

The zinc finger transcription factor Kappa Recognition Component (“KRC”, also known as schnurri3 or Shn3, and human immunodeficiency virus type I enhancer-binding protein 3 (HIVEP3)) is a member of the ZAS DNA binding family of proteins (Bachmeyer, et al. 1999. Nuc. Acid Res. 27, 643-648; Wu et al. 1998. Science 281, 998-1001). The KRC gene was identified as a DNA binding protein for the heptameric consensus signal sequences involved in somatic V(D)J recombination of the immune receptor genes (Mak, C. H., et al. 1994. Nuc. Acid Res. 22: 383-390). KRC is a substrate for epidermal growth factor receptor kinase and p34cdc2 kinase in vitro (Bachmeyer, et al. 1999. Nuc. Acid Res. 27, 643-648).

In Drosophila, Schnurri (Shn) plays an important role during embryogenesis in the regulation of genes downstream of decapentaplegic (Dpp), a member of the TGF-β superfamily (Arora, K., et al. (1995). Cell 81, 781-790). Ligation of Dpp to its receptors initiates a signal cascade that results in Med, the Drosophila Co-Smad homologue, partnering with Mad, the Drosophila R-Smad homologue (Dai, H., et al. (2000). Dev Biol 227, 373-387). The Mad/Med complex translocates to the nucleus where it interacts with Shn. It has been demonstrated that Shn recruits the necessary transcriptional co-repressors to the Mad/Med complex bound to the regulatory region of Brinker (Brk). Since Brk is a global repressor of Dpp-mediated gene expression, Shn-induced repression of Brk expression thus promotes Dpp's ability to induce expression of target genes (Arora, K., et al. (1995). Cell 81, 781-790; Dai, H., et al. (2000). Dev Biol 227, 373-387; Marty, T., et al. (2000). Nat Cell Biol 2, 745-749).

Although a number of studies have demonstrated that Shn3 regulates the activities of other important transcription proteins, including NF-κB and AP-1, no role for the mammalian Shn genes in TGF-β signaling has yet to be identified (Hong, J. W., et al. (2003). Proc Natl Acad Sci USA 100, 12301-12306; Oukka, M., et al. (2004). J Exp Med 199, 15-24; Oukka, M., et al. (2002). Mol Cell 9, 121-131). Furthermore, the in vivo role(s) of Shn3 remain largely unknown.

Bone is a dynamic tissue whose matrix components are continuously being remodeled to preserve the structural integrity of the skeleton. Bone remodeling is a cyclical process where under normal physiological conditions, bone formation occurs only at sites where bone resorption has previously taken place. Homeostatic remodeling of the skeleton is mediated primarily, if not exclusively, by the osteoclast and the osteoblast (Erlebacher, A., et al. (1995). Cell 80, 371-378). Osteoclasts are giant multinucleated cells of hematopoietic origin that are responsible for bone resorption. Osteoblasts, which originate from mesenchymal stem cells, synthesize the matrix constituents on bone forming surfaces. Proliferation, differentiation and bone remodeling activities of these cells involve a complex temporal network of growth factors, signaling proteins, and transcription factors (Karsenty, G., and Wagner, E. F. (2002). Dev Cell 2, 389-406). Dysregulation of any one component may disrupt the remodeling process and contribute to the pathogenesis of certain skeletal disorders, such as osteoporosis and Paget's disease. Rare single gene disorders resulting in elevated bone mass due to osteoclast defects, collectively termed osteopetrosis, have been identified. Rarer are single gene disorders, exemplified by Camerati-Engelman syndrome, collectively termed osteosclerosis, in which elevated bone mass is due to intrinsically-elevated osteoblast activity (Appendix 2003).

The transcription factor Runx2 is the principal regulator of osteoblast differentiation during embryonic development. It interacts with a number of nuclear transcription factors, coactivators, and adaptor proteins that interpret extracellular signals to ensure homeostatic osteoblast development and activity (Lian, J. B., et al. (2004). Crit Rev Eukaryot Gene Expr 14, 1-41; Stein, G. S., et al. (2004). Oncogene 23, 4315-4329). Mutations in Runx2 cause the human autosomal dominant disease cleidoranial dysplasia (Lee, B., et al. (1997). Nat Genet 16, 307-310; Mundlos, S., et al. (1997). Cell 89, 773-779; Otto, F., et al. (1997). Cell 89, 765-771). Runx2^{-/-} mice exhibit a complete lack of both intramembranous and endochondral ossification, which results in an unmineralized skeleton (Komori, T., et al. (1997). Cell 89, 755-764; Otto, F., et al. (1997). Cell 89, 765-771). In contrast to the significant progress in understanding the molecular mechanisms responsible for osteoblast differentiation during embryonic development, only a small number of genes are known to regulate postnatal osteoblast function (Yoshida, Y., et al. (2000). Cell 103, 1085-1097; Kim, S., et al. (2003). Genes Dev 17, 1979-1991). LRP5, a Wnt coreceptor, is important in the regulation of bone mass in adult humans and rodents (Johnson, M. L., et al. (2004). J Bone Miner Res 19, 1749-1757). Runx2, in addition to its central role in osteoblast differentiation, also regulates mature osteoblast activity in adult mice (Ducy, P., et al. (1999). Genes Dev 13, 1025-1036) in part through its induction of ATF4, another protein demonstrated to be important in postnatal bone formation (Yang, X., et al. (2004). Cell 117, 387-398). TGFβ has a complex function in bone homeostasis mediated in part through the activity of the SMAD3 E3 ligase, Smurf1.

Transforming growth factor-β (TGF-β) has been known for some time to have particular importance in skeletal patterning, bone remodeling and bone matrix formation (Chang, H., et al. (2002). Endocr Rev 23, 787-823). TGF-β has been found to have a multifaceted role during osteoblastogenesis. TGF-β has been demonstrated to promote early osteoblast differentiation but inhibit the later stages of maturation (Canalis, E. (2003). Osteoenic Growth Factors. In Primer on the Metabolic Bone Disease and Disorders of Mineral Metabolism, M. J. Favus, ed. (The American Society for Bone and Mineral Research), pp. 28-31.). TGF-β can elicit different cellular responses in the osteoblast through its ability to positively and negatively regulate gene transcription (Alliston, T., et al. (2001). Embo J 20, 2254-2272; Takai, H., et al. (1998). J Biol Chem 273, 27091-27096). Both activation and repression of gene expression by TGF-β utilize the same set of ubiquitous Smad proteins. However, specific cofactors that bind to Smads are believed to dictate whether a gene is up-regulated or down-regulated in response to TGF-β (Shi, Y., and Massague, J. (2003). Cell 113, 685-700). A similar transcriptional mechanism may account for the variable effects of TGF-β on osteoblast differentiation. Transcriptional cofactors expressed early in osteoblast differentiation may be required to regulate those genes downstream of TGF-β that drive the initial stages of differentiation. Different cofactors expressed at later time points in osteoblast differentiation would then be necessary for TGF-β to suppress the terminal stage of maturation.

Further elucidation of the factors influencing osteoblast activity would be of value in identifying agents capable of modulating bone formation and mineralization. The identification of such agents and methods of using such agents would be of great benefit in the treatment of disorders that would benefit from increased or decreased bone formation.

### SUMMARY OF THE INVENTION

The present invention is based, at least in part, on novel screening methods to identify small molecules which modulate bone formation and mineralization by interacting with Shn3, Runx2, SMAD3, and/or WWP1. It has been discovered that KRC modulates osteoblast formation and mineralization since mice bearing a null mutation in KRC exhibit a pronounced osteosclerotic phenotype, due to augmented osteoblast activity and bone formation. Downstream of TGF-β signaling in osteoblasts the formation of a multimeric complex between KRC, Runx2, Smad3, and the E3 ubiquitin ligase, WWP1 which inhibits Runx2 function due to the ability of WWP1 to promote Runx2 polyubiquitination and proteasome-dependent degradation is promoted. KRC is an integral and required component of this complex, since its absence in osteoblasts results in elevated levels of Runx2 protein, enhanced Runx2 transcriptional activity, elevated transcription of Runx2 target genes, and profoundly increased bone formation in vivo. The present invention is also based, at least in part, on the discovery that KRC and WWP1 also form a complex with RSK2 and inhibit RSK2 function due to the ability of WWP1 to promote RSK2 ubiquitination.

Accordingly, in one aspect, the invention pertains to a method for increasing bone formation and mineralization, comprising a) providing (i) a cellular indicator composition comprising KRC, WWP1, and Runx2, or biologically active fragments thereof; and (ii) a reporter gene responsive to the Runx2 polypeptide, or biological active fragment thereof, b) contacting the indicator composition with each member of a library of test compounds, c) evaluating the expression of the reporter gene in the presence and absence of the test compound, d) selecting from the library of test compounds a compound of interest that increases the expression of the reporter gene, e) evaluating the ability of the test compound of interest to increase mesenchymal stem cell differentiation, comprising contacting a mesenchymal stem cell comprising KRC, WWP1, and Runx2, or biologically active fragments thereof, with the test compound of interest and determining the effect of test compound on mesenchymal stem cell differentiation in the presence and absence of the test compound, to thereby identify a compound that increases bone formation and mineralization.

In one embodiment, the indicator cell is an osteoblast. In one embodiment, the osteoblast is a mature osteoblast.

In one embodiment, the reporter gene is luciferase. In one embodiment, the luciferase is operably linked to an Osteocalcin promoter.

In one embodiment, the indicator composition comprises a biologically active portion of Runx2 which comprises the PPXY domain. In another embodiment, the indicator composition comprises a biologically active portion of WWPI which comprises the HECT domain. In one embodiment, the indicator cell comprises a full length KRC polypeptide. In one embodiment, the KRC polypeptide is endogenous to the indicator cell. In another embodiment, the KRC polypeptide is exogenous to the indicator cell.

In one embodiment, the method is a high-throughput method. In one embodiment, the high-throughput method is preformed in a 96-well format.

In one embodiment, the effect of the test compound of interest on mesenchymal stem cell differentiation is evaluated by determining the level of cellular alkaline phosphatase (ALP). In another embodiment, the effect of the test compound of interest on the level of cellular alkaline phosphatase (ALP) is evaluated by a colorimetric assay, which method may further comprise normalizing cell number to the level of cellular alkaline phosphatase (ALP) by Alamar blue staining.

In one embodiment, a test compound of interest further is further evaluated for an effect on mineralization. In one embodiment, evaluating the effect of the test compound of interest on mineralization is determined by xylenol orange staining.

In one embodiment, the methods of the invention further comprise evaluating the ability of the test compound of interest to modulate the E3 ubiquitin ligase activity of WWP1, comprising providing an indicator composition comprising WWP1, or a biologically active fragment thereof; contacting the indicator composition with the test compound of interest; and determining the effect of the test compound of interest on the E3 ubiquitin ligase activity of WWP1 in the presence or absence of the test compound of interest.

In one embodiment, the methods of the invention further comprise evaluating the ability of the test compound of interest to decrease an interaction between WWPI and Runx2, comprising providing an indicator composition comprising WWP1 and Runx2, or biologically active fragments thereof; contacting the indicator composition with the test compound of interest; and determining the effect of the test compound of interest on the interaction of WWP1 and Runx2 in the presence or absence of the test compound.

In one embodiment, the interaction is determined by measuring the formation of a complex between WWP1 and Runx2. In another embodiment, the interaction is determined by measuring the degradation of the Runx2 in the presence and absence of the test compound. In yet another embodiment, the interaction is measured by measuring the ubiquitination of the Runx2. In one embodiment, the interaction is measured by measuring Runx2 mRNA production. In another embodiment, the interaction is measured by measuring Runx2 protein levels.

In one embodiment, the methods of the invention further comprise altering the chemical structure of the test compound of interest to obtain an optimized compound.

In one embodiment, the methods of the invention further comprise determining the effect of the test compound of interest on bone formation and mineralization in a non-human adult animal, comprising administering the test compound to the animal and determining the effect of test compound on bone formation and mineralization in the presence and absence of the test compound, wherein an increase in bone formation and mineralization in the non-human animal identifies the test compound of interest as a compound that increases bone formation and mineralization.

In one embodiment, the non-human animal is a mouse. In one embodiment, the mouse is a female mouse. In one embodiment, the female mouse is ovarectomized. In one embodiment, the non-human animal is a transgenic mouse overexpressing WWP1. In one embodiment, the transgenic mouse overexpressing WWP1 overexpresses human WWP1. In one embodiment, the transgenic mouse comprises a conditional allele of human WWP1. In one embodiment, the conditional allele of human WWP1 spatially restricts expression of WWP1 to an osteoblast. In another embodiment, the conditional WWP1 allele comprises a type I collagen promoter.

In one embodiment, bone formation and mineralization is determined by measuring trabecular number. In another embodiment, bone formation and mineralization is determined by measuring trabecular thickness. In yet another embodiment, bone formation and mineralization is determined by measuring trabecular spacing. In one embodiment, bone formation and mineralization is determined by measuring bone volume. In another embodiment, bone formation and mineralization is determined by measuring volumetric bone mineral density. In yet another embodiment, bone formation and mineralization is determined by measuring trabecular number, measuring trabecular thickness, measuring trabecular spacing, measuring bone volume, and measuring volumetric bone mineral density.

In one embodiment, the methods of the invention further comprise determining the serum levels of Trabp5b and deoxypyridinoline (Dpd).

In another aspect, the invention pertains to a method of identifying compounds useful in increasing bone formation and mineralization comprising, a) providing a mesenchymal stem cell comprising KRC, WWP1, and Runx2, or biologically active portions thereof, b) contacting the indicator composition with each member of a library of test compounds, and c) selecting from the library of test compounds a compound of interest that increases the differentiation of the mesenchymal stem cell into an osteoblast to thereby identify a compound that increases bone formation and mineralization.

In one embodiment, the effect of on mesenchymal stem cell differentiation is evaluated by determining the level of cellular alkaline phosphatase (ALP). In one embodiment, the effect on the level of cellular alkaline phosphatase (ALP) is evaluated by a colorimetric assay. In one embodiment, the methods of the invention further comprise normalizing cell number to the level of cellular alkaline phosphatase (ALP) by Alamar blue staining. In another embodiment, the methods of the invention further comprise evaluating the effect of the test compound on mineralization.

In one embodiment, evaluating the effect of the test compound of interest on mineralization is determined by xylenol orange staining.

In one embodiment, the methods of the invention further comprise evaluating the ability of the test compound of interest to modulate the E3 ubiquitin ligase activity of WWP1, comprising providing an indicator composition comprising WWP1, or a biologically active fragment thereof; contacting the indicator composition with the test compound of interest; and determining the effect of the test compound of interest on the E3 ubiquitin ligase activity of WWP1 in the presence or absence of the test compound of interest.

In another embodiment, the methods of the invention further comprise evaluating the ability of the test compound of interest to decrease an interaction between WWPI and Runx2, comprising providing an indicator composition comprising WWP1 and Runx2, or biologically active fragments thereof; contacting the indicator composition with the test compound of interest; and determining the effect of the test compound of interest on the interaction of WWP1 and Runx2 in the presence or absence of the test compound.

In one embodiment, the interaction is determined by measuring the formation of a complex between WWP1 and Runx2. In another embodiment, the interaction is determined by measuring the degradation of the Runx2 in the presence and absence of the test compound. In yet another embodiment, the interaction is measured by measuring the ubiquitination of the Runx2. In one embodiment, the interaction is measured by measuring Runx2 mRNA production. In another embodiment, the interaction is measured by measuring Runx2 protein levels.

In one embodiment, the methods of the invention further comprise altering the chemical structure of the test compound of interest to obtain an optimized compound.

In one embodiment, the methods of the invention further comprise determining the effect of the test compound of interest on bone formation and mineralization in a non-human adult animal, comprising administering the test compound to the animal and determining the effect of test compound on bone formation and mineralization in the presence and absence of the test compound, wherein an increase in bone formation and mineralization in the non-human animal identifies the test compound of interest as a compound that increases bone formation and mineralization.

In one embodiment, the non-human animal is a mouse. In one embodiment, the mouse is a female mouse. In one embodiment, the female mouse is ovarectomized. In one embodiment, the non-human animal is a transgenic mouse overexpressing WWP1. In one embodiment, the transgenic mouse overexpressing WWP1, overexpresses human WWP1. In one embodiment, the transgenic mouse comprises a conditional allele of human WWP1. In one embodiment, the conditional allele of human WWP1 spatially restricts expression of WWP1 to an osteoblast. In one embodiment, the conditional WWP1 allele comprises a type I collagen promoter.

In one embodiment, bone formation and mineralization is determined by measuring trabecular number. In another embodiment, bone formation and mineralization is determined by measuring trabecular thickness. In yet another embodiment, bone formation and mineralization is determined by measuring trabecular spacing. In one embodiment, bone formation and mineralization is determined by measuring bone volume. In another embodiment, bone formation and mineralization is determined by measuring volumetric bone mineral density. In yet another embodiment, bone formation and mineralization is determined by measuring trabecular number, measuring trabecular thickness, measuring trabecular spacing, measuring bone volume, and measuring volumetric bone mineral density.

In one embodiment, the methods of the invention further comprise determining the serum levels of Trabp5b and deoxypyridinoline (Dpd).

In one embodiment, the biologically active fragment of WWP1 comprises a HECT domain.

In another aspect, the invention provides a method of identifying compounds useful in increasing bone formation and mineralization comprising, a) providing (i) a cellular indicator composition comprising KRC, WWP1, and Runx2, or biologically active portions thereof, and (ii) a reporter gene responsive to the Runx2 polypeptide, or biological active fragment thereof, b) contacting the indicator composition with each member of a library of test compounds, c) evaluating the expression of the reporter gene in the presence and absence of the test compound, d) selecting from the library of test compounds a compound of interest that increases the expression of the reporter gene, e) evaluating the ability of the test compound of interest from step d) to increase mesenchymal stem cell differentiation, comprising contacting a mesenchymal stem cell with the test compound of interest and determining the effect of test compound on mesenchymal stem cell differentiation in the presence and absence of the test compound, f) evaluating the ability of the test compound of interest from step e) to decrease the E3 ubiquitin ligase activity of WWP1, comprising providing an indicator composition comprising WWP1, or a biologically active fragment thereof; contacting the indicator composition with the test compound of interest; and determining the effect of the test compound of interest on the E3 ubiquitin ligase activity of WWP1 in the presence or absence of the test compound of interest, and/or g) evaluating the ability of the test compound of interest from step e) to decrease an interaction between WWPI and Runx2, comprising providing an indicator composition comprising WWP1 and Runx2, or biologically active fragments thereof; contacting the indicator composition with the test compound of interest; and determining the effect of the test compound of interest on the interaction of WWP1 and Runx2 in the presence or absence of the test compound, and h) determining the effect of the test compound of interest from step g) on bone formation and mineralization in an adult non-human animal, comprising administering the test compound to the animal and determining the effect of test compound on bone formation and mineralization in the presence and absence of the test compound, wherein an increase in bone formation and mineralization in the non-human animal identifies the test compound of interest as a compound that increases bone formation and mineralization.

In one embodiment, a SMAD3 molecule is also present in the indicator composition. In another embodiment, a RSK2 molecule is also present in the indicator composition.

Yet another aspect of the invention provides a method of identifying compounds useful in increasing bone formation and mineralization comprising, a) providing (i) a cellular indicator composition comprising KRC, WWP1, and RSK2, or biologically active fragments thereof, and (ii) a reporter gene responsive to the RSK2 polypeptide, or biological active fragment thereof, b) contacting the indicator composition with each member of a library of test compounds, c) evaluating the expression of the reporter gene in the presence and absence of the test compound, d) selecting from the library of test compounds a compound of interest that increases the expression of the reporter gene, e) evaluating the ability of the test compound of interest to increase mesenchymal stem cell differentiation, comprising contacting a mesenchymal stem cell comprising KRC, WWP1, and RSK2, or biologically active fragments thereof, with the test compound of interest and determining the effect of test compound on mesenchymal stem cell differentiation in the presence and absence of the test compound, to thereby identify a compound that increases bone formation and mineralization.

Another aspect of the invention provides a method of identifying compounds useful in increasing bone formation and mineralization comprising, a) providing a mesenchymal stem cell comprising KRC, WWP1, and RSK2, or biologically active portions thereof, b) contacting the indicator composition with each member of a library of test compounds, and c) selecting from the library of test compounds a compound of interest that increases the differentiation of the mesenchymal stem cell into an osteoblast to thereby identify a compound that increases bone formation and mineralization.

One aspect of the invention provides a method of identifying compounds useful in increasing bone formation and mineralization comprising, a) providing (i) a cellular indicator composition comprising KRC, WWP1, and RSK2, or biologically active portions thereof; and (ii) a reporter gene responsive to the Runx2 polypeptide, or biological active fragment thereof, b) contacting the indicator composition with each member of a library of test compounds, c) evaluating the expression of the reporter gene in the presence and absence of the test compound, d) selecting from the library of test compounds a compound of interest that increases the expression of the reporter gene, e) evaluating the ability of the test compound of interest from step d) to increase mesenchymal stem cell differentiation, comprising contacting a mesenchymal stem cell with the test compound of interest and determining the effect of test compound on mesenchymal stem cell differentiation in the presence and absence of the test compound, f) evaluating the ability of the test compound of interest from step e) to decrease the E3 ubiquitin ligase activity of WWP1, comprising providing an indicator composition comprising WWP1, or a biologically active fragment thereof; contacting the indicator composition with the test compound of interest, and determining the effect of the test compound of interest on the E3 ubiquitin ligase activity of WWP1 in the presence or absence of the test compound of interest, and/or g) evaluating the ability of the test compound of interest from step e) to decrease an interaction between WWPI and RSK2, comprising providing an indicator composition comprising WWP1 and RSK2, or biologically active fragments thereof, contacting the indicator composition with the test compound of interest; and determining the effect of the test compound of interest on the interaction of WWP1 and RSK2 in the presence or absence of the test compound, and h) determining the effect of the test compound of interest from step g) on bone formation and mineralization in an adult non-human animal, comprising administering the test compound to the animal and determining the effect of test compound on bone formation and mineralization in the presence and absence of the test compound, wherein an increase in bone formation and mineralization in the non-human animal identifies the test compound of interest as a compound that increases bone formation and mineralization.

### DETAILED DESCRIPTION OF THE INVENTION

The present invention is based, at least in part, on the finding that KRC modulates bone formation and mineralization by interacting with Runx2, SMAD3, and/or WWP1. TGF-β signaling in osteoblasts promotes the formation of a multimeric complex between KRC, Runx2, Smad3, and the E3 ubiquitin ligase, WWP1, which inhibits Runx2 function due to the ability of WWP1 to promote Runx2 polyubiquitination and proteasome-dependent degradation. KRC is an integral and required component of this complex, since its absence in osteoblasts results in elevated levels of Runx2 protein, enhanced Runx2 transcriptional activity, elevated transcription of Runx2 target genes, profoundly increased bone formation in vivo, as well as defective osteoclastogenesis in vivo. The present invention is also based, at least in part, on the discovery that KRC and WWP1 also form a complex with RSK2 and inhibit RSK2 kinase function due to the ability of WWP1 to promote RSK2 ubiquitination.

The KRC protein (for κB binding and putative recognition component of the V(D)J Rss), referred to interchangeably herein as Schnurri-3 (Shn3), is a DNA binding protein comprised of 2282 amino acids. KRC has been found to be present in T cells, B cells, and macrophages. The KRC cDNA sequence is set forth in SEQ ID NO:1. The amino acid sequence of KRC is set forth in SEQ ID NO:2. KRC is a member of a family of zinc finger proteins that bind to the kB motif (Bachmeyer, C, et al., 1999. Nuc. Acids. Res. 27(2):643-648). Zinc finger proteins are divided into three classes represented by KRC and the two MHC Class I gene enhancer binding proteins, MBP1 and MBP2 (Bachmeyer, C, et al., 1999. Nuc. Acids. Res. 27(2):643-648).

Zinc finger proteins are identified by the presence of highly conserved Cys2His2 zinc fingers. The zinc fingers are an integral part of the DNA binding structure called the ZAS domain. The ZAS domain is comprised of a pair of zinc fingers, a glutamic acid/aspartic acid-rich acidic sequence and a serine/threonine rich sequence. The ZAS domains have been shown to interact with the kB like cis-acting regulatory elements found in the promoter or enhancer regions of genes. The genes targeted by these zinc finger proteins are mainly involved in immune responses.

The KRC ZAS domain, in particular, has a pair of Cys2-His2 zinc fingers followed by a glutamic acid/aspartic acid-rich acidic sequence and five copies of the serine/threonine-proline-X-arginine/lysine sequence. Southwestern blotting experiments, electrophoretic mobility shift assays (EMSA) and methylation interference analysis has also demonstrated that KRC recombinant proteins bind to the κB motif as well as to the Rss sequence (Bachmeyer, et al. 1999. Nuc. Acid Res. 27, 643-648; Wu et al. 1998. Science 281, 998-1001) and do so in highly ordered complexes (Mak, C. H., et al. 1994. Nuc. Acid Res. 22, 383-390.; Wu et al. 1998. Science 281, 998-1001).

Similar zinc finger-acidic domain structures are present in human KBP1, MBP1 and MBP2, rat ATBP1 and ATBP2, and mouse αA-CRYBP proteins. KRC has recently been shown to regulate transcription of the mouse metastasis-associated gene, s100A4/mts1*, by binding to the Sb element (a kB like sequence) of the gene. (Hjelmsoe, I., et al. 2000. J. Biol. Chem. 275(2): 913-920). KRC is regulated by post-translational modification as evidenced by the fact that pre-B cell nuclear protein kinases phosphorylate KRC proteins on serine and tyrosine residues. Phosphorylation increases DNA binding, providing a mechanism by which KRC may respond to signals transmitted from the cell surface (Bachmeyer, C, et al., 1999. Nuc. Acids. Res. 27(2):643-648). Two prominent ser/thr-specific protein kinases that play a central role in signal transduction are cyclic AMP-dependent protein kinase A (PKA) and the protein kinase C (PKC family). Numerous other serine/threonine specific kinases, including the family of mitogen-activated protein (MAP) kinases serve as important signal transduction proteins which are activated in either growth-factor receptor or cytokine receptor signaling. Other protein ser/thr kinases important for intracellular signaling are Calcium-dependent protein kinase (CaM-kinase II) and the c-raf-protooncogene. KRC is known to be a substrate for epidermal growth factor receptor kinase and p34cdc2 kinase in vitro.

The results of a yeast two hybrid screen using amino acid residues 204 to 1055 of KRC (which includes the third zinc finger) as bait demonstrate that KRC interacts with the TRAF family of proteins and that this interaction occurs through the TRAF C domain and that KRC interacts with higher affinity with TRAF2 than with TRAF5 and TRAF6. (See Example 1 of PCT/US02/14166).

Recent research has lead to the isolation of polypeptide factors named TRAFs for tumor necrosis factor receptor associated factors, which participate in the TNFR signal transduction cascade. Six members of the TRAF family of proteins have been identified in mammalian cells (reviewed in Arch, R. H., et al. 1998. Genes Dev. 12, 2821-2830). All TRAF proteins, with the exception of TRAF1, contain an amino terminal RING finger domain with a characteristic pattern of cysteines and histidines that coordinate the binding of Zn2+ ions (Borden, K. L. B., et al. 1995. EMBO J 14, 1532-1521), which is followed by a stretch of multiple zinc fingers. All TRAFs share a highly conserved carboxy-terminal domain (TRAF-C domain) which is required for receptor binding and can be divided into two parts, a highly conserved domain which mediates homo and heterodimerization of TRAF proteins and also the association of the adapter proteins with their associated receptors and an amino-terminal half that displays a coiled-coil configuration. TRAF molecules have distinct patterns of tissue distribution, are recruited by different cell surface receptors and have distinct functions as revealed most clearly by the analysis of TRAF-deficient mice (see Lomaga, M. A., et al. 1999. Genes Dev. 13, 1015-24; Nakano, H., et al. 1999. Proc. Natl. Acad. Sci. USA 96, 9803-9808; Nguyen, L. T., et al. 1999. Immunity 11, 379-389; Xu, Y., et al. 1996. Immunity 5, 407-415.; Yeh, W. C., et al. 1997. Immunity 7, 715-725).

Tumor necrosis factor (TNF) is a cytokine produced mainly by activated macrophages which elicits a wide range of biological effects. These include an important role in endotoxic shock and in inflammatory, immunoregulatory, proliferative, cytotoxic, and anti-viral activities (reviewed by Goeddel, D. V. et al., 1986. Cold Spring Harbor Symposia on Quantitative Biology 51: 597-609; Beutler, B. and Cerami, A., 1988. Ann. Rev. Biochem. 57: 505-518; Old, L. J., 1988. Sci. Am. 258(5): 59-75; Fiers, W. 1999. FEBS Lett. 285(2):199-212). The induction of the various cellular responses mediated by TNF is initiated by its interaction with two distinct cell surface receptors, an approximately 55 kDa receptor termed TNFR1 and an approximately 75 kDa receptor termed TNFR2. Human and mouse cDNAs corresponding to both receptor types have been isolated and characterized (Loetscher, H. et al., 1990. Cell 61:351; Schall, T. J. et al., 1990. Cell 61: 361; Smith, C. A. et al., 1990 Science 248: 1019; Lewis, M. et al., 1991. Proc. Natl. Acad. Sci. USA 88: 2830-2834; Goodwin, R. G. et al., 1991. Mol. Cell. Biol. 11:3020-3026).

TNFα binds to two distinct receptors, TNFR1 and TNFR2, but in most cell types NFκB activation and JNK/SAPK activation occur primarily through TNFR1. TNFR1 is known to interact with TRADD which functions as an adaptor protein for the recruitment of other proteins including RIP, a serine threonine kinase, and TRAF2. Of the six known TRAFs, TRAF2, TRAF5 and TRAF6 have all been linked to NFκB activation (Cao, Z., et al. 1996. Nature 383: 443-6; Rothe, M., et al. 1994. Cell 78: 681-692; Nakano, H., et al. 1996. J. Biol. Chem. 271:14661-14664), and TRAF2 in particular has been linked to activation of the JNK/SAPK proteins as shown unequivocally by the failure of TNFα to activate this MAP kinase in cells lacking TRAF2 or expressing a dominant negative form of TRAF2 (Yeh, W. C., et al. 1997. Immunity 7: 715-725; Lee, S. Y., et al. 1997. Immunity 7:1-20).

Various aspects of the invention are described in further detail in the following subsections:

### I. DEFINITIONS

As used herein, the term “KRC”, used interchangeably with “Shn3” or “schnurri 3”, refers to κB binding and putative recognition component of the V(D)J Rss. The nucleotide sequence of KRC is set forth in SEQ ID NO:1 and the amino acid sequence of KRC is set forth in SEQ ID NO:2. The amino acid sequence of the ZAS domain of KRC is set forth in amino acids 1497-2282 of SEQ ID NO:2 (SEQ ID NO:4). The amino acid sequence of KRC tr is shown in amino acid residues 204 to 1055 of SEQ ID NO:2. As used herein, the term “KRC”, unless specifically used to refer to a specific SEQ ID NO, will be understood to refer to a KRC family polypeptide as defined below.

“KRC family polypeptide” is intended to include proteins or nucleic acid molecules having a KRC structural domain or motif and having sufficient amino acid or nucleotide sequence identity with a KRC molecule as defined herein. Such family members can be naturally or non-naturally occurring and can be from the same or different species. For example, a family can contain a first protein of human origin, as well as other, distinct proteins of human origin or, alternatively, can contain homologues of non-human origin. Preferred members of a family may also have common functional characteristics. Preferred KRC polypeptides comprise one or more of the following KRC characteristics: a pair of Cys2-His2 zinc fingers followed by a Glu- and Asp-rich acidic domain and five copies of the ser/Thr-Pro-X-Arg/Lys sequence thought to bind DNA. Another preferred KRC family polypeptide comprises amino acid residues 204 to 1055 of SEQ ID NO:2 (e.g., the “KRC-interacting domain” (KRC tr)).

As used herein, the term “KRC activity”, “KRC biological activity” or “activity of a KRC polypeptide” includes the ability to modulate an activity regulated by KRC, a KRC family polypeptide, such as for example KRC tr, or a signal transduction pathway involving KRC. For example, in one embodiment a KRC biological activity includes modulation of an immune response. In another embodiment, KRC modulates bone formation and mineralization. Exemplary KRC activities include e.g., modulating: immune cell activation and/or proliferation (such as by modulating cytokine gene expression), cell survival (e.g., by modulating apoptosis), signal transduction via a signaling pathway (e.g., an NFkB signaling pathway, a JNK signaling pathway, and/or a TGFβ signaling pathway), actin polymerization, ubiquitination of AP-1, ubiquitination of TRAF, degradation of c-Jun, degradation of c-Fos, degradation of SMAD, degradation of GATA3, GATA3 expression, modulation of Th2 cell differentiation, modulation of Th2 cytokine production, IgA production, modulation of GLα transcription, modulation of bone growth, modulation of bone mineralization, modulation of osteoclastogenesis, modulation of osteoblast versus osteoclast activity, e.g., in bone formation and/or remodeling of bone, modulation of osteocalcin gene transcription, degradation of Runx2, e.g., modulation of Runx2 protein levels, ubiquitination of Runx2, modulation of the expression of RSK2, degradation of RSK2, e.g., modulation of RSK2 protein levels, ubiquitination of RSK2, modulation of the phosphorylation of RSK2, modulation of RSK2 kinase activity, modulation of the expression of BSP, ColI(α)1, OCN, Osterix, RANKL, and ATF4, modulation of ATF4 protein levels, and/or modulation of the phosphorylation of ATF4.

As used herein, the various forms of the term “modulate” are intended to include stimulation (e.g., increasing or upregulating a particular response or activity) and inhibition (e.g., decreasing or downregulating a particular response or activity).

As described above and in the appended Examples, KRC modulates bone formation and mineralization through a complex interaction of molecules which are downstream of TGF-β signaling. In one embodiment, the KRC activity is a direct activity, such as an association with a KRC-target molecule or binding partner. As used herein, a “target molecule”, “binding partner” or “KRC binding partner” is a molecule with which a KRC protein binds or interacts in nature, such that KRC mediated function is achieved.

As used herein the term “TRAF” refers to TNF Receptor Associated Factor (See e.g., Wajant et al, 1999, Cytokine Growth Factor Rev 10:15-26). The “TRAF” family includes a family of cytoplasmic adapter proteins that mediate signal transduction from many members of the TNF-receptor superfamily and the interleukin-1 receptor (see e.g., Arch, R. H. et al., 1998, Genes Dev. 12:2821-2830). As used herein, the term “TRAF C domain” refers to the highly conserved sequence motif found in TRAF family members.

As used herein, the terms “TRAF interacting portion of a KRC molecule” or “c-Jun interacting portion of a KRC molecule” includes a region of KRC that interacts with TRAF or c-Jun. In a preferred embodiment, a region of KRC that interacts with TRAF or c-Jun is amino acid residues 204-1055 of SEQ ID NO:2 (SEQ ID NO:3). As used herein, the term “KRC interacting portion of a TRAF molecule” or “KRC interacting portion of a TRAF molecule” includes a region of TRAF or c-Jun that interacts with KRC. In a preferred embodiment, a region of TRAF that interacts with KRC is the TRAF C domain.

The term “interact” as used herein is meant to include detectable interactions between molecules, such as can be detected using, for example, a yeast two hybrid assay or coimmunoprecipitation. The term interact is also meant to include “binding” interactions between molecules. Interactions may be protein-protein or protein-nucleic acid in nature.

As used herein, the term “contacting” (i.e., contacting a cell e.g. an immune cell, with an compound) is intended to include incubating the compound and the cell together in vitro (e.g., adding the compound to cells in culture) or administering the compound to a subject such that the compound and cells of the subject are contacted in vivo. The term “contacting” is not intended to include exposure of cells to a KRC modulator that may occur naturally in a subject (i.e., exposure that may occur as a result of a natural physiological process).

As used herein, the term “test compound” includes a compound that has not previously been identified as, or recognized to be, a modulator of KRC activity and/or expression and/or a modulator of bone growth and/or mineralization.

The term “library of test compounds” is intended to refer to a panel or pool comprising a multiplicity of test compounds. Preferably, the test compounds are not previously known to modulate KRC activity or bone formation.

As used herein, the term “cell free composition” refers to an isolated composition which does not contain intact cells. Examples of cell free compositions include cell extracts and compositions containing isolated proteins.

As used herein, the term “indicator composition” refers to a composition that includes a protein of interest (e.g., KRC or a molecule in a signal transduction pathway involving KRC), for example, a cell that naturally expresses the protein, a cell that has been engineered to express the protein by introducing an expression vector encoding the protein into the cell, or a cell free composition that contains the protein (e.g., purified naturally-occurring protein or recombinantly-engineered protein).

As used herein, an “antisense” nucleic acid comprises a nucleotide sequence which is complementary to a “sense” nucleic acid encoding a protein, e.g., complementary to the coding strand of a double-stranded cDNA molecule, complementary to an mRNA sequence or complementary to the coding strand of a gene. Accordingly, an antisense nucleic acid can hydrogen bond to a sense nucleic acid.

In one embodiment, a nucleic acid molecule of the invention is an siRNA molecule. In one embodiment, a nucleic acid molecule of the invention mediates RNAi. RNA interference (RNAi) is a post-transcriptional, targeted gene-silencing technique that uses double-stranded RNA (dsRNA) to degrade messenger RNA (mRNA) containing the same sequence as the dsRNA (Sharp, P. A. and Zamore, P. D. 287, 2431-2432 (2000); Zamore, P. D., et al. Cell 101, 25-33 (2000). Tuschl, T. et al. Genes Dev. 13, 3191-3197 (1999); Cottrell T R, and Doering T L. 2003. Trends Microbiol. 11:37-43; Bushman F. 2003. Mol. Therapy. 7:9-10; McManus M T and Sharp P A. 2002. Nat Rev Genet. 3:737-47). The process occurs when an endogenous ribonuclease cleaves the longer dsRNA into shorter, e.g., 21- or 22-nucleotide-long RNAs, termed small interfering RNAs or siRNAs. The smaller RNA segments then mediate the degradation of the target mRNA. Kits for synthesis of RNAi are commercially available from, e.g. New England Biolabs or Ambion. In one embodiment one or more of the chemistries described herein for use in antisense RNA can be employed in molecules that mediate RNAi.

As used herein, the term “dominant negative” includes molecules, such as KRC molecules (e.g., portions or variants thereof) that compete with native (i.e., wild-type) KRC molecules, but which do not have KRC activity. Such molecules effectively decrease KRC activity in a cell.

As used herein, the term “NFkB signaling pathway” refers to any one of the signaling pathways known in the art which involve activation or deactivation of the transcription factor NFkB, and which are at least partially mediated by the NFkB factor (Karin, 1998, Cancer J from Scientific American, 4:92-99; Wallach et al, 1999, Ann Rev of Immunology, 17:331-367). Generally, NFkB signaling pathways are responsive to a number of extracellular influences e.g. mitogens, cytokines, stress, and the like. The NFkB signaling pathways involve a range of cellular processes, including, but not limited to, modulation of apoptosis. These signaling pathways often comprise, but are by no means limited to, mechanisms which involve the activation or deactivation via phosphorylation state of an inhibitor peptide of NFkB (IkB), thus indirectly activating or deactivating NFkB.

As used herein, the term “JNK signaling pathway” refers to any one of the signaling pathways known in the art which involve the Jun amino terminal kinase (JNK) (Karin, 1998, Cancer J from Scientific American, 4:92-99; Wallach et al, 1999, Ann Rev of Immunology, 17:331-367). This kinase is generally responsive to a number of extracellular signals e.g. mitogens, cytokines, stress, and the like. The JNK signaling pathways mediate a range of cellular processes, including, but not limited to, modulation of apoptosis. In a preferred embodiment, JNK activation occurs through the activity of one or more members of the TRAF protein family (See, e.g., Wajant et al, 1999, Cytokine Growth Factor Rev 10:15-26).

As used herein, the term “TGFβ signaling pathway” refers to any one of the signaling pathways known in the art which involve transforming growth factor beta. A TGFβ signaling pathway is initiated when this molecule binds to and induces a heterodimeric cell-surface complex consisting of type I (TβRI) and type II (TβRII) serine/threonine kinase receptors. This heterodimeric receptor then propagates the signal through phosphorylation of downstream target SMAD proteins. There are three functional classes of SMAD protein, receptor-regulated SMADs (R-SMADs), e.g., SMAD2 and SMAD3, Co-mediator SMADs (Co-SMADs) and inhibitory SMADs (I-SMADs). Following phosphorylation by the heterodimeric receptor complex, the R-SMADs complex with the Co-SMAD and translocate to the nucleus, where in conjunction with other nuclear proteins, they regulate the transcription of target genes (Derynck, R., et al. (1998) Cell 95: 737-740). Reviewed in Massague, J. and Wotton, D. (2000) EMBO J. 19:1745.

The nucleotide sequence and amino acid sequence of human SMAD2, is described in, for example, GenBank Accession No. gi:20127489. The nucleotide sequence and amino acid sequence of murine SMAD2, is described in, for example, GenBank Accession No. gi:31560567. The nucleotide sequence and amino acid sequence of human SMAD3, is described in, for example, GenBank Accession No. gi:42476202. The nucleotide sequence and amino acid sequence of murine SMAD3, is described in, for example, GenBank Accession No. gi:31543221.

“GATA3” is a Th2-specific transcription factor that is required for the development of Th2 cells. GATA-binding proteins constitute a family of transcription factors that recognize a target site conforming to the consensus WGATAR (W=A or T and R=A or G). GATA3 interacts with SMAD3 following its phosphorylation by TGFβ signaling to induce the differentiation of T helper cells. The nucleotide sequence and amino acid sequence of human GATA3, is described in, for example, GenBank Accession Nos. gi:4503928 and gi:14249369. The nucleotide sequence and amino acid sequence of murine GATA3, is described in, for example, GenBank Accession No. gi:40254638. The domains of GATA3 responsible for specific DNA-binding site recognition (amino acids 303 to 348) and trans activation (amino acids 30 to 74) have been identified. The signaling sequence for nuclear localization of human GATA-3 is a property conferred by sequences within and surrounding the amino finger (amino acids 249 to 311) of the protein. Exemplary genes whose transcription is regulated by GATA3 include IL-5, IL-12, IL-13, and IL-12Rβ2.

TGFβ also plays a key role in osteoblast differentiation and bone development and remodeling. Osteoblasts secrete and deposit TGFβ into the bone matrix and can respond to it, thus enabling possible autocrine modes of action. TGFβ regulates the proliferation and differentiation of osteoblasts both in vitro and in vivo; however, the effects of TGFβ on osteoblast differentiation depend on the extracellular milieu and the differentiation stage of the cells. TGFβ stimulates proliferation and early osteoblast differentiation, while inhibiting terminal differentiation. Accordingly, TGFβ has been reported to inhibit expression of alkaline phosphatase and osteocalcin, among other markers of osteoblast differentiation and function (Centrella et al., 1994 Endocr. Rev., 15, 27-39). Osteoblasts express cell surface receptors for TGFβ and the effectors, Smad2 and Smad3.

As used herein, the term “bone formation and mineralization” refers to the cellular activity of osteoblasts to synthesize the collagenous precursors of bone extracellular matrix, regulate mineralization of the matrix to form bone, as well as their function in bone remodeling and reformation, e.g., bone mass is maintained by a balance between the activity of osteoblasts that form bone and the osteoclasts that break it down. The mineralization of bone occurs by deposition of carbonated hydroxyapetite crystals in an extracellular matrix consisting of type I collagen and a variety of non-collagenous proteins. As used herein, an “osteoblast” is a bone-forming cell that is derived from mesenchymal osteoprognitor cells and forms an osseous matrix in which it becomes enclosed as an osteocyte. A mature osteoblast is one capable of forming bone extracellular matrix in vivo , and can be identified in vitro by its capacity to form mineralized nodules which reflects the generation of extracellular. An immature osteoblast is not capable of forming mineralized nodules in vitro. As used herein, an “osteoclast” is a large multinucleated cell with abundant acidophilic cytoplasm, functioning in the absorption and removal of osseous tissue. Osteoclasts become highly active in the presence of parathyroid hormone, causing increased bone resorption and release of bone salts (phosphorus and, especially, calcium) into the extracellular fluid.

As used herein, “osteocalcin”, also called bone Gla protein, is a vitamin K-dependent, calcium-binding bone protein, the most abundant noncollagen protein in bone. Osteocalcin is specifically expressed in differentiated osteoblasts and odontoblasts. The TGF-β-mediated decrease of osteocalcin has been shown to occur at the mRNA level and does not require new protein synthesis. Transcription from the osteocalcin promoter requires binding of the transcription factor CBFA1, also known as Runx2, to a response element, named OSE2, in the osteocalcin promoter.

Runx factors are DNA binding proteins that can facilitate tissue-specific gene activation or repression (Lutterbach, B., and S. W. Hiebert. (2000) Gene 245:223-235). Mammalian Runx-related genes are essential for blood, skeletal, and gastric development and are commonly mutated in acute leukemias and gastric cancers (Lund, A. H., and M. van Lohuizen. (2002) Cancer Cell. 1:213-215). Runx factors exhibit a tissue-restricted pattern of expression and are required for definitive hematopoiesis and osteoblast maturation. Runx proteins have recently been shown to interact through their C-terminal segment with Smads, a family of signaling proteins that regulate a diverse array of developmental and biological processes in response to transforming growth factor (TGF)-β/bone morphogenetic protein (BMP) family of growth factors. Moreover, subnuclear distribution of Runx proteins is mediated by the nuclear matrix-targeting signal, a protein motif present in the C terminus of Runx factors. Importantly, in vivo osteogenesis requires the C terminus of Runx2 containing the overlapping subnuclear targeting signal and the Smad interacting domain. The Runx and Smad proteins are jointly involved in the regulation of phenotypic gene expression and lineage commitment. Gene ablation studies have revealed that both Runx proteins and Smads are developmentally involved in hematopoiesis and osteogenesis. Furthermore, Runx2 and the BMP-responsive Smads can induce osteogenesis in mesenchymal pluripotent cells. Runx proteins comprise a highly conserved Runt domain.

“Runx2” is one of three mammalian homologues of the Drosophila transcription factors, Runt and Lozenge (Daga, A., et al. (1996) Genes Dev. 10:1194-1205). Runx2 is also expressed in T lymphocytes and cooperates with oncogenes c-myc, p53, and Pim1 to accelerate T-cell lymphoma development in mice (Blyth, K., et al. (2001) Oncogene 20:295-302).

Runx2 expression also plays a key role in osteoblast differentiation and skeletal formation. In addition to osteocalcin, Runx2 regulates expression of several other genes that are activated during osteoblast differentiation, including alkaline phosphatase, collagen, osteopontin, and osteoprotegerin ligand. These genes also contain Runx2-binding sites in their promoters. These observations suggest that Runx2 is an essential transcription factor for osteoblast differentiation. This hypothesis is strongly supported by the absence of bone formation in mouse embryos in which the cbfa1 gene was inactivated. Furthermore, cleidocranial dysplasia, a human disorder in which some bones are not fully developed, has been associated with mutations in a cbfa1 allele. In addition to its role in osteoblast differentiation, Runx2 has been implicated in the regulation of bone matrix deposition by differentiated osteoblasts. The expression of Runx2 is regulated by factors that influence osteoblast differentiation. Accordingly, BMPs can activate, while Smad2 and glucocorticoids can inhibit, Runx2 expression. In addition, Runx2 can bind to an OSE2 element in its own promoter, suggesting the existence of an autoregulatory feedback mechanism of transcriptional regulation during osteoblast differentiation. For a review, see, Alliston, et al. (2000) EMBO J 20:2254.

As described herein, Runx2 interacts with KRC through its Runt DNA binding domain. The best-described binding partner for the Runt domain of Runx2 is CBFβ, a constitutively-expressed factor required for high-affinity DNA binding by Runx2 (Tang, Y. Y., et al. (2000). J Biol Chem 275, 39579-39588; Yoshida, C. A., et al. (2002). Nat Genet 32, 633-638). Although CBFβ−/− mice die at E12.5 due to severe defects in Runx1-mediated hematopoiesis, when CBFβ−/− mice are rescued by transgenic overexpression of CBFβ by the Gata1 promoter, severe dwarfism results that mimicking the phenotype of Runx2−/− mice (Yoshida, C. A., et al. (2002). Nat Genet 32, 633-638). When bound to CBFβ, Runx family members are protected from ubiquitin/proteasome-mediated degradation (Huang, G., et al. (2001). Embo J 20, 723-733). When bound to CBFβ, Runx2 stability is promoted and it optimally binds target DNA sequences. When bound to Shn3, Runx2 can no longer bind target sequences with high affinity, and Runx2 degradation is accelerated due to enhanced ubiquitination and subsequent proteolysis.

The nucleotide sequence and amino acid sequence of human Runx2, is described in, for example, GenBank Accession No. gi:10863884. The nucleotide sequence and amino acid sequence of murine Runx2, is described in, for example, GenBank Accession No. gi:20806529. The nucleotide sequence and amino acid sequence of human CBFβ, is described in, for example, GenBank Accession No. gi: 47132615 and 47132616. The nucleotide sequence and amino acid sequence of murine CBFβ, is described in, for example, GenBank Accession No. gi: gi:31981853.

As used herein, “WWP1” is a member of the family of E3 ubiquitin ligases with multiple WW domains, which also includes Nedd4, WWP2, and AIP4. WWP1 has previously been shown to interact with all R- and I-Smad proteins, and to promote the ubiquitination of Smad6 and Smad7 (Komuro, A., et al. (2004). Oncogene 23, 6914-6923); however, the ability of WWP1 to ubiquitinate Runx proteins, which also possess PPXY motifs in their Runt domains (Jin, Y. H., et al. (2004). J Biol Chem 279, 29409-29417), had not been investigated. WWP1 comprises a WW domain. The WW domain is characterized by 2 conserved Trp residues and a conserved Pro (hence its alternative name, WWP). The domain contains around 35-40 residues, and may be repeated up to 4 times in some sequences. It appears to bind proteins that contain characteristic proline motifs ([AP]-P-P-[AP]-Y), and resembles, to an extent, the SH3 domains.

The nucleotide sequence and amino acid sequence of human WWP1, is described in, for example, GenBank Accession No. gi:33946331. The nucleotide sequence and amino acid sequence of murine WWP1, is described in, for example, GenBank Accession No. gi:51709071.

“Bone sialoprotein” or “BSP” is belongs to the osteopontin gene family and is a non-collagenase bone matrix protein that binds tightly to hydroxyapatite, forming an integral part of the mineralized matrix of bone. The nucleotide sequence and amino acid sequence of human BSP, is described in, for example, GenBank Accession No. gi:38146097. The nucleotide sequence and amino acid sequence of murine BSP, is described in, for example, GenBank Accession No. gi:6678112.

Type I collagen (α)1 (“ColI(α)1”), is a collagenase bone matrix protein. The nucleotide sequence and amino acid sequence of human ColI(α)1, is described in, for example, GenBank Accession No. gi:14719826. The nucleotide sequence and amino acid sequence of murine ColI(α)1, is described in, for example, GenBank Accession No. gi:34328107.

“ATF4”, also called “CREB2”, and “Osterix”, also called “SP7”, are transcription factors belonging to the bZIP protein family and C2H2-type zinc-finger protein family, respectively, that are key regulators of bone matrix biosynthesis during remodeling of bone, e.g., during bone formation and mineralization (see, for example, Yang, X., et al. (2004). Cell 117, 387-398; Nakashima, K., et al. (2002). Cell 108, 17-2). BSP, ColI(α)1, ATF4, and Osterix are specific markers of bone formation and development. The nucleotide sequence and amino acid sequence of human ATF4, is described in, for example, GenBank Accession No. gi:33469975 and gi:33469973. The nucleotide sequence and amino acid sequence of murine ATF4, is described in, for example, GenBank Accession No. gi:6753127. The nucleotide sequence and amino acid sequence of human SP7, is described in, for example, GenBank Accession No. gi:22902135. The nucleotide sequence and amino acid sequence of murine SP7, is described in, for example, GenBank Accession No gi:18485517.

As used herein, the term “ATF4 signaling pathway” refers to any one of the signaling pathways known in the art which involve Activating Transcription Factor 4 to regulate osteoblast development and function. As discussed above, ATF4 is a transcription factor which functions as a specific repressor of CRE-dependent transcription. The transcriptional repressor activity resides within the C-terminal leucine zipper and basic domain region of the ATF4 protein. ATF4 has been shown to be required for high levels of collagen synthesis by mature osteoblasts and requires phosphorylation by the kinase, RSK2, for optimal extracellular matrix production by osteoblasts (Yang, et al. (2004) Cell 117:387). Furthermore, as described herein, animals deficient in KRC have elevated levels of ATF4 and RSK2 mRNA and protein, as well as an accumulation of hyperphosphorylated ATF4. The nucleotide sequence and amino acid sequence of human RSK2, is described in, for example, GenBank Accession No. gi:56243494. The nucleotide sequence and amino acid sequence of murine RSK2, is described in, for example, GenBank Accession No. gi:22507356.

As used herein, “AP-1” refers to the transcription factor activator protein 1 (AP-1) which is a family of DNA-binding factors that are composed of dimers of two proteins that bind to one another via a leucine zipper motif. The best characterized AP-1 factor comprises the proteins Fos and Jun. (Angel, P. and Karin, M. (1991) Biochim. Biophys. Acta 1072:129-157; Orengo, I. F., Black, H. S., et al. (1989) Photochem. Photobiol. 49:71-77; Curran, T. and Franza, B. R., Jr. (1988) Cell 55, 395-397). The AP-1 dimers bind to and transactivate promoter regions on DNA that contain cis-acting phorbol 12-tetradecanoate 13-acetate (TPA) response elements to induce transcription of genes involved in cell proliferation, metastasis, and cellular metabolism (Angel, P., et al. (1987) Cell 49, 729-739. AP-1 is induced by a variety of stimuli and is implicated in the development of cancer and autoimmune disease. The nucleotide sequence and amino acid sequence of human AP-1, is described in, for example, GenBank Accession No. gi:20127489.

As used herein, the term “nucleic acid” includes fragments or equivalents thereof (e.g., fragments or equivalents thereof KRC, TRAF, c-Jun, c-Fos, GATA3, Runx2, SMAD2, SMAD3, GLα, CBFβ, ATF4, RSK2, and/or WWP1). The term “equivalent” is intended to include nucleotide sequences encoding functionally equivalent proteins, i.e., KRC variant proteins which have the ability to bind to the natural binding partner(s) of the KRC or variant proteins in a signal transduction pathway involving KRC that retain their biological activity. In a preferred embodiment, a functionally equivalent KRC protein has the ability to bind TRAF, e.g., TRAF2, in the cytoplasm of an immune cell, e.g., a T cell. In another preferred embodiment, a functionally equivalent KRC protein has the ability to bind Jun, e.g., c-Jun, in the nucleoplasm of an immune cell, e.g., a T cell. In another preferred embodiment, a functionally equivalent KRC protein has the ability to bind GATA3 in the nucleoplasm of an immune cell, e.g., a T cell. In yet another preferred embodiment, a functionally equivalent KRC protein has the ability to bind SMAD, e.g., SMAD2 and/or SMAD3, in the cytoplasm of an immune cell, e.g., a B cell. In yet another preferred embodiment, a functionally equivalent KRC protein has the ability to bind SMAD3 in the cytoplasm of an osteoblast. In yet another preferred embodiment, a functionally equivalent KRC has the ability to bind Runx2 in the nucleoplasm of an immune cell, e.g., a B cell. In another preferred embodiment, a functionally equivalent KRC has the ability to bind Runx2. In yet another preferred embodiment, a functionally equivalent KRC has the ability to bind WWP1. In yet another preferred embodiment, a functionally equivalent KRC has the ability to bind SMAD3, Runx2, and/or WWP1. In another preferred embodiment, a functional equivalent of a KRC molecule comprises a PPXY motif and has the ability to bind WWP1. In another preferred embodiment, a functional equivalent of a Runx2 molecule comprises the Runt domain, e.g., amino acids 102-229 of Runx2, and has the ability to bind KRC. In another preferred embodiment, a functional equivalent of a Runx2 molecule comprises a PPXY motif in its Runt domain, e.g., amino acids 102-229 of Runx2, and has the ability to bind WWP1. In yet another preferred embodiment, a functionally equivalent KRC has the ability to bind RSK2 and/or WWP1.

An “isolated” nucleic acid molecule is one which is separated from other nucleic acid molecules which are present in the natural source of the nucleic acid. For example, with regards to genomic DNA, the term “isolated” includes nucleic acid molecules which are separated from the chromosome with which the genomic DNA is naturally associated. Preferably, an “isolated” nucleic acid molecule is free of sequences which naturally flank the nucleic acid molecule (i.e., sequences located at the 5′ and 3′ ends of the nucleic acid molecule) in the genomic DNA of the organism from which the nucleic acid molecule is derived.

As used herein, an “isolated protein” or “isolated polypeptide” refers to a protein or polypeptide that is substantially free of other proteins, polypeptides, cellular material and culture medium when isolated from cells or produced by recombinant DNA techniques, or chemical precursors or other chemicals when chemically synthesized. An “isolated” or “purified” protein or biologically active portion thereof is substantially free of cellular material or other contaminating proteins from the cell or tissue source from which the KRC protein is derived, or substantially free from chemical precursors or other chemicals when chemically synthesized. The language “substantially free of cellular material” includes preparations of KRC protein in which the protein is separated from cellular components of the cells from which it is isolated or recombinantly produced.

The nucleic acids of the invention can be prepared, e.g., by standard recombinant DNA techniques. A nucleic acid of the invention can also be chemically synthesized using standard techniques. Various methods of chemically synthesizing polydeoxynucleotides are known, including solid-phase synthesis which has been automated in commercially available DNA synthesizers (See e.g., Itakura et al. U.S. Pat. No. 4,598,049; Caruthers et al. U.S. Pat. No. 4,458,066; and Itakura U.S. Pat. Nos. 4,401,796 and 4,373,071, incorporated by reference herein).

As used herein, the term “vector” refers to a nucleic acid molecule capable of transporting another nucleic acid to which it has been linked. One type of vector is a “plasmid”, which refers to a circular double stranded DNA loop into which additional DNA segments may be ligated. Another type of vector is a viral vector, wherein additional DNA segments may be ligated into the viral genome. Certain vectors are capable of autonomous replication in a host cell into which they are introduced (e.g., bacterial vectors having a bacterial origin of replication and episomal mammalian vectors). Other vectors (e.g., non-episomal mammalian vectors) are integrated into the genome of a host cell upon introduction into the host cell, and thereby are replicated along with the host genome. Moreover, certain vectors are capable of directing the expression of genes to which they are operatively linked. Such vectors are referred to herein as “recombinant expression vectors” or simply “expression vectors”. In general, expression vectors of utility in recombinant DNA techniques are often in the form of plasmids. In the present specification, “plasmid” and “vector” may be used interchangeably as the plasmid is the most commonly used form of vector. However, the invention is intended to include such other forms of expression vectors, such as viral vectors (e.g., replication defective retroviruses, adenoviruses, adeno-associated viruses, lentiviruses), which serve equivalent functions.

As used herein, the term “host cell” is intended to refer to a cell into which a nucleic acid molecule of the invention, such as a recombinant expression vector of the invention, has been introduced. The terms “host cell” and “recombinant host cell” are used interchangeably herein. It should be understood that such terms refer not only to the particular subject cell but to the progeny or potential progeny of such a cell. Because certain modifications may occur in succeeding generations due to either mutation or environmental influences, such progeny may not, in fact, be identical to the parent cell, but are still included within the scope of the term as used herein. Preferably a host cell is a mammalian cell, e.g., a mouse cell, a human cell. In one embodiment, it is an epithelial cell. In another embodiment, a host cell is a mesenchymal stem cell. In yet another embodiment, a host cell is an osteoblast.

As used herein, the term “transgenic cell” refers to a cell containing a transgene.

As used herein, a “transgenic animal” includes an animal, e.g., a non-human mammal, e.g., a swine, a monkey, a goat, or a rodent, e.g., a mouse, in which one or more, and preferably essentially all, of the cells of the animal include a transgene. The transgene is introduced into the cell, directly or indirectly by introduction into a precursor of the cell, e.g., by microinjection, transfection or infection, e.g., by infection with a recombinant virus. The term genetic manipulation includes the introduction of a recombinant DNA molecule. This molecule may be integrated within a chromosome, or it may be extrachromosomally replicating DNA.

As used herein, the term “antibody” is intended to include immunoglobulin molecules and immunologically active portions of immunoglobulin molecules, i.e., molecules that contain an antigen binding site which binds (immunoreacts with) an antigen, such as Fab and F(ab′)₂ fragments, single chain antibodies, intracellular antibodies, scFv, Fd, or other fragments, as well as intracellular antibodies. Preferably, antibodies of the invention bind specifically or substantially specifically to KRC, TRAF, c-Jun, c-Fos, GATA3, SMAD2, SMAD3, CBFβ, ATF4, RSK2, WWP1 or Runx2, molecules (i.e., have little to no cross reactivity with non-KRC, non-TRAF, non-c-Jun, non-c-Fos, non-GATA3, non-SMAD2, non-SMAD3, non-WWP1, non-CBFβ, non-ATF4, non-RSK2, or non-Runx2, molecules). The terms “monoclonal antibodies” and “monoclonal antibody composition”, as used herein, refer to a population of antibody molecules that contain only one species of an antigen binding site capable of immunoreacting with a particular epitope of an antigen, whereas the term “polyclonal antibodies” and “polyclonal antibody composition” refer to a population of antibody molecules that contain multiple species of antigen binding sites capable of interacting with a particular antigen. A monoclonal antibody compositions thus typically display a single binding affinity for a particular antigen with which it immunoreacts.

As used herein, the term “disorders that would benefit from the modulation of KRC activity or expression” or “KRC associated disorder” includes disorders in which KRC activity is aberrant or which would benefit from modulation of a KRC activity. Exemplary KRC associated disorders include disorders, diseases, conditions or injuries in which modulation of bone formation and mineralization would be beneficial.

In one embodiment, small molecules can be used as test compounds. The term “small molecule” is a term of the art and includes molecules that are less than about 7500, less than about 5000, less than about 1000 molecular weight or less than about 500 molecular weight. In one embodiment, small molecules do not exclusively comprise peptide bonds. In another embodiment, small molecules are not oligomeric. Exemplary small molecule compounds which can be screened for activity include, but are not limited to, peptides, peptidomimetics, nucleic acids, carbohydrates, small organic molecules (e.g., Cane et al. 1998. Science 282:63), and natural product extract libraries. In another embodiment, the compounds are small, organic non-peptidic compounds. In a further embodiment, a small molecule is not biosynthetic. For example, a small molecule is preferably not itself the product of transcription or translation.

Various aspects of the invention are described in further detail below:

### II. SCREENING ASSAYS

Modulators of KRC activity can be known (e.g., dominant negative inhibitors of KRC activity, antisense KRC intracellular antibodies that interfere with KRC activity, peptide inhibitors derived from KRC) or can be identified using the methods described herein. The invention provides methods (also referred to herein as “screening assays”) for identifying other modulators, i.e., candidate or test compounds or agents (e.g., peptidomimetics, small molecules or other drugs) which modulate KRC activity and for testing or optimizing the activity of other agents.

For example, in one embodiment, molecules which bind, e.g., to KRC or a molecule in a signaling pathway involving KRC (e.g., TRAF, NF-kB, JNK, GATA3, SMAD2, SMAD3, CBFβ, JNK, TGFβ, ATF4, RSK2, and/or AP-1) or have a stimulatory or inhibitory effect on the expression and or activity of KRC or a molecule in a signal transduction pathway involving KRC can be identified. For example, c-Jun, NF-kB, TRAF, GATA3, SMAD2, SMAD3, Runx2, WWP1, CBFβ, JNK, TGFβ, ATF4, RSK2, and/or AP-1 function in a signal transduction pathway involving KRC, therefore, any of these molecules can be used in the subject screening assays. Although the specific embodiments described below in this section and in other sections may list one of these molecules as an example, other molecules in a signal transduction pathway involving KRC can also be used in the subject screening assays.

In one embodiment, the ability of a compound to directly modulate the expression, post-translational modification (e.g., phosphorylation), or activity of KRC is measured in an indicator composition using a screening assay of the invention.

The indicator composition can be a cell that expresses the KRC protein or a molecule in a signal transduction pathway involving KRC, for example, a cell that naturally expresses or, more preferably, a cell that has been engineered to express the protein by introducing into the cell an expression vector encoding the protein. Preferably, the cell is a mammalian cell, e.g., a mouse cell and/or a human cell. In one embodiment, the cell is derived from an adult. In one embodiment, the cell is a T cell. In another embodiment, the cell is a B cell. In another embodiment, the cell is an osteoblast. In one embodiment, the osteoblast is a primary calvarial osteoblast. In another embodiment, the osteoblast is a C3H10T1/2 osteoblast. In another embodiment, the cell is a mature osteoblast. In another embodiment, the cell is a mesenchymal stem cell. In another embodiment, cells for use in the screening assays of the invention are primary cells, e.g., isolated cells cultured in vitro that have not been immortalized. In another embodiment, cells for use in the screening assays of the invention are immortalized cells, i.e., cells from a cell line. In one embodiment, the cell line is the MC3T3-E1 cell line. In another embodiment, the cell line is the 293T cell line. Alternatively, the indicator composition can be a cell-free composition that includes the protein (e.g., a cell extract or a composition that includes e.g., either purified natural or recombinant protein).

Compounds identified using the assays described herein can be useful for treating disorders associated with aberrant expression, post-translational modification, or activity of KRC or a molecule in a signaling pathway involving KRC e.g., disorders that would benefit from modulation of bone formation and mineralization, modulation of osteoclastogenesis, modulation of osteoblast versus osteoclast activity, modulation of osteocalcin gene transcription, modulation of the degradation of Runx 2, e.g., modulation of Runx2 protein levels, modulation of the ubiquitination of Runx2, modulation of WWP1 activity, e.g., ubiquitination activity, modulation of the expression of RSK2, degradation of RSK2, e.g., modulation of RSK2 protein levels, ubiquitination of RSK2, modulation of the phosphorylation of RSK2, modulation of RSK2 kinase activity, modulation of the expression of BSP, ColI(α)1, OCN, Osterix, RANKL, and ATF4, modulation of ATF4 protein levels, and/or modulation of the phosphorylation of ATF4.

Conditions that can benefit from modulation of a signal transduction pathway involving KRC include diseases, disorders, conditions, or injuries in which modulation of bone formation and mineralization would be beneficial. In one embodiment, bone formation and mineralization is modulated in a postnatal subject. In another embodiment, bone formation and mineralization is modulated in an adult subject, e.g., a subject in which the epiphyseal discs of, for example, the long bones have disappeared, i.e., the epiphysis and the diaphysis have fused.

In another aspect, the invention pertains to a combination of two or more of the assays described herein. For example, a modulating agent can be identified using a cell-based or a cell-free assay, and the ability of the agent to modulate the activity of KRC or a molecule in a signal transduction pathway involving KRC can be confirmed in vivo, e.g., in an animal, such as, for example, an animal model for, e.g., osteoporosis or osteopetrosis. In one embodiment, the animal model of osteoporosis is an animal model of bone loss in postmenopausal women, e.g., due to a decrease in estrogen and subsequent increase in FSH, e.g., a mouse model of osteoporosis, e.g., an ovariectomized mouse. In another embodiment, an animal model for use in the methods of the invention, e.g., a mouse model of osteopenia, is a transgenic mouse overexpressing WWP1 (described below). In one embodiment, the transgenic WWP1 mouse comprises a conditional allele of WWP1, e.g., an allele of WWP1 which spatially restricts the expression of WWP1 to, e.g., an osteoblast. In one embodiment, the conditional WWP1 allele comprises the human WWP1 allele. In one embodiment, WWP1 is expressed under the control of a tissue specific promoter. In one embodiment, a tissue specific promoter is a type I collagen promoter. In another embodiment, a tissue specific promoter is the Osterix promoter.

Moreover, a modulator of KRC or a molecule in a signaling pathway involving KRC identified as described herein (e.g., an antisense nucleic acid molecule, or a specific antibody, or a small molecule) can be used in an animal model to determine the efficacy, toxicity, or side effects of treatment with such a modulator. Alternatively, a modulator identified as described herein can be used in an animal model to determine the mechanism of action of such a modulator.

In another embodiment, it will be understood that similar screening assays can be used to identify compounds that indirectly modulate the activity and/or expression of KRC e.g., by performing screening assays such as those described above using molecules with which KRC interacts, e.g., molecules that act either upstream or downstream of KRC in a signal transduction pathway.

In one embodiment of the invention, the cell based and/or cell free assays are performed in a high-throughput manner. In one embodiment, the assays are performed using a 96-well format. In another embodiment, the assays of the invention are performed using a 192-well format. In another embodiment, the assays of the invention are performed using a 384-well format. In one embodiment, the assays of the invention are semi-automated, e.g., a portion of the assay is performed in an automated manner, e.g., the addition of various reagents. In another embodiment, the assays of the invention are fully automated, e.g., the addition of all reagents to the assay and the capture of assay results are automated.

The assays of the invention generally involve contacting an assay composition with a compound of interest or a library of compounds for a predetermined amount of time or at a predetermined time of growth (either in vitro or in vivo) and assaying for the effect of the compound on a particular read-out. In one embodiment, an assay composition is contacted with a compound of interest or a library of compounds for the duration of the assay. In another embodiment, an assay composition is contacted with a compound of interest or a library of compounds for a period of time less than the entire assay time period. For example, cells may be cultured for a period of days or weeks and may be contacted with a compound following, for example, 14 days in culture. In one embodiment, cells are contacted with a compound of interest for 1, 2, 3, 4, 5, 6, 7, 8, 9, 10, 11, 12, 13, 14, 15, 16, 17, 18, 19, 20, or 21 days. In one embodiment, assay compositions of the invention are contacted with a compound for a predetermined time period, the compound is removed, and the assay composition is maintained in the absence of the compound for a predetermined period prior to assaying for a particular read-out. In addition, non-human animals for use in the methods of the invention (described in detail below) may be contacted with a compound of interest for 1, 2, 3, 4, 5, 6, 7, 8, 9, 10, 11, 12, 13, 14, 15, 16, 17, 18, 19, 20, 21 days, 4, 5, 6, 7, 8, 9, 10, 11, or 12 weeks. Non-human animals of the invention may also be, for example, ovarectomized, and contacted with a compound of the invention, 0, 1 2, 3, 4, 5, 6, 7, 8, 9, 10, 11, or 12, weeks following surgery. In another embodiment, surgically altered non-human animals may be contacted with a compound of interest prior to surgery, e.g., 1, 2, 3, 4, 5, 6, 7, 8, 9, 10, 11, 12, 13, 14 days prior to surgery.

The compounds of the invention may be assayed at concentrations suitable to the assay and readily determined by one of skill in the art. For example in one embodiment, assay compositions are contacted with millimolar concentrations of compounds. In another embodiment, assay compositions are contacted with micromolar concentrations of compounds. In another embodiment, assay compositions are contacted with nanomolar concentrations of compounds.

The cell based and cell free assays of the invention are described in more detail below.

### A. Cell Based Assays

The indicator compositions of the invention can be cells that express at least one of a KRC protein or non-KRC protein in the KRC signaling pathway (such as, e.g., TRAF, NF-kB, JNK, Jun, TGFβ, GATA3, SMAD2, SMAD3, CBFβ, WWP1, Runx2, RSK2, ATF4, and/or AP-1) for example, a cell that naturally expresses the endogenous molecule or, more preferably, a cell that has been engineered to express at least one of an exogenous KRC, TRAF, NF-kB, JNK, Jun, TGFβ, GATA3, SMAD2, SMAD3, CBFβ, WWP1, Runx2, ATF4, RSK2, and/or AP-1 protein by introducing into the cell an expression vector encoding the protein(s). Alternatively, the indicator composition can be a cell-free composition that includes at least one of a KRC or a non-KRC protein such as TRAF, NF-kB, JNK, Jun, TGFβ, GATA3, SMAD2, SMAD3, WWP1, CBFβ, Runx2, ATF4, RSK2, and/or (e.g., a cell extract from a cell expressing the protein or a composition that includes purified KRC, TRAF, NF-kB, JNK, Jun, TGFβ, GATA3, SMAD2, SMAD3, WWP1, Runx2, ATF4, RSK2, and/or AP-1 protein, either natural or recombinant protein).

A variety of cell types are suitable for use as an indicator cell in the screening assay. Preferably a cell line is used which expresses low levels of endogenous KRC (or, e.g., TRAF, Fos, Jun, NF-kB, TGFβ, GATA3, SMAD2, SMAD3, CBFβ, WWP1, AP-1, ATF4, RSK2, and/or Runx2) and is then engineered to express recombinant protein. Cells for use in the subject assays include both eukaryotic and prokaryotic cells. For example, in one embodiment, a cell is a bacterial cell. In another embodiment, a cell is a fungal cell, such as a yeast cell. In another embodiment, a cell is a vertebrate cell, e.g., an avian cell or a mammalian cell (e.g., a murine cell, or a human cell). Preferably, the cell is a mammalian cell, e.g., a human cell. Alternatively, the indicator composition can be a cell-free composition that includes the protein (e.g., a cell extract or a composition that includes e.g., either purified natural or recombinant protein).

Compounds that modulate expression and/or activity of KRC, or a non-KRC protein that acts upstream or downstream of can be identified using various “read-outs.”

For example, an indicator cell can be transfected with an expression vector, incubated in the presence and in the absence of a test compound, and the effect of the compound on the expression of the molecule or on a biological response regulated by the molecule can be determined. The biological activities of include activities determined in vivo, or in vitro, according to standard techniques. Activity can be a direct activity, such as an association with a target molecule or binding partner (e.g., a protein such as the Jun, e.g., c-Jun, TRAF, e.g., TRAF2, GATA3, SMAD, e.g., SMAD2, SMAD3, CBFβ, Runx2, RSK2, and/or WWP1. In one embodiment, the interaction of Runx2 and CBFβ is measured. In one embodiment, the interaction of Runx2 and WWP1 is measured. In one embodiment, the interaction of RSK2 and WWP1 is measured. In one embodiment, the interaction of KRC and WWP1 is measured. Alternatively, the activity is an indirect activity, such as a cellular signaling activity occurring downstream of the interaction of the protein with a target molecule or a biological effect occurring as a result of the signaling cascade triggered by that interaction. For example, biological activities of KRC include: modulation of TNFα production, modulation of IL-2 production, modulation of a JNK signaling pathway, modulation of an NFkB signaling pathway, modulation of a TGF signaling pathway, modulation of AP-1 activity, modulation of Ras and Rac activity, modulation of actin polymerization, modulation of ubiquitination of AP-1, modulation of ubiquitination of TRAF2, modulation of the degradation of c-Jun, modulation of the degradation of c-Fos, modulation of degradation of SMAD3, modulation of degradation of GATA3, modulation of effector T cell function, modulation of T cell anergy, modulation of apoptosis, or modulation of T cell differentiation, modulation of IgA germline transcription, modulation of bone formation and mineralization, modulation of osteoclastogenesis, modulation of osteoblast versus osteoclast activity, modulation of osteocalcin gene transcription, modulation of the degradation of Runx 2, e.g., modulation of Runx2 protein levels, modulation of the ubiquitination of Runx2, modulation of WWP1 activity, e.g., ubiquitination activity of WWP1, modulation of the expression of RSK2, degradation of RSK2, e.g., modulation of RSK2 protein levels, ubiquitination of RSK2, modulation of the phosphorylation of RSK2, modulation of RSK2 kinase activity, modulation of the expression of BSP, ColI(α)1, OCN, Osterix, RANKL, and ATF4, modulation of ATF4 protein levels, and/or modulation of the phosphorylation of ATF4.

To determine whether a test compound modulates KRC protein expression, or the expression of a protein in a signal transduction pathway involving KRC as described herein, in vitro transcriptional assays can be performed. In one example of such an assay, a regulatory sequence (e.g., the full length promoter and enhancer) of KRC can be operably linked to a reporter gene such as chloramphenicol acetyltransferase (CAT), GFP, or luciferase, e.g., OSE2-luciferase, and introduced into host cells. In one embodiment, a reporter gene construct is a multimerized construct. In one embodiment, the multimerized construct comprises the osteocalcin regulatory sequence. In one embodiment, the multimerized osteocalcin construct comprises six copies of the osteocalcin regulatory sequence operably linked to a luciferase reporter gene. Other techniques are known in the art.

To determine whether a test compound modulates KRC mRNA expression, or the expression of genes modulated by KRC, e.g., BSP, ColI(α)1, OCN, RANKL, Osterix, RSK2, and ATF4, various methodologies can be performed, such as quantitative or real-time PCR.

As used interchangeably herein, the terms “operably linked” and “operatively linked” are intended to mean that the nucleotide sequence is linked to a regulatory sequence in a manner which allows expression of the nucleotide sequence in a host cell (or by a cell extract). Regulatory sequences are art-recognized and can be selected to direct expression of the desired protein in an appropriate host cell. The term regulatory sequence is intended to include promoters, enhancers, polyadenylation signals and other expression control elements. Such regulatory sequences are known to those skilled in the art and are described in Goeddel, Gene Expression Technology: Methods in Enzymology 185, Academic Press, San Diego, Calif. (1990). It should be understood that the design of the expression vector may depend on such factors as the choice of the host cell to be transfected and/or the type and/or amount of protein desired to be expressed.

A variety of reporter genes are known in the art and are suitable for use in the screening assays of the invention. Examples of suitable reporter genes include those which encode chloramphenicol acetyltransferase, beta-galactosidase, alkaline phosphatase, green fluorescent protein, or luciferase. Standard methods for measuring the activity of these gene products are known in the art.

A variety of cell types are suitable for use as an indicator cell in the screening assay. In one embodiment, a cell line is used which expresses low levels of at least one of endogenous KRC (or, e.g., TRAF, Fos, Jun, NF-kB, TGFβ, GATA3, SMAD2, SMAD3, CBFβ, WWP1, AP-1, ATF4, RSK2, and/or Runx2) and is then engineered to express recombinant protein. Cells for use in the subject assays include both eukaryotic and prokaryotic cells. For example, in one embodiment, a cell is a bacterial cell. In another embodiment, a cell is a fungal cell, such as a yeast cell. In another embodiment, a cell is a vertebrate cell, e.g., an avian cell or a mammalian cell (e.g., a murine cell, or a human cell). In another embodiment, primary cells are used which express low levels of at least one of endogenous KRC (or, e.g., TRAF, Fos, Jun, NF-kB, TGFβ, GATA3, SMAD2, SMAD3, CBFβ, WWP1, AP-1, ATF4, RSK2, and/or Runx2).

In one embodiment, the level of expression of the reporter gene in the indicator cell in the presence of the test compound is higher than the level of expression of the reporter gene in the indicator cell in the absence of the test compound and the test compound is identified as a compound that stimulates the expression of KRC (or, e.g., TRAF, Fos, Jun, NF-kB, TGFβ, GATA3, SMAD2, SMAD3, CBFβ, WWP1, AP-1, ATF4, RSK2, and/or Runx2). In another embodiment, the level of expression of the reporter gene in the indicator cell in the presence of the test compound is lower than the level of expression of the reporter gene in the indicator cell in the absence of the test compound and the test compound is identified as a compound that inhibits the expression of KRC (or, e.g., TRAF, Fos, Jun, NF-kB, TGFβ, GATA3, SMAD2, SMAD3, CBFβ, WWP1, AP-1, ATF4, RSK2, and/or Runx2).

In one embodiment, the invention provides methods for identifying compounds that modulate cellular responses in which KRC is involved.

In one embodiment differentiation of cells, e.g., T cells or mesenchymal cells, can be used as an indicator of modulation of KRC or a signal transduction pathway involving KRC. Cell differentiation can be monitored directly (e.g. by microscopic examination of the cells for monitoring cell differentiation), or indirectly, e.g., by monitoring one or more markers of cell differentiation (e.g., an increase in mRNA for a gene product associated with cell differentiation, or the secretion of a gene product associated with cell differentiation, such as the secretion of a protein (e.g., the secretion of cytokines) or the expression of a marker (such as CD69). Standard methods for detecting mRNA of interest, such as reverse transcription-polymerase chain reaction (RT-PCR) and Northern blotting, are known in the art. Standard methods for detecting protein secretion in culture supernatants, such as enzyme linked immunosorbent assays (ELISA), are also known in the art. Proteins can also be detected using antibodies, e.g., in an immunoprecipitation reaction or for staining and FACS analysis.

In another embodiment, the ability of a compound to modulate effector T cell function can be determined. For example, in one embodiment, the ability of a compound to modulate T cell proliferation, cytokine production, and/or cytotoxicity can be measured using techniques well known in the art.

In one embodiment, the ability of a compound to modulate IL-2 production can be determined. Production of IL-2 can be monitored, for example, using Northern or Western blotting. IL-2 can also be detected using an ELISA assay or in a bioassay, e.g., employing cells which are responsive to IL-2 (e.g., cells which proliferate in response to the cytokine or which survive in the presence of the cytokine) using standard techniques.

In another embodiment, the ability of a compound to modulate apoptosis can be determined. Apoptosis can be measured in the presence or the absence of Fas-mediated signals. In one embodiment, cytochrome C release from mitochondria during cell apoptosis can be detected, e.g., plasma cell apoptosis (as described in, for example, Bossy-Wetzel E. et al. (2000) Methods in Enzymol. 322:235-42). Other exemplary assays include: cytofluorometric quantization of nuclear apoptosis induced in a cell-free system (as described in, for example, Lorenzo H. K. et al. (2000) Methods in Enzymol. 322:198-201); apoptotic nuclease assays (as described in, for example, Hughes F. M. (2000) Methods in Enzymol. 322:47-62); analysis of apoptotic cells, e.g., apoptotic plasma cells, by flow and laser scanning cytometry (as described in, for example, Darzynkiewicz Z. et al. (2000) Methods in Enzymol. 322:18-39); detection of apoptosis by annexin V labeling (as described in, for example, Bossy-Wetzel E. et al. (2000) Methods in Enzymol. 322:15-18); transient transfection assays for cell death genes (as described in, for example, Miura M. et al. (2000) Methods in Enzymol. 322:480-92); and assays that detect DNA cleavage in apoptotic cells, e.g., apoptotic plasma cells (as described in, for example, Kauffman S. H. et al. (2000) Methods in Enzymol. 322:3-15). Apoptosis can also be measured by propidium iodide staining or by TUNEL assay. In another embodiment, the transcription of genes associated with a cell signaling pathway involved in apoptosis (e.g., JNK) can be detected using standard methods.

In another embodiment, mitochondrial inner membrane permeabilization can be measured in intact cells by loading the cytosol or the mitochondrial matrix with a die that does not normally cross the inner membrane, e.g., calcein (Bernardi et al. 1999. Eur. J. Biochem. 264:687; Lemasters, J., J. et al. 1998. Biochem. Biophys. Acta 1366:177. In another embodiment, mitochondrial inner membrane permeabilization can be assessed, e.g., by determining a change in the mitochondrial inner membrane potential (ΔΨm). For example, cells can be incubated with lipophilic cationic fluorochromes such as DiOC6 (Gross et al. 1999. Genes Dev. 13:1988) (3,3′ dihexyloxacarbocyanine iodide) or JC-1 (5,5′,6,6′-tetrachloro-1,1′, 3,3′-tetraethylbenzimidazolylcarbocyanine iodide). These dyes accumulate in the mitochondrial matrix, driven by the Ψm. Dissipation results in a reduction of the fluorescence intensity (e.g., for DiOC6 (Gross et al. 1999. Genes Dev. 13:1988) or a shift in the emission spectrum of the dye. These changes can be measured by cytofluorometry or microscopy.

In yet another embodiment, the ability of a compound to modulate translocation of KRC to the nucleus can be determined. Translocation of KRC to the nucleus can be measured, e.g., by nuclear translocation assays in which the emission of two or more fluorescently-labeled species is detected simultaneously. For example, the cell nucleus can be labeled with a known fluorophore specific for DNA, such as Hoechst 33342. The KRC protein can be labeled by a variety of methods, including expression as a fusion with GFP or contacting the sample with a fluorescently-labeled antibody specific for KRC. The amount KRC that translocates to the nucleus can be determined by determining the amount of a first fluorescently-labeled species, i.e., the nucleus, that is distributed in a correlated or anti-correlated manner with respect to a second fluorescently-labeled species, i.e., KRC, as described in U.S. Pat. No. 6,400,487, the contents of which are hereby incorporated by reference.

In one embodiment, the effect of a compound on a JNK signaling pathway can be determined. The JNK group of MAP kinases is activated by exposure of cells to environmental stress or by treatment of cells with pro-inflammatory cytokines. A combination of studies involving gene knockouts and the use of dominant-negative mutants have implicated both MKK4 and MKK7 in the phosphorylation and activation of JNK. Targets of the JNK signal transduction pathway include the transcription factors ATF2 and c-Jun. JNK binds to an NH₂-terminal region of ATF2 and c-Jun and phosphorylates two sites within the activation domain of each transcription factor, leading to increased transcriptional activity. JNK is activated by dual phosphorylation on Thr-183 and Tyr-185. To determine the effect of a compound on a JNK signal transduction pathway, the ability of the compound to modulate the activation status of various molecules in the signal transduction pathway can be determined using standard techniques. For example, in one embodiment, the phosphorylation status of JNK can be examined by immunoblotting with the anti-ACTIVE-JNK antibody (Promega), which specifically recognizes the dual phosphorylated TPY motif.

In another embodiment, the effect of a compound on an NFkB signal transduction pathway can be determined. The ability of the compound to modulate the activation status of various components of the NFkB pathway can be determined using standard techniques. NFkB constitutes a family of Rel domain-containing transcription factors that play essential roles in the regulation of inflammatory, anti-apoptotic, and immune responses. The function of the NFkB/Rel family members is regulated by a class of cytoplasmic inhibitory proteins termed IBs that mask the nuclear localization domain of NFkB causing its retention in the cytoplasm. Activation of NFkB by TNF-α and IL-1 involves a series of signaling intermediates, which may converge on the NFkB-inducing kinase (NIK). This kinase in turn activates the IB kinase (IKK) isoforms. These IKKs phosphorylate the two regulatory serines located in the N termini of IB molecules, triggering rapid ubiquitination and degradation of IB in the 26S proteasome complex. The degradation of IB unmasks a nuclear localization signal present in the NFkB complex, allowing its rapid translocation into the nucleus, where it engages cognate B enhancer elements and modulates the transcription of various NFkB-responsive target genes. In one embodiment, the ability of a compound to modulate one or more of: the status of NFkB inhibitors, the ability of NFkB to translocate to the nucleus, or the activation of NFkB dependent gene transcription can be measured.

In one embodiment, the ability of a compound to modulate AP-1 activity can be measured. The AP-1 complex is comprised of the transcription factors Fos and Jun. The AP-1 complex activity is controlled by regulation of Jun and Fos transcription and by posttranslation modification, for example, the activation of several MAPKS, ERK, p38 and JN, is required for AP-1 transcriptional activity. In one embodiment, the modulation of transcription mediated by AP-1 can be measured. In another embodiment, the ability of a compound to modulate the activity of AP-1, e.g., by modulating its phosphorylation or its ubiquitination can be measured. In one embodiment, the ubiquitination of AP-1 can be measured using techniques known in the art. In another embodiment, the degradation of AP-1 (or of c-Jun and/or c-Fos) can be measured using known techniques.

The loss of AP-1 has been associated with T cell anergy. Accordingly, in one embodiment, the ability of a test compound to modulate T cell anergy can be determined, e.g., by assaying secondary T cell responses. If the T cells are unresponsive to the secondary activation attempts, as determined by IL-2 synthesis and/or T cell proliferation, a state of anergy or has been induced. Standard assay procedures can be used to measure T cell anergy, for example, T cell proliferation can be measured, for example, by assaying [³H] thymidine incorporation. In another embodiment, signal transduction can be measured, e.g., activation of members of the MAP kinase cascade or activation of the AP-1 complex can be measured. In another embodiment, intracellular calcium mobilization, protein levels members of the NFAT cascade can be measured.

In another embodiment, the effect of a compound on Ras and Rac activity can be measured using standard techniques. In one embodiment, actin polymerization, e.g., by measuring the immunofluorescence of F-actin can be measured.

In another embodiment, the effect of the compound on ubiquitination of, for example, AP1, SMAD, TRAF, RSK2, and/or Runx2, can be measured, by, for example in vitro or in vivo ubiquitination assays. In vitro ubiquitination assays are described in, for example, Fuchs, S. Y., Bet al. (1997) J. Biol. Chem. 272:32163-32168. In vivo ubiquitination assays are described in, for example, Treier, M., L. et al. (1994) Cell 78:787-798.

In one embodiment, a low throughput assay may be used to assess the effect of a compound on ubiquitination. For example, the autoubiquitination of WWP1 or WWP1-mediated ubiquitination of Runx2 may be measured in assays using the HECT domain and recombinant E1 and E2 (UbCH7). Products may be resolved by reducing SDS-PAGE to detect poly-ubiquinated products in the presence and absence of a test compound. Biotinylated ubiquitin and detectably labeled streptavidin may be used to visualize ubiquitin on the products.

In another embodiment, a high throughput assay may be used to screen for compounds that affect ubiquitination. For example, an antibody recognizing a protein tag (e.g., myc) may be bound to the wells of a plate. Epitope-tagged WWP1 comprising a HECT domain may then be bound to the antibody on the plate. Compounds may be tested for their ability to modulate the autoubiquitination of WWP1 in the presence of biotinylated ubiquitin and E1/UbCH7. Biotinylated ubiquitin may be detected with streptavidin, e.g., labeled with alkaline phosphatase.

In another embodiment, the effect of the compound on the degradation of, for example, a KRC target molecule and/or a KRC binding partner, can be measured by, for example, coimmunoprecipitation of KRC, e.g., full-length KRC and/or a fragment thereof, with, e.g., SMAD, GATA3, Runx2, RSK2, TRAF, Jun, and/or Fos. Western blotting of the coimmunoprecipitate and probing of the blots with antibodies to KRC and the KRC target molecule and/or a KRC binding partner can be quantitated to determine whether degradation has occurred. Pulse-chase experiments can also be performed to determine protein levels.

In one embodiment, the ability of the compound to modulate TGFβ signaling in B cells can be measured. For example, as described herein, KRC is a coactivator of GLα promoter activity and a corepressor of the osteocalcin gene. In the absence of KRC, GLα transcription is diminished in B cells, and osteocalcin gene transcription is augmented in osteoblasts. Accordingly, in one embodiment, the ability of the compound to modulate TGFβ signaling in B cells can be measured by measuring the transcription of GLα. In another embodiment, osteocalcin gene transcription can be measured. In one embodiment, RT-PCR is used to measure the transcription. Furthermore, given the ability of KRC to interact with SMAD and drive the transcription of a SMAD reporter construct, the ability of a compound to modulate TGFβ signaling in B cells can be measured by measuring the transcriptional ability of SMAD. In one embodiment, SMAD, or a fragment thereof, e.g., a basic SMAD-binding element, is operably linked to a luciferase reporter gene. Other TGFβ regulated genes are known in the art (e.g., Massague and Wotton. 2000 EMBO 19:1745.).

In one embodiment, the ability of the compound to modulate ATF4 signaling in osteoblasts can be measured. For example, as described herein, overexpression of KRC inhibits ATF4-driven transcription and RSK2-mediated potentiation of ATF4 function. In the absence of KRC, ATF4 mRNA and protein levels are elevated, hyperphosphorylated ATF4 accumulates, and RSK2 autophosphorylation is increased, leading to , for example, hyperphosphorylated RSK2. Accordingly, in one embodiment, the ability of a compound to modulate ATF4 signaling in osteoblasts can be measured by, for example, measuring the transcription of ATF4. In another embodiment, the phosphorylation of ATF4 is measured. In yet another embodiment, the autophosphorylation of RSK2 is measured. Phosphorylation can be determined by, for example, the use of in vitro kinase assays, and the autophosphorylation of a protein such as RSK2, can be measured by, for example, immunoblotting with antibodies specific for phosphorylated and/or unphosphorylated forms of the protein, and/or immunoblotting with an antibody that recognizes phosphorylated serine/threonine preceeded by two upstream arginine residues, a consensus motif for Rsk protein substrates. In another embodiment, the kinase activity of RSK2 is determined by, for example, assessing the ability of RSK2 to phosphorylate a RSK2 substrate.

In another embodiment, the ability of the compound to modulate bone formation and mineralization can be measured. For example, as described herein, animals deficient in KRC develop an osteosclerotic phenotype associated due to augmented osteoblast activity and bone formation. The formation of a multimeric complex between KRC, Runx2, Smad3, and/or the E3 ubiquitin ligase, WWP1 inhibits Runx2 function due to the ability of WWP1 to promote Runx2 polyubiquitination and proteasome-dependent degradation. KRC is an integral and required component of this complex, since its absence in osteoblasts results in elevated levels of Runx2 protein, enhanced Runx2 transcriptional activity, elevated transcription of Runx2 target genes, and profoundly increased bone formation in vivo. Similarly, the formation of a multimeric complex between KRC, RSK2, and/or the E3 ubiquitin ligase, WWP1 inhibits RSK2 function due to the ability of WWP1 to promote RSK2 polyubiquitination and the ability of KRC and WWPI to inhibit RSK2 autophosphorylation. In the absence of KRC, RSK2 autophosphorylation is increased demonstrating an critical role of KRC in the regulation of RSK2 function. Various in vitro techniques for determining the ability of compound to modulate bone formation and mineralization are known to the skilled artisan. For example, skeletal architecture can be assayed by digital radiography of, trabeculation (i.e., the anastomosing bony spicules in cancerous bone which form a meshwork of intercommunicating spaces that are filled with bone marrow) can be determined by three-dimensional μ-QCT imaging, and by analyses of bone cross-sections. In addition, trabecular number, trabecular thickness, trabecular spacing, bone volume per tissue volume (BV/TV), and bone mineral density (BMD) can also be determined by μ-QCT imaging. These analyses can be performed on whole skeleton preparations or individual bones. Mineralized bone and non-mineralized cartilage formation can be determined by histochemical analyses, such as by alizarin red/alcian blue staining. To assay a compound for an effect on osteoblast function versus osteoclast function, in vitro osteoclast differentiation assays are performed by culturing bone marrow (BM) in the presence of M-CSF and RANKL to generate TRAP+ osteoclasts. In vivo determinations of whether a compound effects osteoblast function or osteoclast can be performed by, for example, bone marrow transfers. In addition, various histomorphometric parameters can be analyzed to determine bone formation rates. For example, dual calcein-labeling of bone visualized with fluorescent micrography allows the determination of bone formation rate (BFR), which is calculated by multiplying the mineral apposition rate (MAR), which is a reflection of the bone formation capabilities of osteoblasts, by the area of mineralized surface per bone surface (MS/BS). In one embodiment, a chelating fluorochrome, e.g., xylenol orange can be used to visualize bone. In addition, the total osteoblast surface, which a reliable indicator of osteoblast population, can be measured, as can osteoid thickness, i.e., the thickness of bone that has not undergone calcification. Sections of bone can also be analyzed by staining with Von Kossa and Toluidine Blue for analysis of in vivo bone formation and serum levels of, for example, Trabp5b and deoxypyridinoline can be determined as an indication of bone formation. The ex vivo culturing of osteoblast precursors and immature osteoblasts can also be performed to determine if cells possess the capacity to form mineralized nodules, which reflects the generation of extracellular matrix, i.e., the mineralized matrix of bone. Furthermore, these cultures can be assayed for their proliferative ability, e.g., by cell counting, and can be stained for the presence of various markers of bone formation, such as for example, alkaline phosphatase. These same cultures can also be used for various analyses of mRNA and protein production of numerous molecules known to be involved in bone formation and mineralization, and osteoclastogenesis, such as, for example, BSP, ColI(α)1, and OCN, ALP, LRP5, Osterix, Runx2, RANKL, RSK2, and ATF4.

The ability of a compound to modulate bone formation and mineralization can also be measured using cultured cells. In one embodiment, a mesenchymal stem cell may be used in an assay for bond formation. For example, a pluripotent cell capable to forming an osteoblast, i.e., a mesenchymal stem cells (e.g., a primary cell or a cell line, can be contacted with a compound of interest and the differentiation of the pluripotent cell into an osteoblast can be visually assessed. The differentiation of the pluripotent cell into an osteoblast can also be assessed by assaying the level of cellular alkaline phosphatase using a colorimetric assay. In one embodiment, total cell number is normalized to the level of cellular alkaline phosphatase by staining the cells with, for example, Alamar blue. The mineralization of such cultured, differentiated cells can be determined by, for example xylenol orange staining and/or von Kossa staining human) may be plated for culture on day 0. On day 1, cells may be differentiated. Also on day 1, test compounds may be added to the cultures. Differentiation may be analyzed (e.g., on day 4-10) using an alkaline phosphatase assay and cell viability may be measured using alamar blue. Extracellular matrix formation may also be measured, e.g., on day 21.

The ability of the test compound to modulate KRC (or a molecule in a signal transduction pathway involving to KRC) binding to a substrate or target molecule (e.g., TRAF, GATA3, SMAD2, SMAD3, CBFβ, WWP1, AP-1, RSK2, and/or Runx2, in the case of KRC) can also be determined. Determining the ability of the test compound to modulate KRC binding to a target molecule (e.g., a binding partner such as a substrate) can be accomplished, for example, by coupling the target molecule with a radioisotope or enzymatic label such that binding of the target molecule to KRC or a molecule in a signal transduction pathway involving KRC can be determined by detecting the labeled KRC target molecule in a complex. Alternatively, KRC be coupled with a radioisotope or enzymatic label to monitor the ability of a test compound to modulate KRC binding to a target molecule in a complex. Determining the ability of the test compound to bind to KRC can be accomplished, for example, by coupling the compound with a radioisotope or enzymatic label such that binding of the compound to KRC can be determined by detecting the labeled compound in a complex. For example, targets can be labeled with ¹²⁵I, ³⁵S, ¹⁴C, or ³H, either directly or indirectly, and the radioisotope detected by direct counting of radioemmission or by scintillation counting. Alternatively, compounds can be labeled, e.g., with, for example, horseradish peroxidase, alkaline phosphatase, or luciferase, and the enzymatic label detected by determination of conversion of an appropriate substrate to product.

In another embodiment, the ability of KRC or a molecule in a signal transduction pathway involving KRC to be acted on by an enzyme or to act on a substrate can be measured. For example, in one embodiment, the effect of a compound on the phosphorylation of KRC can be measured using techniques that are known in the art.

In another embodiment, the interaction of WWP1 and Runx2 may be measured using art recognized techniques.

It is also within the scope of this invention to determine the ability of a compound to interact with KRC or a molecule in a signal transduction pathway involving KRC without the labeling of any of the interactants. For example, a microphysiometer can be used to detect the interaction of a compound with a KRC molecule without the labeling of either the compound or the molecule (McConnell, H. M. et al. (1992) Science 257:1906-1912). As used herein, a “microphysiometer” (e.g., Cytosensor) is an analytical instrument that measures the rate at which a cell acidifies its environment using a light-addressable potentiometric sensor (LAPS). Changes in this acidification rate can be used as an indicator of the interaction between a compound and

Exemplary target molecules of KRC include: Jun, TRAF (e.g., TRAF2) GATA3, SMAD, e.g., SMAD2 and SMAD3, CBFβ, RSK2, and/or Runx2.

In another embodiment, a different (i.e., non-KRC) molecule acting in a pathway involving KRC that acts upstream or downstream of KRC can be included in an indicator composition for use in a screening assay. Compounds identified in a screening assay employing such a molecule would also be useful in modulating KRC activity, albeit indirectly. For example, the ability of TRAF (e.g., TRAF2) to activate NFKβ dependent gene expression can be measured, or the ability of SMAD to activate TGFβ-dependent gene transcription can be measured.

The cells of the invention can express at least one of KRC or another protein in a signaling pathway involving KRC endogenously or may be engineered to do so using recombinant technology. For example, a cell that has been engineered to express the KRC protein and/or a non protein which acts upstream or downstream of can be produced by introducing into the cell an expression vector encoding the protein.

Recombinant expression vectors that can be used for expression of KRC or a molecule in a signal transduction pathway involving KRC (e.g., a protein which acts upstream or downstream of KRC) are known in the art. For example, the cDNA is first introduced into a recombinant expression vector using standard molecular biology techniques. A cDNA can be obtained, for example, by amplification using the polymerase chain reaction (PCR) or by screening an appropriate cDNA library. The nucleotide sequences of cDNAs for or a molecule in a signal transduction pathway involving (e.g., human, murine and yeast) are known in the art and can be used for the design of PCR primers that allow for amplification of a cDNA by standard PCR methods or for the design of a hybridization probe that can be used to screen a cDNA library using standard hybridization methods.

Following isolation or amplification of a cDNA molecule encoding KRC or a non-KRC molecule in a signal transduction pathway involving KRC the DNA fragment is introduced into an expression vector. As used herein, the term “vector” refers to a nucleic acid molecule capable of transporting another nucleic acid to which it has been linked. One type of vector is a “plasmid”, which refers to a circular double stranded DNA loop into which additional DNA segments can be ligated. Another type of vector is a viral vector, wherein additional DNA segments can be ligated into the viral genome. Certain vectors are capable of autonomous replication in a host cell into which they are introduced (e.g., bacterial vectors having a bacterial origin of replication and episomal mammalian vectors). Other vectors (e.g., non-episomal mammalian vectors and/or viral vectors, e.g., lentiviruses) are integrated into the genome of a host cell upon introduction into the host cell, and thereby are replicated along with the host genome. Moreover, certain vectors are capable of directing the expression of genes to which they are operatively linked. Such vectors are referred to herein as “recombinant expression vectors” or simply “expression vectors”. In general, expression vectors of utility in recombinant DNA techniques are often in the form of plasmids. In the present specification, “plasmid” and “vector” may be used interchangeably as the plasmid is the most commonly used form of vector. However, the invention is intended to include such other forms of expression vectors, such as viral vectors (e.g., replication defective retroviruses, adenoviruses, adeno-associated viruses, and lentiviruses), which serve equivalent functions.

The recombinant expression vectors of the invention comprise a nucleic acid molecule in a form suitable for expression of the nucleic acid in a host cell, which means that the recombinant expression vectors include one or more regulatory sequences, selected on the basis of the host cells to be used for expression and the level of expression desired, which is operatively linked to the nucleic acid sequence to be expressed. Within a recombinant expression vector, “operably linked” is intended to mean that the nucleotide sequence of interest is linked to the regulatory sequence(s) in a manner which allows for expression of the nucleotide sequence (e.g., in an in vitro transcription/translation system or in a host cell when the vector is introduced into the host cell). The term “regulatory sequence” includes promoters, enhancers and other expression control elements (e.g., polyadenylation signals). Such regulatory sequences are described, for example, in Goeddel; Gene Expression Technology: Methods in Enzymology 185, Academic Press, San Diego, Calif. (1990). Regulatory sequences include those which direct constitutive expression of a nucleotide sequence in many types of host cell, those which direct expression of the nucleotide sequence only in certain host cells (e.g., tissue-specific regulatory sequences) or those which direct expression of the nucleotide sequence only under certain conditions (e.g., inducible regulatory sequences).

When used in mammalian cells, the expression vector's control functions are often provided by viral regulatory elements. For example, commonly used promoters are derived from polyoma virus, adenovirus, cytomegalovirus and Simian Virus 40. Non-limiting examples of mammalian expression vectors include pCDM8 (Seed, B., (1987) Nature 329:840) and pMT2PC (Kaufman et al. (1987), EMBO J. 6:187-195). A variety of mammalian expression vectors carrying different regulatory sequences are commercially available. For constitutive expression of the nucleic acid in a mammalian host cell, a preferred regulatory element is the cytomegalovirus promoter/enhancer. Moreover, inducible regulatory systems for use in mammalian cells are known in the art, for example systems in which gene expression is regulated by heavy metal ions (see e.g., Mayo et al. (1982) Cell 29:99-108; Brinster et al. (1982) Nature 296:39-42; Searle et al. (1985) Mol. Cell. Biol. 5:1480-1489), heat shock (see e.g., Nouer et al. (1991) in Heat Shock Response, e.d. Nouer, L., CRC, Boca Raton, Fla., pp 167-220), hormones (see e.g., Lee et al. (1981) Nature 294:228-232; Hynes et al. (1981) Proc. Natl. Acad. Sci. USA 78:2038-2042; Klock et al. (1987) Nature 329:734-736; Israel & Kaufman (1989) Nucl. Acids Res. 17:2589-2604; and PCT Publication No. WO 93/23431), FK506-related molecules (see e.g., PCT Publication No. WO 94/18317) or tetracyclines (Gossen, M. and Bujard, H. (1992) Proc. Natl. Acad. Sci. USA 89:5547-5551; Gossen, M. et al. (1995) Science 268:1766-1769; PCT Publication No. WO 94/29442; and PCT Publication No. WO 96/01313). Still further, many tissue-specific regulatory sequences are known in the art, including the albumin promoter (liver-specific; Pinkert et al. (1987) Genes Dev. 1:268-277), lymphoid-specific promoters (Calame and Eaton (1988) Adv. Immunol. 43:235-275), in particular promoters of T cell receptors (Winoto and Baltimore (1989) EMBO J. 8:729-733) and immunoglobulins (Banerji et al. (1983) Cell 33:729-740; Queen and Baltimore (1983) Cell 33:741-748), neuron-specific promoters (e.g., the neurofilament promoter; Byrne and Ruddle (1989) Proc. Natl. Acad. Sci. USA 86:5473-5477), pancreas-specific promoters (Edlund et al. (1985) Science 230:912-916) and mammary gland-specific promoters (e.g., milk whey promoter; U.S. Pat. No. 4,873,316 and European Application Publication No. 264,166), the type I collagen promoter or the Osterix promoter to direct expression in osteoblasts.). Developmentally-regulated promoters are also encompassed, for example the murine hox promoters (Kessel and Gruss (1990) Science 249:374-379) and the α-fetoprotein promoter (Campes and Tilghman (1989) Genes Dev. 3:537-546).

Vector DNA can be introduced into mammalian cells via conventional transfection techniques. As used herein, the various forms of the term “transfection” are intended to refer to a variety of art-recognized techniques for introducing foreign nucleic acid (e.g., DNA) into mammalian host cells, including calcium phosphate co-precipitation, DEAE-dextran-mediated transfection, lipofection, or electroporation. Suitable methods for transfecting host cells can be found in Sambrook et al. (Molecular Cloning: A Laboratory Manual, 2nd Edition, Cold Spring Harbor Laboratory press (1989)), and other laboratory manuals. Vector DNA can also be introduced into mammalian cells by infection with, for example, a viral vector, e.g., one incorporated into a viral particle.

For stable transfection of mammalian cells, it is known that, depending upon the expression vector and transfection technique used, only a small fraction of cells may integrate the foreign DNA into their genome. In order to identify and select these integrants, a gene that encodes a selectable marker (e.g., resistance to antibiotics) is generally introduced into the host cells along with the gene of interest. Preferred selectable markers include those which confer resistance to drugs, such as G418, hygromycin and methotrexate. Nucleic acid encoding a selectable marker can be introduced into a host cell on a separate vector from that encoding KRC or, more preferably, on the same vector. Cells stably transfected with the introduced nucleic acid can be identified by drug selection (e.g., cells that have incorporated the selectable marker gene will survive, while the other cells die).

In one embodiment, within the expression vector coding sequences are operatively linked to regulatory sequences that allow for constitutive expression of the molecule in the indicator cell (e.g., viral regulatory sequences, such as a cytomegalovirus promoter/enhancer, can be used). Use of a recombinant expression vector that allows for constitutive expression of KRC or a molecule in a signal transduction pathway involving KRC in the indicator cell is preferred for identification of compounds that enhance or inhibit the activity of the molecule. In an alternative embodiment, within the expression vector the coding sequences are operatively linked to regulatory sequences of the endogenous gene for KRC or a molecule in a signal transduction pathway involving KRC (i.e., the promoter regulatory region derived from the endogenous gene). Use of a recombinant expression vector in which expression is controlled by the endogenous regulatory sequences is preferred for identification of compounds that enhance or inhibit the transcriptional expression of the molecule.

In yet another aspect of the invention, the KRC protein or fragments thereof can be used as “bait protein” e.g., in a two-hybrid assay or three-hybrid assay (see, e.g., U.S. Pat. No. 5,283,317; Zervos et al. (1993) Cell 72:223-232; Madura et al. (1993) J. Biol. Chem. 268:12046-12054; Bartel et al. (1993) Biotechniques 14:920-924; Iwabuchi et al. (1993) Oncogene 8:1693-1696; and Brent WO94/10300), to identify other proteins, which bind to or interact with KRC (“binding proteins” or “bp”) and are involved in KRC activity. Such KRC-binding proteins are also likely to be involved in the propagation of signals by the KRC proteins or KRC targets such as, for example, downstream elements of an KRC-mediated signaling pathway. Alternatively, such KRC -binding proteins can be KRC inhibitors.

The two-hybrid system is based on the modular nature of most transcription factors, which consist of separable DNA-binding and activation domains. Briefly, the assay utilizes two different DNA constructs. In one construct, the gene that codes for an KRC protein is fused to a gene encoding the DNA binding domain of a known transcription factor (e.g., GAL-4). In the other construct, a DNA sequence, from a library of DNA sequences, that encodes an unidentified protein (“prey” or “sample”) is fused to a gene that codes for the activation domain of the known transcription factor. If the “bait” and the “prey” proteins are able to interact, in vivo, forming an KRC dependent complex, the DNA-binding and activation domains of the transcription factor are brought into close proximity. This proximity allows transcription of a reporter gene (e.g., LacZ) which is operably linked to a transcriptional regulatory site responsive to the transcription factor. Expression of the reporter gene can be detected and cell colonies containing the functional transcription factor can be isolated and used to obtain the cloned gene which encodes the protein which interacts with the KRC protein or a molecule in a signal transduction pathway involving KRC.

### B. Cell-Free Assays

In another embodiment, the indicator composition is a cell free composition. At least one of KRC or a non-KRC protein in a signal transduction pathway involving KRC expressed by recombinant methods in a host cells or culture medium can be isolated from the host cells, or cell culture medium using standard methods for protein purification. For example, ion-exchange chromatography, gel filtration chromatography, ultrafiltration, electrophoresis, and immunoaffinity purification with antibodies can be used to produce a purified or semi-purified protein that can be used in a cell free composition. Alternatively, a lysate or an extract of cells expressing the protein of interest can be prepared for use as cell-free composition.

In one embodiment, compounds that specifically modulate KRC activity or the activity of a molecule in a signal transduction pathway involving KRC are identified based on their ability to modulate the interaction of KRC with a target molecule to which KRC binds. The target molecule can be a DNA molecule, e.g., a KRC-responsive element, such as the regulatory region of a chaperone gene) or a protein molecule. Suitable assays are known in the art that allow for the detection of protein-protein interactions (e.g., immunoprecipitations, two-hybrid assays and the like) or that allow for the detection of interactions between a DNA binding protein with a target DNA sequence (e.g., electrophoretic mobility shift assays, DNAse I footprinting assays, oligonucleotide pull-down assays, and the like). By performing such assays in the presence and absence of test compounds, these assays can be used to identify compounds that modulate (e.g., inhibit or enhance) the interaction of KRC with a target molecule.

In one embodiment, the amount of binding of KRC or a molecule in a signal transduction pathway involving KRC to the target molecule in the presence of the test compound is greater than the amount of binding of KRC to the target molecule in the absence of the test compound, in which case the test compound is identified as a compound that enhances binding of KRC to a target. In another embodiment, the amount of binding of the KRC to the target molecule in the presence of the test compound is less than the amount of binding of the KRC (or e.g., Jun, TRAF, GATA3, SMAD2, SMAD3, Runx2, RSK2, ATF4, and/or WWP1) to the target molecule in the absence of the test compound, in which case the test compound is identified as a compound that inhibits binding of KRC to the target. Binding of the test compound to KRC or a molecule in a signal transduction pathway involving KRC can be determined either directly or indirectly as described above. Determining the ability of KRC protein to bind to a test compound can also be accomplished using a technology such as real-time Biomolecular Interaction Analysis (BIA) (Sjolander, S, and Urbaniczky, C. (1991) Anal. Chem. 63:2338-2345; Szabo et al. (1995) Curr. Opin. Struct. Biol. 5:699-705). As used herein, “BIA” is a technology for studying biospecific interactions in real time, without labeling any of the interactants (e.g., BIAcore). Changes in the optical phenomenon of surface plasmon resonance (SPR) can be used as an indication of real-time reactions between biological molecules.

In the methods of the invention for identifying test compounds that modulate an interaction between KRC (or e.g., Jun, TRAF, GATA3, SMAD2, SMAD3, Runx2, RSK2, ATF4, and/or WWP1) protein and a target molecule or the interaction of other molecules in a pathway involving KRC (e.g., WWP1 and Runx2). In one embodiment, a polypeptide comprising the complete KRC amino acid sequence can be used in the method, or, alternatively, a polypeptide comprising only portions of the protein can be used. For example, an isolated KRC interacting domain (e.g., consisting of amino acids 204-1055 or a larger subregion including an interacting domain) can be used. In another embodiment, a polypeptide comprising the Runt domain of Runx2 or the isolated domain can be used in an assay of the invention. In yet another embodiment, the PPXY motif of the Runt domain of Runx2 can be used in an assay of the invention. In another embodiment, a polypeptide comprising the WW domain of WWP1 may be used in an assay. An assay can be used to identify test compounds that either stimulate or inhibit the interaction between the KRC protein and a target molecule. A test compound that stimulates the interaction between the protein and a target molecule is identified based upon its ability to increase the degree of interaction between, e.g., KRC and a target molecule as compared to the degree of interaction in the absence of the test compound and such a compound would be expected to increase the activity of KRC in the cell. A test compound that inhibits the interaction between the protein and a target molecule is identified based upon its ability to decrease the degree of interaction between the protein and a target molecule as compared to the degree of interaction in the absence of the compound and such a compound would be expected to decrease KRC activity.

In one embodiment of the above assay methods of the present invention, it may be desirable to immobilize either KRC (or a molecule in a signal transduction pathway involving KRC, e.g., Jun, TRAF, GATA3, SMAD2, SMAD3, Runx2, RSK2, and/or WWP1) or a respective target molecule for example, to facilitate separation of complexed from uncomplexed forms of one or both of the proteins, or to accommodate automation of the assay. Binding of a test compound to a KRC or a molecule in a signal transduction pathway involving KRC, or interaction of an KRC protein (or a molecule in a signal transduction pathway involving KRC) with a target molecule in the presence and absence of a test compound, can be accomplished in any vessel suitable for containing the reactants. Examples of such vessels include microtitre plates, test tubes, and micro-centrifuge tubes. In one embodiment, a fusion protein can be provided in which a domain that allows one or both of the proteins to be bound to a matrix is added to one or more of the molecules. For example, glutathione-S-transferase fusion proteins or glutathione-S-transferase/target fusion proteins can be adsorbed onto glutathione sepharose beads (Sigma Chemical, St. Louis, Mo.) or glutathione derivatized microtitre plates, which are then combined with the test compound or the test compound and either the non-adsorbed target protein or KRC protein, and the mixture incubated under conditions conducive to complex formation (e.g., at physiological conditions for salt and pH). Following incubation, the beads or microtitre plate wells are washed to remove any unbound components, the matrix is immobilized in the case of beads, and complex formation is determined either directly or indirectly, for example, as described above. Alternatively, the complexes can be dissociated from the matrix, and the level of binding or activity determined using standard techniques.

Other techniques for immobilizing proteins on matrices can also be used in the screening assays of the invention. For example, either an KRC protein or a molecule in a signal transduction pathway involving KRC, or a target molecule can be immobilized utilizing conjugation of biotin and streptavidin. Biotinylated protein or target molecules can be prepared from biotin-NHS (N-hydroxy-succinimide) using techniques known in the art (e.g., biotinylation kit, Pierce Chemicals, Rockford, Ill.), and immobilized in the wells of streptavidin-coated 96 well plates (Pierce Chemical), for example.). Alternatively, antibodies which are reactive with protein or target molecules but which do not interfere with binding of the protein to its target molecule can be derivatized to the wells of the plate, and unbound target or KRC protein is trapped in the wells by antibody conjugation. Methods for detecting such complexes, in addition to those described above for the GST-immobilized complexes, include immunodetection of complexes using antibodies reactive with KRC or a molecule in a signal transduction pathway involving KRC or target molecule, as well as enzyme-linked assays which rely on detecting an enzymatic activity associated with the KRC protein or target molecule.

### C. In Vivo Assays

In one embodiment, an in vivo assay may be used to analyze the ability of a compound to modulate bone formation. For example, in one embodiment, a test compound is administered to mice and the effect of the compound on bone formation in the mice is measured using techniques that are known in the art. For example, sections of bone can also be analyzed by staining with Von Kossa and Toluidine Blue for analysis of in vivo bone formation. In one embodiment, levels of TRAP 5b or deoxypyridinoline (DPD), e.g., in serum or other body fluids may be measured using techniques known in the art.

In one embodiment the mice are adult mice and the effect of the compound on adult bone formation is tested. In another embodiment, the mice are female mice. In another embodiment, the mice are ovariectomized mice.

In yet another embodiment, the mice are transgenic mice overexpressing WWP1. In another embodiment, the mice express a conditional allele of WWP1. In yet another embodiment, the conditional allele restricts WWP1 expression to osteoblast cells (e.g., a type I collagen promoter or an Osterix promoter).

In another embodiment, the ability of a compound to modulate bone formation in a tumor metastasis model is tested. For example, in one embodiment, tumor cells (e.g., human tumor cells such as breast cancer cells) are injected into immunodeficient mice (e.g., by interacardiac or intratibial injection) and the ability of the compound to affect bone formation in the animals is determined.

In another embodiment, the invention provides methods for identifying compounds that modulate a biological effect of KRC or a molecule in a signal transduction pathway involving KRC using cells deficient in at least one of KRC (or e.g., Jun, TRAF, GATA3, SMAD2, SMAD3, Runx2, ATF4, RSK2, and/or WWP1). As described in the Examples, inhibition of KRC activity (e.g., by disruption of the KRC gene) in cells results, e.g., in increased bone formation and mineralization. Thus, cells deficient in KRC or a molecule in a signal transduction pathway involving KRC can be used identify agents that modulate a biological response regulated by KRC by means other than modulating KRC itself (i.e., compounds that “rescue” the KRC deficient phenotype). Alternatively, a “conditional knock-out” system, in which the gene is rendered non-functional in a conditional manner, can be used to create deficient cells for use in screening assays. For example, a tetracycline-regulated system for conditional disruption of a gene as described in WO 94/29442 and U.S. Pat. No. 5,650,298 can be used to create cells, or animals from which cells can be isolated, be rendered deficient in KRC (or a molecule in a signal transduction pathway involving KRC e.g., Jun, TRAF, GATA3, SMAD2, SMAD3, Runx2, CBFβ, ATF4, RSK2, and/or WWP1) in a controlled manner through modulation of the tetracycline concentration in contact with the cells. Specific cell types, e.g., lymphoid cells (e.g., thymic, splenic and/or lymph node cells) or purified cells such as T cells, B cells, osteoblasts, osteoclasts, from such animals can be used in screening assays. In one embodiment, the entire 5.4 kB exon 2 of KRC can be replaced, e.g., with a neomycin cassette, resulting in an allele that produces no KRC protein.

Similarly, the invention provides methods for identifying compounds that modulate a biological effect of KRC or a molecule in a signal transduction pathway involving KRC using cells overexpressing WWP1 (or e.g., Jun, TRAF, GATA3, SMAD2, SMAD3, Runx2, ATF4, RSK2, and/or KRC). As described in the Examples, formation of a multimeric complex between KRC, WWP1 and Runx2 results in WWP I polyubiquitination and proteasome-dependent degradation of Runx2. Moreover, transgenic overexpression of WWP1 in cells results, e.g., in decreased bone formation and mineralization, i.e., osteopenia. Thus, cells overexpressing WWP1 can be used to identify agents that modulate a biological response regulated by KRC by modulating the biological activity of WWP1 (i.e., compounds that “rescue” the osteopenic phenotype of WWP1 overexpression). In one embodiment, a “conditional knock-out” system, in which the gene is overproduced in a spatially restricted manner, can be used to create transgenic cells for use in the screening assays. For example, a WWP1 gene can be operably linked to a type I collagen promoter or the osterix promoter and this construct can be used to create cells, or animals from which cells can be isolated, that overexpress WWP1 in a controlled manner and spatially restricts the expression of WWP1. Specific cell types, e.g., osteoblasts or purified cells such as mesenchymal stem cells, osteoblasts, osteoclasts, from such animals can be used in screening assays.

### RSK2 Animals?

In the screening methods, cells deficient in at least one of KRC or a molecule in a signal transduction pathway involving KRC or transgenic WWP1 cells (hereinafter, collectively referred to as transgenic cells for simplicity) can be contacted with a test compound and a biological response regulated by KRC or a molecule in a signal transduction pathway involving KRC can be monitored. Modulation of the response in transgenic cells (as compared to an appropriate control such as, for example, untreated cells or cells treated with a control agent or appropriate wild-type cells) identifies a test compound as a modulator of the KRC regulated response.

In one embodiment, the test compound is administered directly to a non-human transgenic animal, preferably a mouse (e.g., a mouse in which the KRC gene or a gene in a signal transduction pathway involving KRC is conditionally disrupted by means described above, or a chimeric mouse in which the lymphoid organs are deficient in KRC or a molecule in a signal transduction pathway involving KRC as described above, or a WWP1 transgenic mouse overexpressing WWP1 as described above) to identify a test compound that modulates the in vivo responses of such transgenic cells. In another embodiment, transgenic cells are isolated from the non-human animals of the invention and contacted with the test compound ex vivo to identify a test compound that modulates a response regulated by KRC in the cells.

Transgenic cells can be obtained from a non-human animals created to be deficient in KRC or a molecule in a signal transduction pathway involving KRC or animals in which the WWP1 gene is overexpressed. Preferred non-human animals include monkeys, dogs, cats, mice, rats, cows, horses, goats and sheep. In preferred embodiments, the deficient animal is a mouse. Mice deficient in KRC or a molecule in a signal transduction pathway involving KRC (or overexpressing WWP1) can be made using methods known in the art. One example of such a method and the resulting KRC heterozygous and homozygous animals is described in the appended examples. Non-human animals deficient in a particular gene product typically are created by homologous recombination. In an exemplary embodiment, a vector is prepared which contains at least a portion of the gene into which a deletion, addition or substitution has been introduced to thereby alter, e.g., functionally disrupt, the endogenous KRC. The gene preferably is a mouse gene. For example, a mouse KRC gene can be isolated from a mouse genomic DNA library using the mouse KRC cDNA as a probe. The mouse KRC gene then can be used to construct a homologous recombination vector suitable for modulating an endogenous KRC gene in the mouse genome. In a preferred embodiment, the vector is designed such that, upon homologous recombination, the endogenous gene is functionally disrupted (i.e., no longer encodes a functional protein; also referred to as a “knock out” vector).

Alternatively, the vector can be designed such that, upon homologous recombination, the endogenous gene is mutated or otherwise altered but still encodes functional protein (e.g., the upstream regulatory region can be altered to thereby alter the expression of the endogenous KRC protein). In the homologous recombination vector, the altered portion of the gene is flanked at its 5′ and 3′ ends by additional nucleic acid of the gene to allow for homologous recombination to occur between the exogenous gene carried by the vector and an endogenous gene in an embryonic stem cell. The additional flanking nucleic acid is of sufficient length for successful homologous recombination with the endogenous gene. Typically, several kilobases of flanking DNA (both at the 5′ and 3′ ends) are included in the vector (see e.g., Thomas, K. R. and Capecchi, M. R. (1987) Cell 51:503 for a description of homologous recombination vectors). The vector is introduced into an embryonic stem cell line (e.g., by electroporation) and cells in which the introduced gene has homologously recombined with the endogenous gene are selected (see e.g., Li, E. et al. (1992) Cell 69:915). The selected cells are then injected into a blastocyst of an animal (e.g., a mouse) to form aggregation chimeras (see e.g., Bradley, A. in Teratocarcinomas and Embryonic Stem Cells: A Practical Approach, E. J. Robertson, ed. (IRL, Oxford, 1987) pp. 113-152). A chimeric embryo can then be implanted into a suitable pseudopregnant female foster animal and the embryo brought to term. Progeny harboring the homologously recombined DNA in their germ cells can be used to breed animals in which all cells of the animal contain the homologously recombined DNA by germline transmission of the transgene. Methods for constructing homologous recombination vectors and homologous recombinant animals are described further in Bradley, A. (1991) Current Opinion in Biotechnology 2:823-829 and in PCT International Publication Nos.: WO 90/11354 by Le Mouellec et al.; WO 91/01140 by Smithies et al.; WO 92/0968 by Zijlstra et al.; and WO 93/04169 by Berns et al.

In one embodiment of the screening assay, compounds tested for their ability to modulate a biological response regulated by KRC or a molecule in a signal transduction pathway involving KRC are contacted with transgenic cells by administering the test compound to a non-human animal in vivo and evaluating the effect of the test compound on the response in the animal.

The test compound can be administered to a transgenic animal as a pharmaceutical composition. Such compositions typically comprise the test compound and a pharmaceutically acceptable carrier. As used herein the term “pharmaceutically acceptable carrier” includes any and all solvents, dispersion media, coatings, antibacterial and antifungal compounds, isotonic and absorption delaying compounds, and the like, compatible with pharmaceutical administration. The use of such media and compounds for pharmaceutically active substances is well known in the art. Except insofar as any conventional media or compound is incompatible with the active compound, use thereof in the compositions is contemplated. Supplementary active compounds can also be incorporated into the compositions. Pharmaceutical compositions are described in more detail below.

In another embodiment, compounds that modulate a biological response regulated by KRC or a signal transduction pathway involving KRC are identified by contacting transgenic cells ex vivo with one or more test compounds, and determining the effect of the test compound on a read-out. In one embodiment, transgenic cells contacted with a test compound ex vivo can be readministered to a subject.

For practicing the screening method ex vivo, transgenic cells can be isolated from a non-human transgenic animal or embryo by standard methods and incubated (i.e., cultured) in vitro with a test compound. Cells (e.g., T cells, B cells, and/or osteoblasts) can be isolated from transgenic animals by standard techniques. In another embodiment, the cells are isolated form animals deficient in one or more of KRC, Jun, TRAF, GATA3, SMAD2, SMAD3, Runx2, ATF4, RSK2, and/or WWP1. In another embodiment, cells are isolated from animals deficient in one or more of KRC, Jun, TRAF, GATA3, SMAD2, SMAD3, Runx2, ATF4, RSK2, and/or WWP1, and overexpressing WWP1.

Following contact of the transgenic cells with a test compound (either ex vivo or in vivo), the effect of the test compound on the biological response regulated by KRC or a molecule in a signal transduction pathway involving KRC can be determined by any one of a variety of suitable methods, such as those set forth herein, e.g., including light microscopic analysis of the cells, histochemical analysis of the cells, production of proteins, induction of certain genes, e.g., cytokine gene, such as IL-2, degradation of certain proteins, e.g., ubiquitination of certain proteins, as described herein.

It will be understood by those of skill in the art that the subject assays may be used in combination to provide various levels of testing for compounds. For example, in one embodiment, a cellular indicator composition comprising KRC, WWP1, and Runx2, or biologically active fragments thereof; and further comprising a reporter gene responsive to the Runx2 polypeptide, or biological active fragment thereof is contacted with each member of a library of test compounds. An indicator of the activity of a member of the KRC signaling pathway is measured, e.g., the expression of a reporter gene in the presence and absence of the test compound is determined. A compound(s) of interest that modulates the activity of the polypeptide in the KRC signaling pathway is selected. The compound of interest may then be tested in a secondary screening assay. For example, the ability of the test compound of interest to increase mesenchymal stem cell differentiation may be tested. In one embodiment, a mesenchymal stem cell comprising KRC, WWP1, and Runx2, or biologically active fragments thereof, is contacted with the test compound of interest and the effect of test compound on mesenchymal stem cell differentiation in the presence and absence of the test compound is determined.

Additionally or alternatively (e.g., as a primary screen, a secondary screen or as an additional tertiary screen) the ability of the test compound of interest to modulate an activity of WWP1 may be measured, e.g., the ability of WWP1 to bind to Runx2 or the ability of WWP1 to ubiquitinate a substrate molecule.

In another embodiment, a compound of interest may be assayed in an in vivo model for its ability to modulate bone formation and mineralization in a non-human adult animal. For example, the test compound may be administered to the animal and the effect of test compound on bone formation and mineralization in the presence and absence of the test compound determined, wherein an increase in bone formation and mineralization in the non-human animal identifies the test compound of interest as a compound that increases bone formation and mineralization. It will be understood that this assay may be used as a secondary screen, a tertiary screen, or a quaternary screen).

In another embodiment, a cellular indicator composition comprising KRC, WWP1, and Runx2, or biologically active portions thereof, and a reporter gene responsive to the Runx2 polypeptide, or biological active fragment thereof are contacted with each member of a library of test compounds. The expression of the reporter gene in the presence and absence of the test compound is measured.

A compound of interest that increases the expression of the reporter gene is selected. The ability of the test compound of interest from step to increase mesenchymal stem cell differentiation, comprising contacting a mesenchymal stem cell with the test compound of interest and determining the effect of test compound on mesenchymal stem cell differentiation in the presence and absence of the test compound. In one embodiment, the ability of the test compound of interest to decrease the E3 ubiquitin ligase activity of WWP1, comprising providing an indicator composition comprising WWP1, or a biologically active fragment thereof; contacting the indicator composition with the test compound of interest; and determining the effect of the test compound of interest on the E3 ubiquitin ligase activity of WWP1 in the presence or absence of the test compound of interest; and/or

g) evaluating the ability of the test compound of interest from step e) to decrease an interaction between WWP1 and Runx2, comprising providing an indicator composition comprising WWP1 and Runx2, or biologically active fragments thereof; contacting the indicator composition with the test compound of interest; and determining the effect of the test compound of interest on the interaction of WWP1 and Runx2 in the presence or absence of the test compound; and

In one embodiment, the effect of the test compound of interest on bone formation and mineralization in an adult non-human animal, comprising administering the test compound to the animal and determining the effect of test compound on bone formation and mineralization in the presence and absence of the test compound, wherein an increase in bone formation and mineralization in the non-human animal identifies the test compound of interest as a compound that increases bone formation and mineralization.

### D. Test Compounds

A variety of test compounds can be evaluated using the screening assays described herein. The term “test compound” includes any reagent or test agent which is employed in the assays of the invention and assayed for its ability to influence the expression and/or activity of KRC or a molecule in a signal transduction pathway involving KRC. More than one compound, e.g., a plurality of compounds, can be tested at the same time for their ability to modulate the expression and/or activity of, e.g., KRC in a screening assay. The term “screening assay” preferably refers to assays which test the ability of a plurality of compounds to influence the readout of choice rather than to tests which test the ability of one compound to influence a readout. Preferably, the subject assays identify compounds not previously known to have the effect that is being screened for. In one embodiment, high throughput screening can be used to assay for the activity of a compound.

In certain embodiments, the compounds to be tested can be derived from libraries (i.e., are members of a library of compounds). While the use of libraries of peptides is well established in the art, new techniques have been developed which have allowed the production of mixtures of other compounds, such as benzodiazepines (Bunin et al. (1992). J. Am. Chem. Soc. 114:10987; DeWitt et al. (1993). Proc. Natl. Acad. Sci. USA 90:6909) peptoids (Zuckermann. (1994). J. Med. Chem. 37:2678) oligocarbamates (Cho et al. (1993). Science. 261:1303-), and hydantoins (DeWitt et al. supra). An approach for the synthesis of molecular libraries of small organic molecules with a diversity of 104-105 as been described (Carell et al. (1994). Angew. Chem. Int. Ed. Engl. 33:2059-; Carell et al. (1994) Angew. Chem. Int. Ed. Engl. 33:2061-).

The compounds of the present invention can be obtained using any of the numerous approaches in combinatorial library methods known in the art, including: biological libraries; spatially addressable parallel solid phase or solution phase libraries, synthetic library methods requiring deconvolution, the ‘one-bead one-compound’ library method, and synthetic library methods using affinity chromatography selection. The biological library approach is limited to peptide libraries, while the other four approaches are applicable to peptide, non-peptide oligomer or small molecule libraries of compounds (Lam, K. S. (1997) Anticancer Drug Des. 12:145). Other exemplary methods for the synthesis of molecular libraries can be found in the art, for example in: Erb et al. (1994). Proc. Natl. Acad. Sci. USA 91:11422-; Horwell et al. (1996) Immunopharmacology 33:68-; and in Gallop et al. (1994); J. Med. Chem. 37:1233-.

Libraries of compounds can be presented in solution (e.g., Houghten (1992) Biotechniques 13:412-421), or on beads (Lam (1991) Nature 354:82-84), chips (Fodor (1993) Nature 364:555-556), bacteria (Ladner U.S. Pat. No. 5,223,409), spores (Ladner U.S. Pat. No. '409), plasmids (Cull et al. (1992) Proc Natl Acad Sci USA 89:1865-1869) or on phage (Scott and Smith (1990) Science 249:386-390); (Devlin (1990) Science 249:404-406); (Cwirla et al. (1990) Proc. Natl. Acad. Sci. 87:6378-6382); (Felici (1991) J. Mol. Biol. 222:301-310); In still another embodiment, the combinatorial polypeptides are produced from a cDNA library.

Exemplary compounds which can be screened for activity include, but are not limited to, peptides, nucleic acids, carbohydrates, small organic molecules, and natural product extract libraries.

Candidate/test compounds include, for example, 1) peptides such as soluble peptides, including Ig-tailed fusion peptides and members of random peptide libraries (see, e.g., Lam, K. S. et al. (1991) Nature 354:82-84; Houghten, R. et al. (1991) Nature 354:84-86) and combinatorial chemistry-derived molecular libraries made of D- and/or L-configuration amino acids; 2) phosphopeptides (e.g., members of random and partially degenerate, directed phosphopeptide libraries, see, e.g., Songyang, Z. et al. (1993) Cell 72:767-778); 3) antibodies (e.g., polyclonal, monoclonal, humanized, anti-idiotypic, chimeric, and single chain antibodies as well as Fab, F(ab′)₂, Fab expression library fragments, and epitope-binding fragments of antibodies); 4) small organic and inorganic molecules (e.g., molecules obtained from combinatorial and natural product libraries); 5) enzymes (e.g., endoribonucleases, hydrolases, nucleases, proteases, synthatases, isomerases, polymerases, kinases, phosphatases, oxido-reductases and ATPases), and 6) mutant forms of KRC (e.g., dominant negative mutant forms of the molecule).

The test compounds of the present invention can be obtained using any of the numerous approaches in combinatorial library methods known in the art, including: biological libraries; spatially addressable parallel solid phase or solution phase libraries; synthetic library methods requiring deconvolution; the ‘one-bead one-compound’ library method; and synthetic library methods using affinity chromatography selection. The biological library approach is limited to peptide libraries, while the other four approaches are applicable to peptide, non-peptide oligomer or small molecule libraries of compounds (Lam, K. S. (1997) Anticancer Drug Des. 12:145).

Examples of methods for the synthesis of molecular libraries can be found in the art, for example in: DeWitt et al. (1993) Proc. Natl. Acad. Sci. U.S.A. 90:6909; Erb et al. (1994) Proc. Natl. Acad. Sci. USA 91:11422; Zuckermann et al. (1994) J. Med. Chem. 37:2678; Cho et al. (1993) Science 261:1303; Carrell et al. (1994) Angew. Chem. Int. Ed. Engl. 33:2059; Carell et al. (1994) Angew. Chem. Int. Ed. Engl. 33:2061; and Gallop et al. (1994) J. Med. Chem. 37:1233.

Libraries of compounds can be presented in solution (e.g., Houghten (1992) Biotechniques 13:412-421), or on beads (Lam (1991) Nature 354:82-84), chips (Fodor (1993) Nature 364:555-556), bacteria (Ladner U.S. Pat. No. 5,223,409), spores (Ladner U.S. Pat. No. '409), plasmids (Cull et al. (1992) Proc Natl Acad Sci USA 89:1865-1869) or phage (Scott and Smith (1990) Science 249:386-390; Devlin (1990) Science 249:404-406; Cwirla et al. (1990) Proc. Natl. Acad. Sci. 87:6378-6382; Felici (1991) J. Mol. Biol. 222:301-310; Ladner supra.).

Compounds identified in the subject screening assays can be used in methods of modulating one or more of the biological responses regulated by KRC. It will be understood that it may be desirable to formulate such compound(s) as pharmaceutical compositions (described supra) prior to contacting them with cells.

Once a test compound is identified that directly or indirectly modulates, e.g., KRC expression or activity, or a molecule in a signal transduction pathway involving KRC, by one of the variety of methods described hereinbefore, the selected test compound (or “compound of interest”) can then be further evaluated for its effect on cells, for example by contacting the compound of interest with cells either in vivo (e.g., by administering the compound of interest to a subject) or ex vivo (e.g., by isolating cells from the subject and contacting the isolated cells with the compound of interest or, alternatively, by contacting the compound of interest with a cell line) and determining the effect of the compound of interest on the cells, as compared to an appropriate control (such as untreated cells or cells treated with a control compound, or carrier, that does not modulate the biological response).

The instant invention also pertains to compounds identified in the subject screening assays.

### VI. METHODS OF TREATMENT/PHARMACEUTICAL COMPOSITIONS

In one embodiment, the subject assays may be used to identify compounds useful in prophylactic treatment of subjects that would benefit from enhanced bone formation. In another embodiment, the subject assays may be used to identify compounds useful in the therapeutic treatment of subjects that would benefit from enhanced bone formation, e.g., by inhibiting KRC biological activity or the activity of a molecule in a signal transduction pathway modulated by KRC. In one embodiment, a subject that would benefit from enhanced bone formation is an adult subject, e.g., a female subject. In one embodiment, a compound identified using the instant methods may be used to enhance bone healing, e.g., alone or in combination with other therapeutic modalities.

Exemplary disorders that would benefit from increased bone formation include: erosive arthritis, bone malignancies, osteoporosis, including idiopathic osteoporosis, secondary osteoporosis, transient osteoporosis of the hip, osteomalacia, skeletal changes of hyperparathyroidism, chronic renal failure (renal osteodystrophy), osteitis deformans (Paget's disease of bone), osteolytic metastases, and osteopenia in which there is progressive loss of bone density and thinning of bone tissue are conditions which would benefit from increased bone formation and mineralization such that breaks and/or fractures would not occur. Osteoporosis and osteopenia can result not only from aging and reproductive status, but can also be secondary to numerous diseases and disorders, as well as due to prolonged use of numerous medications, e.g., anticonvulsants (e.g., for epilepsy), corticosteroids (e.g., for rheumatoid arthritis and asthma), and/or immunosuppressive agents (e.g., for cancer). For example, glucocorticoid-induced osteoporosis is a form of osteoporosis that is caused by taking glucocorticoid medications such as prednisone (Deltasone, Orasone, etc.), prednisolone (Prelone), dexamethasone (Decadron, Hexadrol), and cortisone (Cortone Acetate). These medications are frequently used to help control many rheumatic diseases, including rheumatoid arthritis, systemic lupus erythematosus, inflammatory bowel disease, and polymyalgia rheumatica. Other diseases in which osteoporosis may be secondary include, but are not limited to, juvenile rheumatoid arthritis, diabetes, osteogenesis imperfecta, hyperthyroidism, hyperparathyroidism, Cushing's syndrome, malabsorption syndromes, anorexia nervosa and/or kidney disease. In addition, numerous behaviors have been associated with osteoporosis, such as, prolonged inactivity or immobility, inadequate nutrition (especially calcium, vitamin D), excessive exercise leading to amenorrhea (absence of periods), smoking, and/or alcohol abuse. Furthermore, promoting the induction of bone formation and mineralization may be beneficial to treat, for example a bone fracture or break, a tooth replacement, either replacement of a subjects' own tooth or a prosthetic tooth, or ameliorate symptoms of an ongoing condition, such as for example, bone loss associated with, for example peri-menopause or menopause.

In addition, compounds of the invention which stimulate KRC activity as a means of downmodulating bone formation and mineralization is also useful in therapy. For example, decreasing or inhibiting bone formation and mineralization by enhancing KRC is beneficial in diseases, disorders, conditions or injuries in which there is premature fusing of two or more bone, or bone density is too high, such as for example, craniosynostosis (synostosis), osteopetrosis (including malignant infantile form, intermediate form, and adult form), primary extra-skeletal bone formation, e.g., multiple miliary osteoma cutis of the face, and osteitis condensans.

A pharmaceutical composition of the invention is formulated to be compatible with its intended route of administration. For example, solutions or suspensions used for parenteral, intradermal, or subcutaneous application can include the following components: a sterile diluent such as water for injection, saline solution, fixed oils, polyethylene glycols, glycerine, propylene glycol or other synthetic solvents; antibacterial compounds such as benzyl alcohol or methyl parabens; antioxidants such as ascorbic acid or sodium bisulfite; chelating compounds such as ethylenediaminetetraacetic acid; buffers such as acetates, citrates or phosphates and compounds for the adjustment of tonicity such as sodium chloride or dextrose. pH can be adjusted with acids or bases, such as hydrochloric acid or sodium hydroxide. The parenteral preparation can be enclosed in ampoules, disposable syringes or multiple dose vials made of glass or plastic.

Pharmaceutical compositions suitable for injectable use include sterile aqueous solutions (where water soluble) or dispersions and sterile powders for the extemporaneous preparation of sterile injectable solutions or dispersion. For intravenous administration, suitable carriers include physiological saline, bacteriostatic water, Cremophor EL™ (BASF, Parsippany, N.J.) or phosphate buffered saline (PBS). In all cases, the composition will preferably be sterile and should be fluid to the extent that easy syringability exists. It will preferably be stable under the conditions of manufacture and storage and must be preserved against the contaminating action of microorganisms such as bacteria and fungi. The carrier can be a solvent or dispersion medium containing, for example, water, ethanol, polyol (for example, glycerol, propylene glycol, and liquid polyethylene glycol, and the like), and suitable mixtures thereof. The proper fluidity can be maintained, for example, by the use of a coating such as lecithin, by the maintenance of the required particle size in the case of dispersion and by the use of surfactants. Prevention of the action of microorganisms can be achieved by various antibacterial and antifungal compounds, for example, parabens, chlorobutanol, phenol, ascorbic acid, thimerosal, and the like. In many cases, it will be preferable to include isotonic compounds, for example, sugars, polyalcohols such as manitol, sorbitol, sodium chloride in the composition. Prolonged absorption of the injectable compositions can be brought about by including in the composition an compound which delays absorption, for example, aluminum monostearate and gelatin.

Sterile injectable solutions can be prepared by incorporating the active compound in the required amount in an appropriate solvent with one or a combination of ingredients enumerated above, as required, followed by filtered sterilization. Generally, dispersions are prepared by incorporating the active compound into a sterile vehicle which contains a basic dispersion medium and the required other ingredients from those enumerated above. In the case of sterile powders for the preparation of sterile injectable solutions, the preferred methods of preparation are vacuum drying and freeze-drying which yields a powder of the active ingredient plus any additional desired ingredient from a previously sterile-filtered solution thereof.

Oral compositions generally include an inert diluent or an edible carrier. They can be enclosed in gelatin capsules or compressed into tablets. For the purpose of oral therapeutic administration, the active compound can be incorporated with excipients and used in the form of tablets, troches, or capsules. Oral compositions can also be prepared using a fluid carrier for use as a mouthwash, wherein the compound in the fluid carrier is applied orally and swished and expectorated or swallowed. Pharmaceutically compatible binding compounds, and/or adjuvant materials can be included as part of the composition. The tablets, pills, capsules, troches and the like can contain any of the following ingredients, or compounds of a similar nature: a binder such as microcrystalline cellulose, gum tragacanth or gelatin; an excipient such as starch or lactose, a disintegrating compound such as alginic acid, Primogel, or corn starch; a lubricant such as magnesium stearate or Sterotes; a glidant such as colloidal silicon dioxide; a sweetening compound such as sucrose or saccharin; or a flavoring compound such as peppermint, methyl salicylate, or orange flavoring.

In one embodiment, the test compounds are prepared with carriers that will protect the compound against rapid elimination from the body, such as a controlled release formulation, including implants and microencapsulated delivery systems. Biodegradable, biocompatible polymers can be used, such as ethylene vinyl acetate, polyanhydrides, polyglycolic acid, collagen, polyorthoesters, and polylactic acid. Methods for preparation of such formulations will be apparent to those skilled in the art. The materials can also be obtained commercially from, e.g., Alza Corporation and Nova Pharmaceuticals, Inc. Liposomal suspensions (including liposomes targeted to infected cells with monoclonal antibodies to viral antigens) can also be used as pharmaceutically acceptable carriers. These can be prepared according to methods known to those skilled in the art, for example, as described in U.S. Pat. No. 4,522,811.

### VII. KITS OF THE INVENTION

Another aspect of the invention pertains to kits for carrying out the screening assays, modulatory methods or diagnostic assays of the invention. For example, a kit for carrying out a screening assay of the invention can include an indicator composition comprising KRC or a molecule in a signal transduction pathway involving KRC, means for measuring a readout (e.g., protein secretion) and instructions for using the kit to identify modulators of biological effects of KRC. In another embodiment, a kit for carrying out a screening assay of the invention can include cells deficient in KRC or a molecule in a signal transduction pathway involving KRC, means for measuring the readout and instructions for using the kit to identify modulators of a biological effect of KRC.

In another embodiment, the invention provides a kit for carrying out a modulatory method of the invention. The kit can include, for example, a modulatory agent of the invention (e.g., KRC inhibitory or stimulatory agent) in a suitable carrier and packaged in a suitable container with instructions for use of the modulator to modulate a biological effect of KRC.

Another aspect of the invention pertains to a kit for diagnosing a disorder associated with a biological activity of KRC in a subject. The kit can include a reagent for determining expression of KRC (e.g., a nucleic acid probe for detecting KRC mRNA or an antibody for detection of KRC protein), a control to which the results of the subject are compared, and instructions for using the kit for diagnostic purposes.

The practice of the present invention will employ, unless otherwise indicated, conventional techniques of cell biology, cell culture, molecular biology, transgenic biology, microbiology, recombinant DNA, and immunology, which are within the skill of the art. Such techniques are explained fully in the literature. See, for example, Molecular Cloning A Laboratory Manual, 2nd Ed., ed. by Sambrook, Fritsch and Maniatis (Cold Spring Harbor Laboratory Press: 1989); DNA Cloning, Volumes I and II (D. N. Glover ed., 1985); Oligonucleotide Synthesis (M. J. Gait ed., 1984); Mullis et al. U.S. Pat. No. 4,683,195; Nucleic Acid Hybridization (B. D. Hames & S. J. Higgins eds. 1984); Transcription And Translation (B. D. Hames & S. J. Higgins eds. 1984); Culture Of Animal Cells (R. I. Freshney, Alan R. Liss, Inc., 1987); Immobilized Cells And Enzymes (IRL Press, 1986); B. Perbal, A Practical Guide To Molecular Cloning (1984); the treatise, Methods In Enzymology (Academic Press, Inc., N.Y.); Gene Transfer Vectors For Mammalian Cells (J. H. Miller and M. P. Calos eds., 1987, Cold Spring Harbor Laboratory); Methods In Enzymology, Vols. 154 and 155 (Wu et al. eds.), Immunochemical Methods In Cell And Molecular Biology (Mayer and Walker, eds., Academic Press, London, 1987); Handbook Of Experimental Immunology, Volumes I-IV (D. M. Weir and C. C. Blackwell, eds., 1986); Manipulating the Mouse Embryo, (Cold Spring Harbor Laboratory Press, Cold Spring Harbor, N.Y., 1986).

This invention is further illustrated by the following examples which should not be construed as limiting. The contents of all references, patents, and published patent applications cited throughout this application, as well as the figures and the sequence listing, are hereby incorporated by reference.

### EXAMPLES

The following materials and methods were used throughout the Examples:

### Generation of KRC-Deficient Mice.

The Shn3 targeting vector was created by cloning a 5-kb genomic fragment between Exons 3 and 4 and a 5.5-kb fragment of Exon 2 into the PGKNEO vector. The targeting construct was linearized and electroporated into ES cells. The gene-targeting vector replaced amino acids 1-108 of Exon 4 with a neomycin resistance cassette by homologous recombination, resulting in an allele that produces no Shn3 protein. Shn3-targeted ES clones were identified by Southern blot analysis and injected into C57BL/6 blastocysts. Shn3 ES cells transmitted the disrupted allele to 129/B6 offspring. Heterozygous pups were backcrossed to wild-type C57BL/6 mice for five generations before analysis. Mice analyzed in all studies are sex-matched littermates that are derived from heterozygous F5 intercrosses. Genotyping was performed by PCR on tail DNA using neomycin-specific primers and primers that span amino acids 1-103 of exon 4 of the Shn3 gene.

### Bone and Cartilage Staining

Newborn mice were skinned, eviscerated and dehydrated in 95% ETOH overnight. The samples wee then transferred into acetone for an additional forty-eight hour incubation. Skeletal preparations were stained for four days using alcian blue and alizarin red as described previously (McLeod, M. J. (1980). Teratology 22, 299-301). Following staining, the samples were washed for thirty minutes, three times in 95% ETOH. The soft tissue was then cleared in 1% KOH.

### Histomorphometric Analysis

For analysis of in vivo bone formation, calcein (1.6 mg/kg body weight) was administered by intraperitoneal injection to 2 month old WT and Shn3^{-/-} mice at 8 days and 3 days prior to sacrifice. Tibias were harvested, cleared of soft tissue and fixed in 70% ethanol. Histomorphometric analysis was conducted by Development and Discovery Services at Charles River Laboratories. Briefly, bones were embedded in methyl-methacrylate blocks without decalcification. Sections were stained with Von Kossa and Toluidine Blue or left unstained. Histomorphometry was performed in the secondary spongiosa approximately 1 mm below the lowest portion of the growth plate. Analysis was conducted with Bioquant True Colors software utilizing an Olympus BX-60 fluorescence-equipped microscope and an Optronics digital camera system.

### Cell and Tissue Cultures

For in vitro osteoclatogenesis, bone marrow cells were isolated from the femur and tibia of mice in αMEM (Mediatech, Inc.). After red blood cell lysis, the cells were washed once and resuspended in αMEM+10% FBS. The bone marrow cells were then plated in a 48-well plate at a concentration of 2×10⁵ cells per 250 μl of αMEM+10% FBS. The cells were then cultured for two days in the presence of 50 ng/ml M-CSF (Peprotech). After the initial two day culture period, the cells were then cultured for an additional five days in the presence of M-CSF (50 ng/ml) and either 25 ng/ml or 100 ng/ml RANKL (Peprotech). The cells were then fixed and stained for the presence of tartate-resistant alkaline phosphatase (TRAP) per manufacture's instructions (Sigma).

Osteoblastic cells were isolated from calvariae of neonatal WT and Shn3^{-/-} littermates as previously described (Yoshida, Y., et al. (2000). Cell 103, 1085-1097). Calvarial-derived cells were plated in αMEM+10% FBS+50 μg/ml ascorbic acid+5 mM β-glycerophosphate in a 6-well dish. Cells were harvested at a sub-confluent stage and replated in a 6-well dish at a concentration of 10⁴ cells/cm2 in αMEM+10% FBS+50 μg/ml ascorbic acid+5 mM β-glycerophosphate. For von Kossa staining, cells were fixed at day 21 of culture with 10% neutral buffered formalin and stained with 5% silver nitrate for 30 minutes. For ALP, cultures were fixed in 100% ethanol at day 14 of culture, and stained utilizing an alkaline phosphatase kit (Sigma) per manufacturer's instructions. For cell proliferation assays, calvarial-derived cells (10⁵ cells/well at day 0) were plated in 6-well dish in αMEM+10% FBS+50 μg/ml ascorbic acid+5 mM β-glycerophosphate. Cells were harvested and counted at day 5 of culture utilizing a hemocytometer following trypan blue exclusion staining for cell viability.

### Bone Marrow Transfers

Bone marrow cells were collected from the femur and tibia of 8-week old WT mice by flushing with RPMI 1640 (Mediatech, Inc.)+10% FBS using a syringe with a 26-gauge needle. Following RBC lysis, cells were washed in RPMI 1640+10% FBS and resuspended in PBS (Gibco). 1×10⁷ WT bone marrow cells were then transferred by tail vein injection into γ-irradiated (1200 rads) 4-week old WT and Shn3^{-/-} mice. The irradiated mice were analyzed by radiography four weeks after transfer.

### Quantitative Real-Time PCR

For quantitative real-time PCR, total RNA was extracted from Shn3^{-/-} and WT osteoblasts and at day 14 of culture utilizing Trizol (Invitrogen). Reverse transcription was performed on 1 μg RNA using iScript cDNA Synthesis kit (BioRad) following the treatment of isolated RNA with amplification-grade DNase I (Invitrogen). Quantitative PCR was then performed on an ABI Prism 7700 Sequence Detection System (Applied Biosystems). PCR reaction were carried out in 25 μl volumes using SYBR Green PCR master mix (Applied Biosystems) and 0.2 μM of specific primers. Relative levels of mRNA for a specific gene between two samples were calculated utilizing the ΔΔCT method where the amount of cDNA in each sample was normalized to the β-actin Ct (Livak, K. J., and Schmittgen, T. D. (2001). Methods 25, 402-408).

### Transient Transfections and Reporter Gene Assays

The preosteoblast cell line, MC3T3-E1 Subclone 4, and the murine mesenchymal stem cell line, C₃H₁₀T1/2, were obtained from ATCC and maintained in DMEM (Mediatech, Inc.)+10% FBS. For transient transfections, cells were seeded overnight in a 12-well dish at a concentration of 8×10⁴ cells/well. Cells were then transfected with a luciferase reporter gene plasmid and the different combinations of expression constructs, as indicated, using Effectene transfection reagent (Qiagen). Total amounts of transfected DNA were kept constant by supplementing with control empty expression vector plasmids as needed. All cells were cotransfected with pRL-TK (Promega) as a normalization control for transfection efficiency. Forty-eight hours after transfection, cells were harvested and lysed in 1× Passive Lysis Buffer (Promega). Luciferase assays were performed using the Dual-Luciferase Reporter Assay System (Promega). The Shn3 expression plasmid has been described previously (Oukka, M., et al. (2002). Mol Cell 9, 121-131).

### Immunoprecipitation and Immunoblotting

For immunoprecipitation, 293T cells (6×10⁶ cells/dish) were plated in 10 cm dishes in DMEM+10% FBS and transiently transfected with Effectene transfection reagent. Thirty-six to forty-eight hours later, cells were harvested and lysed in TNT lysis buffer (20 mM Tris, pH 8.0, 200 mM NaCl, 0.5% Triton X-100) supplemented with protease inhibitors. Lysates were subjected to immunoprecipitation with agarose-conjugated anti-FLAG (M2, Sigma) or anti-Myc (9E10, Santa Cruz) monoclonal antibodies at 4° C. overnight. Immunoprecipitates were then washed three times in lysis buffer and subjected to SDS-PAGE followed by immunoblotting for Shn-3 (Oukka, M., et al. (2002). Mol Cell 9, 121-131), FLAG (M2, Sigma), or Myc (9E10, SantaCruz).

To detect the interaction between endogenous Shn3 and Runx2, MC3T3-E1 cells were grown to confluency in DMEM+10% fetal calf serum in 10 cm dishes. When cells reached confluency, medium was changed to αMEM+10% fetal calf serum supplemented with 10 mM β-glycerophosphate, 50 μM ascorbic acid, and with or without BMP-2 (100 ng/ml), as described (Zamurovic, N., et al. (2004). J Biol Chem 279, 37704-37715). Cells were differentiated for an additional 3-4 days. Eighteen-hours prior to lysis TGFβ (2 ng/ml, R+D Systems) was added to some cultures, and 2 hours prior to lysis MG132 (10 μM, Boston Biochem) was added to all cultures. Cells were harvested and lysed in TNT buffer. Lysates were subjected to immunoprecipitation with 3 μg anti-Runx2 antibody (Santa Cruz) or control rabbit IgG at 4° C. overnight. Protein A/G-agarose (Santa Cruz) was added to precipitate immune complexes, which were then washed five times with lysis buffer followed by SDS-PAGE and immunoblotting for Shn3.

Additional co-immunoprecipitation experiments were conducted with FLAG-epitope-tagged Runx2 deletion mutants. Full length (amino acids 1-521) contains QA, Runt and PST domains. QA mutant (amino acids 48-89) contains QA domain but lacks both Runt and PST domains. Runt mutant (amino acids 102-229) contains Runt and PST domain. Runt/PST mutant (amino acids 102-521) contains Runt and PST domain but lacks QA domain. Shn3 interaction with these mutants was determined by Western blot analysis with anti-Shn3 antibody following immunoprecipitation with anti-FLAG antibody.

To detect endogenous Atf4 and Runx2 protein levels in Shn3^{-/-} and WT osteoblasts, calvarial osteoblast cultures at days 14 and 21 were lysed in RIPA buffer supplemented with protease inhibitors. Protein concentrations were determined and 50 μg protein per sample was resolved by SDS-PAGE followed by immunoblotting for Runx2 (EMD Biosciences), Atf4 (Santa Cruz), or Hsp90 (Santa Cruz).

### Ubiquitination Assays

To detect ubiquitination of Runx2 in 293T cells, a previously established protocol was followed (Campanero, M. R., and Flemington, E. K. (1997). Proc Natl Acad Sci USA 94, 2221-2226). In brief, 293T cells were transiently transfected with combinations of His-Ub, FLAG-Runx2, Myc-WWP1, and Shn3. Thirty-six to forty-eight hours later, cells were treated with 10 μM MG132 for 2 hours. Cells were washed and lysed in buffer containing 6M guanidium-HCl. Ubiquitinated proteins were precipitated with Ni-NTA-agarose (Novagen), and washed in lysis buffer followed by wash buffer containing 25 mM Tris pH 6.8, 20 mM imidazole. Precipitates were resolved by SDS-PAGE and ubiquitinated FLAG-Runx2 was detected by immunoblotting with anti-FLAG (M2, Sigma) antibody.

To assay the ability of immunoprecipitated Runx2/Shn3 complexes to promote ubiquitination in vitro, various combinations of FLAG-Runx2 and Shn3 were transiently transfected in 293T cells as above. Thirty-six to forty-eight hours later, cells were treated with 10 μM MG132 for 2 hours. Cells were washed, lysed in TNT buffer, and anti-FLAG immunoprecipitations were performed as above. Immune complexes were washed in TNT buffer, then in ubiquitination assay (UA) buffer containing 50 mM Tris, pH 8, 50 mM NaCl, 1 mM DTT, 5 mM MgCl2, and 1 mM ATP. Immunoprecipitates were resuspended in UA buffer supplemented ubiquitin and biotinylated ubiquitin (Boston Biochem) with or without recombinant E1, and E2 (UbCH5a and UbCH7, Boston Biochem). Ubiquitination reactions were allowed to proceed at 30° C. for two hours. Reactions were subsequently resolved by SDS-PAGE, transferred to PVDF membranes, and ubiquitinated proteins were visualized by blotting with streptavidin-HRP (Zymed).

### Pulse-Chase Analysis

293T cells (1×10⁶ cells) were transiently transfected with FLAG-Runx2 (200 ng) with or without Shn3 (1 μg) in 6 well plates. After thirty-six hours, cells were washed and incubated in cysteine/methionine-free medium for one hour. Cells were then labeled with 0.1 mCi/ml S³⁵-labelled cysteine/methionine for one hour. Next, cells were chased in medium containing excess non-radioactive cysteine/methionine for the indicated times. Cells were collected and lysed in TNT buffer supplemented with protease inhibitors, and anti-FLAG immunoprecipitations (M2 agarose slurry, Sigma) were performed at 4° C. overnight. Immunoprecipitates were washed four times in lysis buffer, resolved by SDS-PAGE, and immunoprecipitated proteins were visualized by fluography and quantified with PhosphoImager.

### Transient Runx2 Reporter Assay

C3H10T1/2 cells are passaged in DMEM supplemented with 10% fetal calf serum. Cells are seeded in 12 well dishes at 6×10⁴ cells per well. The next day, cells are transfected with 6×OSE2-firefly luciferase, pTK-renilla luciferase, Runx2 and Shn3 cDNA expression constructs using Effectene transfection reagent (Qiagen). Twenty-four hours later, the medium is changed and compounds dissolved in DMSO, or DMSO-only controls, are added. Eighteen hours later, cells are harvested and analyzed for firefly and renilla luciferase activity according to the manufacturer's instructions (Promega). Compounds that block KRC-mediated repression of Runx2-driven transcriptional activity are scored as positive in this assay.

### C3H-Runx2 Cell Assay

C3H10T1/2 cells are infected with control (RV-GFP) or Runx2-expression (RV-Runx2) retroviruses. Retrovirally-infected cells are further purified by cell sorting based on GFP expression. GFP-positive, RV-Runx2 infected cells are determined to express high levels of osteoblast markers Osterix, alkaline phosphatase, osteocalcin, and bone sialoprotein by RT-PCR. Furthermore, Runx2 protein levels in RV-Runx2 cells are increased following WWP1 RNAi. To screen compounds, RV-Runx2 cells are plated in 96 well plates at 6×10³ cells per well in DMEM-10% medium. Twenty-four hours later, the medium is changed and replaced with osteogenic medium containing 5 mM beta-glycerophosphate and 50 mg/L ascorbic acid along with test compounds and DMSO-only controls. Seventy-two hours later, alkaline phosphatase activity is determined according to the manufacturer's instructions (Sigma) and normalized to cell number per well determined by Alamar Blue staining. Compounds that increase alkaline phosphatase activity are scored as positive in this assay.

### Standard WWP1 Ubiquitin Ligase Assay

Ubiquitin ligase assays are performed in 20 μl reaction volumes containing 20 mM Tris-Hcl pH 8, 50 mM NaCl, 5 mM MgCl2, 1 mM ATP, 1 mM DTT, 50 ng E1 (yeast, Boston Biochem), 50 ng E2 (UbCH7, Boston Biochem) and 100 ng recombinant HECT domain of WWP1. Reactions include 100 ng biotinylated ubiquitin (Boston Biochem) to facilitate detection of assay products. Reactions are assembled on ice, and test compounds or DMSO controls are added. Assays are conducted for 15 minutes at 30 degrees C., and immediately stopped with SDS-sample buffer. Reactions are separated by SDS-PAGE and products detected by blotting with streptavidin-HRP (Zymed). Compounds that block WWP1 ubiquitin ligase activity are scored as positive in this assay.

### High Throughput WWP1 Ubiquitin Ligase Assay

Myc-tagged WWP1 is overexpressed in 293T cells using Effectene (Qiagen). 48 hours later, whole cell lysates are prepared in lysis buffer (20 mM Tris pH 8, 250 mM NaCl, 3 mM EDTA, 0.5% Triton X-100) and lysates are aliquoted and frozen at −80 degrees C. until future use. Ninety-six well plates are coated with anti-Myc monoclonal antibody (9E10, Santa Cruz) at 4 degrees C. overnight. The next morning, plates are washed and blocked in 3% BSA dissolved in PBS for 2-3 hours at room temperature. Plates are then washed and 293T cell lysate is incubated with antibody-coated plates overnight at 4 degrees C. The next morning, plates are washed and incubated with ubiquitin ligase assay mixture (as above) containing biotinylated ubiquitin on ice. Compounds are added and the reaction is allowed to continue at 30 degrees C. for 30 minutes. Plates are washed and incubated with streptavidin-coupled alkaline phosphatase followed by standard alkaline phosphatase colorimetry. Compounds that block WWP1 autoubiquitination activity are scored as positive in this assay.

Human Mesenchymal Stem Cell (hMSC) Culture

For in vitro osteoblast differentiation, hMSCs (Cambrex) were maintained and differentiated following manufactures protocols. hMSCs were plated in Optilux 96-well plates (BD Biosciences) at a concentration of 3.1×10³ cell per cm² in MSC growth media (MSGM). Following an overnight incubation, the growth media was replaced with osteogenic induction media (Cambrex) that contained compounds or vehicle. Cells were cultured in the presence of the compounds or vehicle for seven days at which point osteoblast differentiation was assayed by alkaline phosphatase expression.

To assess extracellular matrix formation, hMSCs were cultured under osteogenic conditions as described above in the presence of the compounds or vehicle for twenty-one days. The growth media was changed every three days for the duration of the culture period. At each media change, the compounds or vehicle were added fresh to the cell cultures. Xyelonol orange (Sigma) was then added to the growth media for an eighteen-hour period at day twenty-one of culture. Each of the cultures was then examined by fluorescent microscope to visualize the formation of extracellular matrix.

### Alkaline Phosphatase Index (API)

To determine API, cell numbers were first established by culturing cells in media containing Alamar blue (Biosource) for 4 hours at 37° C. Plates were read on a fluorimeter at 570 nm. Media containing Alamar Blue was removed and cells were washed 1× with sterile PBS. Cells were then incubated with alkaline phosphatase substrate (Sigma) for 1 hour at room temperature. Following incubation period, the plate was read at 405 nm. Alkaline phosphatase levels were then normalized to cell number to establish API (API=Alk. Phos./alamar blue).

### Example 1

### Generation of Shn3 Deficient Mice

To investigate the function of Shn3 in vivo, mice bearing a null mutation in the murine Shn3 gene were generated by homologous recombination. Exon 4 of the Shn3 gene, on mouse chromosome 4, contains 5.4 kB of DNA that includes the ATG start codon as well as the coding sequence for eighty-percent of the entire protein. When the ATG start codon in Exon 4 was replaced with a neomycin-resistance cassette, it resulted in a null Shn3 allele that produced no detectable mRNA or protein. The targeted Shn3 allele was maintained at expected frequencies as 129/B6 Shn3 heterozygous mice. All subsequent experiments were performed using Shn3^{-/-} and WT mice backcrossed at least five generations to C57BL/6 mice.

### Example 2

### Increased Bone Mass in Shn3 Deficient Mice

Homozygous Shn3 mutant (Shn3^{-/-}) mice were born at the expected Mendelian ratio and were healthy with no apparent gross phenotypic abnormalities in the major organs examined. However, analysis of 8-week old wild-type (WT) and Shn3^{-/-} mice by three-dimensional μ-QCT digital radiography showed an increased radiopacity in the long bones of mature homozygous mutant mice. Further analysis of the skeletal architecture in these mice by two-dimensional μ-QCT revealed a dramatic increase in trabeculation present within the long bones and vertebrae of Shn3^{-/-} mice. Serial cross-sections of femurs from Shn3^{-/-} mice show that increased trabecular bone is present throughout the length of the femur, including distal regions of the diaphysis (FIG. 1E). In contrast, femurs isolated from WT mice show no trabeculation within the diaphysis and only modest levels of trabecular bone in the epiphysis and metaphysis of the femur. Quantitative analysis shows both the trabecular number and trabecular thickness is increased in the femurs of Shn3^{-/-} mice. The increase in these two parameters results in the trabecular bone volume (BV/TV) of Shn3^{-/-} mice being increased 4.5-fold over the trabecular bone volume observed in WT control mice. Additionally, the bone mineral density (BMD) of Shn3^{-/-} mice is 250% that of WT mice.

The elevated bone mass present in mature Shn3^{-/-} mice may result from dysfunctional prenatal bone development and/or a dysfunction in postnatal skeletal remodeling. To better understand if the increased bone mass present in Shn3^{-/-} mice is a result of a dysregulation in bone morphogenesis, bone growth and development was analyzed in newborn WT and Shn3^{-/-} mice. Whole skeletal preparations from P4 WT and Shn3^{-/-} mice were stained with alizarin red/alcian blue to analyze mineralized bone and non-mineralized cartilage formation, respectively. Skeletal morphogenesis occurs normally in Shn3^{-/-} mice analyzed at P4, with no premature cartilage mineralization being detected in those areas of the skeleton undergoing endochondral ossification. Collectively, these results suggest a postnatal role for Shn3 in skeletal remodeling in which Shn3 functions to inhibit bone formation.

### Example 3

### Shn3 is not Required for Osteoclast Differentiation or Function

To understand the role of Shn3 in skeletal remodeling, Shn3 expression was examining in those cell types involved in bone remodeling. Shn3 mRNA can be detected in whole bone, osteoblasts, and, to a lesser extent, in osteoclasts. The nonrestrictive pattern of Shn3 expression suggests that increased bone mass observed in the Shn3^{-/-} mice may result from alterations in osteoblast and/or osteoclast function. To determine whether Shn3 functions to regulate osteoclast biology, in vitro osteoclast differentiation assays were performed by following previously established protocols in which bone marrow is harvested and cultured in the presence of M-CSF and RANKL to generate TRAP+ osteoclasts. Differentiation of bone marrow harvested from Shn3^{-/-} mice resulted in similar numbers of multi-nucleated TRAP+ cells when compared to WT bone marrow cultured under identical conditions. Similar numbers of osteoclasts were also observed when WT and Shn3^{-/-} splenocytes were cultured under conditions that promote osteoclastogenesis. These results suggest that Shn3 expression is dispensable for the differentiation of osteoclasts from precursor cells.

It has previously been reported that skeletal abnormalities that result from defects intrinsic to the osteoclast can be rescued following transfer of wild-type bone marrow into irradiated hosts (Li, J., et al. (2000). Proc Natl Acad Sci USA 97, 1566-1571). Rescue of the host phenotype occurs as a result of the WT donor osteoclasts, which are derived from hematopoietic progenitors, repopulating the microenvironment of the host bone and mediating bone resorption. To confirm that the skeletal phenotype observed in the Shn3^{-/-} mice is not the result of an intrinsic defect in the osteoclast, a series of bone marrow transfer experiments were performed in which bone marrow cells harvested from WT mice were injected into lethally irradiated 4-week-old Shn3^{-/-} mice. After four weeks, the mice were sacrificed and the femurs were analyzed by radiography. The transfer of WT bone marrow failed to reduce the amount of trabeculation present in the femurs of recipient Shn3^{-/-} mice. These results further indicate that the increased bone mass present in the Shn3^{-/-} mice is not the result of deficiencies in the osteoclast lineage, but rather, results from an increased osteoblast function and dysregulated bone formation.

### Example 4

### Increased Bone Formation Rate in Shn3-Deficient Mice

To determine if the increased bone mass seen in Shn3^{-/-} mice results from alterations in bone formation, a number of histomorphometric parameters were analyzed in 8-week old Shn3^{-/-} and WT mice, including calcein double-labeling and fluorescent micrography to examine in vivo bone formation rates. The increased distance between the two calcein labels observed in the tibial bones of Shn3^{-/-} mice demonstrates that these mice have elevated levels of new bone formation when compared to WT mice. Quantitative analysis reveals the bone formation rate in Shn3^{-/-} mice to be five-fold the rate observed in WT control animals. BFR is calculated by multiplying the mineral apposition rate (MAR), which is a reflection of the bone formation capabilities of osteoblasts, by the area of mineralized surface per bone surface (MS/BS). Additional histomorphometric analysis shows the Shn3^{-/-} mice have increases in both mineral apposition rate (MAR) and mineralizing surface (MS/BS. However, the osteoblast surface (Ob.S/BS) (a reliable indicator of osteoblast population) in Shn3^{-/-} mice is comparable to WT mice. These data suggest that the increased rate of bone formation observed in the Shn3^{-/-} mice is caused by a functional augmentation of the osteoblasts and not by an increase in the number of osteoblasts. Interestingly, the thickness of the osteoid layer was comparable between WT and Shn3^{-/-} mice. Since Shn3^{-/-} mice have a similar osteoid thickness but an increase in MAR when compared to WT control mice, the time between osteoid formation and onset of mineralization must be decreased in Shn3^{-/-} mice. Therefore, the osteosclerotic phenotype present in Shn3^{-/-} mice results from aberrant bone formation and mineralization.

### Example 5

### Altered In Vitro Activity of Shn3−/− Osteoblasts

To verify that the increased bone mass observed in Shn3^{-/-} mice is the effect of dysregulated osteoblast activity, a series of in vitro experiments were conducted on primary osteoblasts derived from the calvariae of newborn Shn3^{-/-} and WT mice. These ex vivo osteoblast cultures have been reported to consist mainly of osteoblast precursors and immature osteoblasts. When matured in culture, these osteoblasts possess the capacity to form mineralized nodules, which reflects the cells' ability to generate extracellular matrix (Ducy, P., et al. (1999). Genes Dev 13, 1025-1036; Yoshida, Y., et al. (2000). Cell 103, 1085-1097). When Shn3^{-/-} and WT osteoblast cultures were examined by von Kossa staining at days 0 and 5 for the presence of mineralized matrix, it was found that Shn3^{-/-} cultures have an increased number of mineralized bone nodules. Furthermore, the mineralized nodules formed in the Shn3^{-/-} osteoblast cultures were generally larger when compared to the mineralized nodules formed in the WT osteoblast cultures. The increased mineralized matrix present within Shn3^{-/-} cultures did not result from these cultures containing an increased number of osteoblasts as WT and Shn3^{-/-} cultures had a similar number of alkaline phosphatase (ALP) positive cells and displayed similar rates of cellular proliferation. The increased activity by the Shn3^{-/-} osteoblasts in vitro correlates with the Shn3^{-/-} mice exhibiting an increased BFR in vivo, and further demonstrates that dysregulated osteoblast activity is responsible for the observed phenotype.

The increase in mineralized nodule formation by Shn3^{-/-} osteoblasts may result from alterations in the expression of genes involved in osteogenesis. Analysis of gene transcription by quantitative real-time PCR (Q-PCR) revealed Shn3^{-/-} osteoblasts to express enhanced levels of BSP, ColI(α)1, and OCN mRNA but similar levels of ALP mRNA when compared to WT osteoblasts. ATF4, a key regulator of osteoblast biology (Yang, X., et al. (2004). Cell 117, 387-398), was also elevated in Shn3^{-/-} osteoblasts at both the mRNA and protein level. Additionally, Shn3 itself was upregulated during osteoblast differentiation in vitro, further highlighting an osteoblast-intrinsic role for Shn3. Therefore, Shn3 regulates the expression of a number of genes that are important in bone formation and mineralization.

### Example 6

### Shn3 Regulates Runx2 Protein Stability Through a Direct Interaction

Since the osteoblast-specific genes that were overexpressed in Shn3^{-/-} osteoblasts are all direct targets of the transcription factor Runx2 (Stein, G. S., et al. (2004). Oncogene 23, 4315-4329; Yang, X., et al. (2004). Cell 117, 387-398), Shn3 may exert its inhibitory influence on osteoblast activity via an effect on Runx2 itself. Accordingly, levels of Runx2 mRNA and protein were quantitating in Shn3^{-/-} and WT osteoblasts. Interestingly, Shn3^{-/-} osteoblasts showed elevated levels of Runx2 protein even though levels of Runx2 mRNA were comparable between Shn3^{-/-} and WT osteoblasts. This led to the question of whether Shn3 may regulate Runx2 protein stability. When overexpressed in 293T cells, Shn3 led to a dose-dependent decrease in steady-state Runx2 levels. Furthermore, overexpression of Shn3 led to accelerated degradation kinetics of overexpressed Runx2, as judged by pulse-chase experiments.

A number of possible mechanisms whereby Shn3 promotes Runx2 degradation can be envisioned, and the relationship between Shn3, Runx2, and TGF-β was investigated for the following reasons. First, in vivo overexpression of TGF-β in bone leads to osteoporosis (Erlebacher, A., and Derynck, R. (1996). J Cell Biol 132, 195-210; Erlebacher, A., et al. (1998). Mol Biol Cell 9, 1903-1918), while osteoblast-specific overexpression of a dominant-negative TGFβR leads to increased trabecular bone mass (Filvaroff, E., et al. (1999). Development 126, 4267-4279) similar to that observed in Shn3^{-/-} mice. Second, it has been previously observed, that similar to the binding of Shn to Mad in Drosophila, Shn3 could directly interact with R-Smad proteins, most notably the TGF-β-dependent R-Smad, Smad3. Third, a well-documented binding partner of Runx2 is Smad3 (Alliston, T., et al. (2001). Embo J 20, 2254-2272; Ito, Y., and Zhang, Y. W. (2001). J Bone Miner Metab 19, 188-194; Sowa, H., et al. (2004). J Biol Chem 279, 40267-40275).

It was therefore reasoned that Shn3 regulates Runx2 protein stability by physical interaction. Indeed, Runx2 specifically co-immunoprecipitated Shn3 in cotransfection studies, and this interaction was mediated via the Runt (DNA binding) domain of Runx2. Additionally, it was possible to detect an interaction between endogenous Runx2 and Shn3 in MC3T3-E1 osteoblastic cells further differentiated into mature osteoblasts with ascorbic acid, β-glycerophosphate, and BMP-2 (Zamurovic, N., et al. (2004). J Biol Chem 279, 37704-37715). Although low levels of Shn3/Runx2 association were detected in cells following differentiation, treating the differentiated cells with TGF-β dramatically enhanced the association between Runx2 and Shn3.

To determine the consequences of the Runx2/Shn3 interaction with respect to Runx2 function, the Osteocalcin promoter, a well-characterized Runx2-binding site termed OSE2 (Ducy, P., et al. (1997). Cell 89, 747-754), was utilized. While Runx2 potently activated transcription from a multimerized OSE2-luciferase reporter construct, co-expression of Shn3 dose-dependently inhibited Runx2 activity. Co-treatment of cells with TGF-β, or co-expression of Smad3 further augmented Shn3's inhibitory effects towards Runx2. From these studies, it is concluded that Shn3 physically associates with Runx2, this association is promoted by TGF-β signaling, and Shn3 can inhibit Runx2 function in the context of this TGF-β-inducible complex.

### Example 7

### Shn3 Promotes the Ubiquitination of Runx2

Since it was demonstrated that Shn3 associates with and promotes the degradation of Runx2, it was determined whether Shn3 could promote the ubiquitination of Runx2. In overexpression studies, Shn3 promoted Runx2 ubiquitination. Furthermore, when Shn3/Runx2 complexes were immunopurified from 293T cells and used in in vitro ubiquitination assays, specific ubiquitin ligase activity was detected.

Although Shn3 promoted the ubiquitination of Runx2, Shn3 itself contains no canonical E3 ubiquitin ligase domains (RING, HECT, or U box, for review see, Patterson, C. (2002). Sci STKE 2002, PE4; Pickart, C. M. (2001). Annu Rev Biochem 70, 503-533,). Additionally, various recombinant protein fragments of Shn3 possessed no detectable in vitro E3 ubiquitin ligase activity. These observations led to the hypothesis that Shn3 may associate with a known E3 ubiquitin ligase to promote Runx2 ubiquitination. It has previously been demonstrated that Runx2 could be ubiquitinated by Smurf1 (Zhao, M., et al. (2004). J Biol Chem 279, 12854-12859; Zhao, M., et al. (2003). J Biol Chem 278, 27939-27944). Smurf1 belongs to a family of HECT domain-containing E3 ligases termed the Nedd4 family, all of which possess N-terminal C2 domains for membrane targeting, internal WW domains responsible for recognition of substrates with PPXY motifs, and C-terminal HECT E3 ligase domains (Ingham, R. J., et al. (2004). Oncogene 23, 1972-1984).

Although a physical interaction between Shn3 and Smurf1 was not detected, Shn3 did co-immunoprecipitate another member of the Nedd4 family of E3 ubiquitin ligases, WWP1. WWP1 has previously been shown to interact with all R— and I-Smad proteins, and to promote the ubiquitination of Smad6 and Smad7 (Komuro, A., et al. (2004). Oncogene 23, 6914-6923); however, the ability of WWP1 to ubiquitinate Runx proteins, which also possess PPXY motifs in their Runt domains (Jin, Y. H., et al. (2004). J Biol Chem 279, 29409-29417), had not been investigated. It was observed that WWP1 promoted low levels of Runx2 ubiquitination when overexpressed in 293T cells. However, when WWP1 was coexpressed with Shn3, the two synergistically acted to promote Runx2 ubiquitination.

Although not wishing to be bound by theory, these data suggest a model in which TGF-β signaling in osteoblasts promotes the formation of a multimeric complex between Runx2, Smad3, Shn3, and the E3 ubiquitin ligase WWP1. This complex inhibits Runx2 function due to the ability of WWP1 to promote Runx2 polyubiquitination and proteasome-dependent degradation. Shn3 is an integral component of this complex, since in its absence osteoblasts show elevated levels of Runx2 protein, enhanced Runx2 transcriptional activity, elevated transcription of Runx2 target genes, and increased bone formation in vivo. Signaling through the TGFβ receptor expressed on the surface of osteoblasts results in Smad3 complexing with Smad4 and translocating to the nucleus. Shn3, through its interaction with Smad3, associates with this complex in the nucleus to repress the transcription of genes involved in bone matrix biosynthesis. The nuclear Shn3/Smad complex further associates with WWP1, a HECT-domain containing E3 ligase. This complex interacts with and promotes the ubiquitination of Runx2, a key transcriptional regulator of genes involved in osteoblast differentiation and extracellular matrix biosynthesis. The ubiquitination of Runx2 by the Smad/Shn3/WWP1 complex targets Runx2 for proteosome-mediated degradation and/or the ubiquitination of Runx2 inhibits the transcriptional activity of this protein.

### Example 8

### Defective Osteoclastogenesis Occurs in Shn3^{-/-} Mice In Vivo

A component of the high bone mass phenotype observed in our Shn3-deficient mice is clearly due to increased osteoblast matrix synthetic activity. In addition to their ability to synthesize and direct the mineralization of bone matrix, osteoblasts are known to produce RANKL, the critical cytokine known to induce osteoclastogenesis in vivo (Teitelbaum and Ross (2003) Nat Rev Genet. 4(8):638-49). To determine if defective osteoclastogenesis in vivo may account for the osteosclerotic phenotype observed in our Shn3−/− strain, neonatal calvarial whole mount preparations were stained in situ for TRAP, a specific marker of mature osteoclasts. Decreased numbers of TRAP-positive cells in Shn3-deficient skulls, indicating decreased osteoclastogenesis in vivo. RANKL mRNA levels from whole bone or from calvarial osteoblast cultures were analyzed. Shn3-deficient osteoblasts show reduced levels of RANKL transcripts throughout the course of in vitro differentiation. Therefore, although hyperactive osteoblast matrix synthesis contributes to the elevated bone formation rates observed in vivo, the pronounced elevation in overall bone mass may due to both increased osteoblast activity and defective osteoclastogenesis in vivo.

### Example 9

### TGFβ Requires SHN3 to Reduce Bone Mass In Vivo

In the model organism Drosophila, the Schnurri gene is known to function in the Decapentaplegic (Dpp) signaling pathway. A mammalian homologue of the Dpp cytokine is the pleiotropic signaling molecule Transforming Growth Factor-β (TGFβ). Since SHN3 (also called KRC) is a mammalian homologue of Drosophila Schnurri, it was determined whether the ability of SHN3 to antagonize bone formation is downstream of TGFβ.

Previous studies have suggested an important role for TGFβ in skeletal biology. Mice overexpressing activated TGFβ in bone (termed D4 mice) display a dramatic osteopenia with reductions in mineralized trabecular bone, disorganized and hypercellular cortical bone, and spontaneous fractures (Erlebacher, et al. (1998) Mol Biol Cell. 9(7):1903-18)).

It had previously been reported that TGFβ signaling protein Smad3 binds and inhibits Runx2-mediated gene expression in osteoblasts (Alliston, et al. (2001) EMBO J. 20(9):2254-72; Kang, et al. (2005) EMBO J. 24(14): 2543-2555).

To determine if TGFβ requires SHN3 to reduce bone mass in vivo, 293T cells were transfected with Shn3 along with FLAG-tagged versions of Smad1-8. Forty-eight hours later, cells were harvested followed by anti-FLAG immunoprecipitations. Bound proteins were resolved by SDS-PAGE and immunoblotted for Shn3 or FLAG.
The results show that SHN3 can interact with Smad3 proteins.

Moreover, the interaction between SHN3 and Runx2 was promoted by TGFβ. It was therefore determined whether SHN3 is downstream of TGFβ in vivo. Indeed, while D4 mice on a wild type background show the aforementioned skeletal abnormalities, D4 SHN3−/− mice show a pronounced rescue of trabecular bone mass, as well as more organized cortical bone and reduced spontaneous fractures. Therefore, SHN3 is required for the ability of TGFβ to reduce bone mass in vivo.

### Example 10

### Shn3 Regulates RSK2 Function Through a Direct Interaction

An outstanding question is whether substrates for the SHN3/WWP1 ubiquitin ligase complex other than Runx2 exist. The possibility that the RSK2/ATF4 pathway is directly regulated by SHN3/WWP1 was investigated for the following reasons: (1) ATF4 is a transcription factor required for high levels of collagen synthesis by mature osteoblasts; (2) RSK2 is a kinase known to phosphorylate ATF4 that is required for optimal extracellular matrix production by osteoblasts (Yang, et al. (2004) Cell. 117(3):387-98.); (3) SHN3−/− osteoblasts show elevated levels of ATF4 mRNA and protein, as well as an accumulation of hyperphosphorylated ATF4.

Indeed, just as SHN3 overexpression inhibits Runx2-driven transcription in reporter assays, SHN3 overexpression inhibits ATF4-driven transcription as well as RSK2-mediated potentiation of ATF4 function. SHN3 and WWP1 do not physically associate with ATF4 protein, but both readily co-immunoprecipitate with RSK2. SHN3 and WWP1 can promote RSK2 ubiquitination. Additionally, both SHN3 and WWP1 can inhibit RSK2 function in in vitro kinase assays.

Importantly, levels of RSK2 autophosphorylation are increased in SHN3−/− osteoblasts, and increased immunoreactivity of several protein species detectable with a phospho-specific anti-RSK substrate antibody are detected in SHN3−/− osteoblasts. Interestingly, although ATF4 is thought to be an important substrate for RSK2 in wild type osteoblasts, SHN3−/−ATF4−/− mice show increased trabecular bone volumes comparable to SHN3−/− mice, suggesting that RSK2 substrates other than ATF4 play an important role in the increased bone formation seen in SHN3−/− mice.

### EQUIVALENTS

Those skilled in the art will recognize, or be able to ascertain using no more than routine experimentation, many equivalents to the specific embodiments of the invention described herein. Such equivalents are intended to be encompassed by the following claims.

1. A method of identifying compounds useful in increasing bone formation and mineralization comprising,
a) providing (i) a cellular indicator composition comprising KRC, WWP1, and Runx2, or biologically active fragments thereof; and (ii) a reporter gene responsive to the Runx2 polypeptide, or biological active fragment thereof;
b) contacting the indicator composition with each member of a library of test compounds;
c) evaluating the expression of the reporter gene in the presence and absence of the test compound;
d) selecting from the library of test compounds a compound of interest that increases the expression of the reporter gene;
e) evaluating the ability of the test compound of interest to increase mesenchymal stem cell differentiation, comprising contacting a mesenchymal stem cell comprising KRC, WWP1, and Runx2, or biologically active fragments thereof, with the test compound of interest and determining the effect of test compound on mesenchymal stem cell differentiation in the presence and absence of the test compound, to thereby identify a compound that increases bone formation and mineralization.

2. The method of claim 1, wherein the indicator composition comprises a biologically active portion of Runx2 which comprises the PPXY domain.

3. The method of claim 1, wherein the indicator composition comprises a biologically active portion of WWPI which comprises the HECT domain.

4. The method of claim 1, wherein the effect of the test compound of interest on mesenchymal stem cell differentiation is evaluated by determining the level of cellular alkaline phosphatase (ALP).

5. The method of claim 1, further comprising evaluating the effect of the test compound of interest on mineralization.

6. The method of claim 1, further comprising evaluating the ability of the test compound of interest to modulate the E3 ubiquitin ligase activity of WWP1, comprising providing an indicator composition comprising WWP1, or a biologically active fragment thereof; contacting the indicator composition with the test compound of interest; and determining the effect of the test compound of interest on the E3 ubiquitin ligase activity of WWP1 in the presence or absence of the test compound of interest.

7. The method of claim 1, further comprising evaluating the ability of the test compound of interest to decrease an interaction between WWPI and Runx2, comprising providing an indicator composition comprising WWP1 and Runx2, or biologically active fragments thereof; contacting the indicator composition with the test compound of interest; and determining the effect of the test compound of interest on the interaction of WWP1 and Runx2 in the presence or absence of the test compound.

8. The method of claim 6, further comprising determining the effect of the test compound of interest on bone formation and mineralization in a non-human adult animal, comprising administering the test compound to the animal and determining the effect of test compound on bone formation and mineralization in the presence and absence of the test compound, wherein an increase in bone formation and mineralization in the non-human animal identifies the test compound of interest as a compound that increases bone formation and mineralization.

9. The method of claim 1, wherein a SMAD3 molecule is also present in the indicator composition.

10. The method of claim 1, wherein a RSK2 molecule is also present in the indicator composition.

11. A method of identifying compounds useful in increasing bone formation and mineralization comprising,
a) providing a mesenchymal stem cell comprising KRC, WWP1, and Runx2, or biologically active portions thereof;
b) contacting the indicator composition with each member of a library of test compounds; and
c) selecting from the library of test compounds a compound of interest that increases the differentiation of the mesenchymal stem cell into an osteoblast to thereby identify a compound that increases bone formation and mineralization.

12. A method of identifying compounds useful in increasing bone formation and mineralization comprising,
a) providing (i) a cellular indicator composition comprising KRC, WWP1, and Runx2, or biologically active portions thereof; and (ii) a reporter gene responsive to the Runx2 polypeptide, or biological active fragment thereof;
b) contacting the indicator composition with each member of a library of test compounds;
c) evaluating the expression of the reporter gene in the presence and absence of the test compound;
d) selecting from the library of test compounds a compound of interest that increases the expression of the reporter gene;
e) evaluating the ability of the test compound of interest from step d) to increase mesenchymal stem cell differentiation, comprising contacting a mesenchymal stem cell with the test compound of interest and determining the effect of test compound on mesenchymal stem cell differentiation in the presence and absence of the test compound;
f) evaluating the ability of the test compound of interest from step e) to decrease the E3 ubiquitin ligase activity of WWP1, comprising providing an indicator composition comprising WWP1, or a biologically active fragment thereof; contacting the indicator composition with the test compound of interest; and determining the effect of the test compound of interest on the E3 ubiquitin ligase activity of WWP1 in the presence or absence of the test compound of interest; and/or
g) evaluating the ability of the test compound of interest from step e) to decrease an interaction between WWP1 and Runx2, comprising providing an indicator composition comprising WWP1 and Runx2, or biologically active fragments thereof; contacting the indicator composition with the test compound of interest; and determining the effect of the test compound of interest on the interaction of WWP1 and Runx2 in the presence or absence of the test compound; and
h) determining the effect of the test compound of interest from step g) on bone formation and mineralization in an adult non-human animal, comprising administering the test compound to the animal and determining the effect of test compound on bone formation and mineralization in the presence and absence of the test compound, wherein an increase in bone formation and mineralization in the non-human animal identifies the test compound of interest as a compound that increases bone formation and mineralization.

13. A method of identifying compounds useful in increasing bone formation and mineralization comprising,
a) providing (i) a cellular indicator composition comprising KRC, WWP1, and RSK2, or biologically active fragments thereof; and (ii) a reporter gene responsive to the RSK2 polypeptide, or biological active fragment thereof;
b) contacting the indicator composition with each member of a library of test compounds;
c) evaluating the expression of the reporter gene in the presence and absence of the test compound;
d) selecting from the library of test compounds a compound of interest that increases the expression of the reporter gene;
e) evaluating the ability of the test compound of interest to increase mesenchymal stem cell differentiation, comprising contacting a mesenchymal stem cell comprising KRC, WWP1, and RSK2, or biologically active fragments thereof, with the test compound of interest and determining the effect of test compound on mesenchymal stem cell differentiation in the presence and absence of the test compound, to thereby identify a compound that increases bone formation and mineralization.

14. A method of identifying compounds useful in increasing bone formation and mineralization comprising,
a) providing a mesenchymal stem cell comprising KRC, WWP1, and RSK2, or biologically active portions thereof;
b) contacting the indicator composition with each member of a library of test compounds; and
c) selecting from the library of test compounds a compound of interest that increases the differentiation of the mesenchymal stem cell into an osteoblast to thereby identify a compound that increases bone formation and mineralization.

15. A method of identifying compounds useful in increasing bone formation and mineralization comprising,
a) providing (i) a cellular indicator composition comprising KRC, WWP1, and RSK2, or biologically active portions thereof; and (ii) a reporter gene responsive to the Runx2 polypeptide, or biological active fragment thereof;
b) contacting the indicator composition with each member of a library of test compounds;
c) evaluating the expression of the reporter gene in the presence and absence of the test compound;
d) selecting from the library of test compounds a compound of interest that increases the expression of the reporter gene;
e) evaluating the ability of the test compound of interest from step d) to increase mesenchymal stem cell differentiation, comprising contacting a mesenchymal stem cell with the test compound of interest and determining the effect of test compound on mesenchymal stem cell differentiation in the presence and absence of the test compound;
f) evaluating the ability of the test compound of interest from step e) to decrease the E3 ubiquitin ligase activity of WWP1, comprising providing an indicator composition comprising WWP1, or a biologically active fragment thereof; contacting the indicator composition with the test compound of interest; and determining the effect of the test compound of interest on the E3 ubiquitin ligase activity of WWP1 in the presence or absence of the test compound of interest; and/or
g) evaluating the ability of the test compound of interest from step e) to decrease an interaction between WWPI and RSK2, comprising providing an indicator composition comprising WWP1 and RSK2, or biologically active fragments thereof; contacting the indicator composition with the test compound of interest; and determining the effect of the test compound of interest on the interaction of WWP1 and RSK2 in the presence or absence of the test compound; and
h) determining the effect of the test compound of interest from step g) on bone formation and mineralization in an adult non-human animal, comprising administering the test compound to the animal and determining the effect of test compound on bone formation and mineralization in the presence and absence of the test compound, wherein an increase in bone formation and mineralization in the non-human animal identifies the test compound of interest as a compound that increases bone formation and mineralization.


SEQUENCE LISTING (2 sequences)

SEQ ID NO: 1 - DNA, 8546 bp, Homo sapiens
  CDS (889)...(8106)
acacctgcgcgccggaataattcatgaagaaggggctggatccgtgggtcagagaacacaggaccagtttgccatcccaaggccgaaggcctccctccaacacagttctccaagctctagaaatctctgacacatcttgaccatgagaccacggctggtttttggcaggattcgaggcacaaacccagcagcctcaacctagttcatggaggagcctcgcggggtcctggccaagcaagcccgcccctctggtgggaagagcggcgcctaggtggagggtggctgccgtaggagtggacatgaatgctggctttcagagagaacagcgtttcagttttggtcatcggaagtggtgccttcagcacagaagaagagcgtgatttctcctccaaggccgttgatctccaacccagaactaaaggggagaagagccacccccagcatccagcgtggcatctcttgtgccaggaccagggatgactgggccatggacacagatgtctccaaccttcaaccgtttgcatagcacacgggggactcgtgggggccacctgccactgccagctgaaataatacaatggcaatactgacatccttcatgacgttttcccgacagacattcaggcagaaagtgctggtgcgttttctgtctgcaaagtagagggccatcgctcaccaatagaatagcgtgggccctgatgacctgctccgagtccactcacagccagtgacacttgcaaaaaactcccaaagccgtcttgggtttggctcccacagctcttgaccaatgtggccaaagctggacacctccttgggacactgggattattcataaatgcagcccgccctgactctccctgaatagcatctgaagtctttgtgaaggtcatggatcctgaacaaagtgtcaagggcaccaagaaggctgagggaagtccccggaagcggctgaccaaaggagaggccattcagaccagtgtttcttccagcgtcccatacccaggcagcggcacagctccgacccaagagagccccgcccaagagctcttagccccgcagcccttcccgggcccctcatcagttcttagggaaggctctcaggagaaaacgggccagcagcagaagccccccaaaaggccccccatcgaagcatccgtccacatctcacacgttccgcagcaccctctgacaccagcattcatgtcgcctggcaaacctgagcatctcctggaggggtccacatggcaactggttagccccatgagactcggaccctctggctccttgctggcccctgggctccatcctcagagccagctccttccttcccacgcttccatcattccccccgaggaccttcctggagtccccaaagtcttcgtgcctcgtccttcccaggtctccttgaagcccacagaagaggcacacaagaaggagaggaagccccagaagccaggcaagtacatctgccagtactgcagccggccctgtgccaagcccagcgtgctccagaagcacattcgctcacacacaggtgagaggccctacccctgcggcccctgtggcttctccttcaagaccaagagtaatctctacaagcacaggaagtcccatgcccaccgcatcaaagcaggcctggcctcaggcatgggtggcgagatgtacccacatgggctggagatggagcggatccctggggaagagtttgaggagcccactgagggagaaagcacagattctgaagaggagactagtgccacctctggtcaccctgcagagctctccccaagacccaagcagccccttctctccagcgggctatacagctctgggagccacagttccagccacgaacgctgttccctgtcccagtccagcacagcccagtcactcgaagacccccctccatttgtggaaccctcatctgagcaccccctgagccataaacctgaagacacccacacgattaagcagaagctggccctccgcttaagcgagaggaagaaggtgatcgatgagcaggcgtttctgagcccaggcagcaaagggagtactgagtctgggtatttctctcgctccgagagtgcagagcagcaggtcagccccccaaacaccaacgccaagtcctacgctgagatcatctttggcaagtgtgggcgaataggacagcggaccgccatgctgacagccacctccacccagcccctcctgcccctctccaccgaagacaagcccagcctggtgcctttgtctgtaccccggacgcaggtgatcgagcacatcacgaagctcatcaccatcaacgaggccgtggtggacaccagtgagatcgacagcgtgaagccaaggcggagctcactgtccaggcgcagcagcatggagtccccaaaatccagcctctaccgggagcccctgtcatcccacagtgagaaaaccaagcctgaacaatcactgctgagcctccagcacccgcccagtaccgccccccctgtgcctctcctgagaagccactcaatgccttctgccgcctgcactatcagcaccccccaccaccccttccgaggtagctactccttcgatgaccatatcaccgactccgaagccctgagccgcagcagtcacgtgtttacctcccacccccggatgctgaagccgcagccggcaatcgaattacctttgggaggggaatacagttctgaggagcctggcccaagcagcaaagacacagcctccaagccctcggacgaagtggaacccaaggaaagcgagcttaccaaaaagaccaagaagggtttgaaaacaaaaggggtgatctacgaatgtaacatatgtggtgctcggtacaagaaaagggataactacgaagcccacaaaaaatactactgctcagagcttcagatcgcaaagcccatctctgcaggcacccacacatctccagaagctgaaaagagtcagattgagcatgagccgtggtcccaaatgatgcattacaaactgggaaccaccctggaactcactccactgaggaagaggaggaaagagaagagccttggggacgaggaagagccacctgcctttgagtccacaaaaagtcagtttggcagccccgggccatctgatgctgctcggaaccttcccctggagtccaccaagtcaccagcagaaccaagtaaatcagtgccctccttggagggacccacgggcttccagccaaggactcccaagccagggtccggttcagaatcagggaaggagaggagaacaacgtccaaagaaatttctgtcatccagcacaccagctcctttgagaaatctgattctctcgagcagccgagtggcttggaaggggaagacaaacctctggcccagttcccatcacccccacctgccccacacggacgctctgctcactccctgcagcctaagttggtccgccagcccaacattcaggttcctgagatcctagtaactgaggagcctgaccggccggacacagagccagagccgccccctaaggaacctgagaagactgaggagttccaatggccccagcgcagccagacacttgcccagctcccagctgagaaggctccacccaaaaagaagaggttgcgcctggcagagatggcccaatcatcaggggagtccagcttcgagtcctctgtgcctctgtctcgcagcccgagccaggaaagcaatgtctctttgagtgggtccagccgctcagcctcgtttgagagggatgaccatgggaaagccgaggcccccgatccctcatctgacatgcgccccaaacccctgggcacccacatgttgactgtccccagccaccacccacatgcccgagagatgcggaggtcagcctcagagcagagccccaacgtttcccattctgcccacatgaccgagacacgcagcaaatcctttgactatggcagcttgtccttgacaggcccttctgctccagccccagtggctccaccagccggggaggccccgccagagagaagaaaatgcttcttggtgagaagcccctctctgagcaggcctccagaatctgagttggaggttgcccccaagggaagacaggagagcgaagaaccacagccctcatccagtaaaccctctgccaaaagctcattgtcccagatttcctctgcggccacctcacatggtggacccccgggaggcaagggcccagggcaggacaggcccgcattggggcccactgtgccctacacagaagcactgcaagtgttccaccaccccgttgcccagacacccctgcatgagaagccatacctgcccccaccagtctcccttttctccttccagcatctcgtgcagcatgagccaggacagtctccagaattcttctccacccaggccatgtccagcctcctgtcctcaccatactccatgcccccacttcctccctccttatttcaagccccaccgcttcctctccagcctactgttctgcacccaggccaactccatctcccccagctcatgcctcacccagccaacatccccttcaggcaacccccttccttcctccccatgccatacccgacctcctcagcactgtcttctgggtttttcctgcctctgcaatcccagtttgcacttcagctccctggtgatgtggaaagccatctgccccagatcaaaaccagcctggccccactggcaacaggaagtgctggcctctcccccagccaagagtacagcagtgacatccggctaccccctgtggctcccccagccagctcctcagcacctacatcagctcctccactggccctgcctgcctgtccagacaccatggtgtccctggttgtgcctgtccgtgttcagaccaatatgccgtcctatgggagcgcaatgtacaccaccctttcccagatcttggtcacccagtcccaaggcagctcagcaactgtggcacttcccaagtttgaggaacccccatcaaaggggacgactgtatgtggtgcagatgtgcatgaggttgggcccggcccttctgggttaagtgaagagcaaagcagagctttcccaactccatacctgagagtgcctgtgacattacctgaaagaaaaggcacttccctgtcatcagagagtatcttgagcctggaggggagttcatcaacagcagggggaagcaaacgtgtcctttcaccagctggcagccttgaacttaccatggaaacccagcagcaaaaaagagtgaaggaggaggaggcttccaaggcagatgaaaaacttgagctggtaaaaccatgcagtgtggtccttaccagcaccgaggatgggaagaggccagagaaatcccacttaggcaaccagggccaaggcaggagggagctagaaatgctgtccagcctgtcctcagatccatctgacacaaaggaaattcctcccctccctcaccctgcattgtcccatgggcaagccccaggctcagaagctttgaaggaatatccccagccatctggcaaacctcaccgaagagggttgaccccactgagcgtgaagaaagaagattccaaggaacaacctgatctcccctccttggcacctccgagctctctgcctctgtcagaaacgtcctccagaccagccaagtcacaagaaggtacggactcaaagaaggtactgcagttccccagcctccacacaaccactaatgtcagttggtgctatttaaactacattaagccaaatcacatccagcatgcagataggaggtcctctgtttacgctggttggtgcataagtttgtacaaccccaaccttccgggggtttccactaaagctgctttgtccctcctgaggtctaagcagaaagtgagcaaagagacatacaccatggccacagctccgcatcctgaggcaggaaggcttgtgccatccagctcccgcaagccccgcatgacagaggttcacctcccttcactggtttccccggaaggccagaaagatctagctagagtggagaaggaagaagagaggagaggggagccggaggaggatgctcctgcctcccagagaggggagccggcgaggatcaaaatcttcgaaggagggtacaaatcaaacgaagagtatgtatatgtgcgaggccgcggccgagggaaatatgtttgtgaggagtgtggaattcgctgcaagaagcccagcatgctgaagaaacacatccgcacccacactgacgtccggccctatgtgtgcaagcactgtcactttgcttttaaaaccaaagggaatctgactaagcacatgaagtcgaaggcccacagcaaaaagtgccaagagacaggggtgctggaggagctggaagccgaagaaggaaccagtgacgacctgttccaggactcggaaggacgagagggttcagaggctgtggaggagcaccagttttcggacctggaggactcggactcagactcagacctggacgaagacgaggatgaggatgaggaggagagccaggatgagctgtccagaccatcctcagaggcgcccccgcctggcccaccacatgcactgcgggcagactcctcacccatcctgggccctcagcccccagatgcccccgcctctggcacggaggccacacgaggcagctcggtctcggaagctgagcgcctgacagccagcagctgctccatgtccagccagagcatgccgggcctcccctggctgggaccggcccctctgggctctgtggagaaagacacaggctcagccttgagctacaagcctgtgtccccaagaagaccgtggtccccaagcaaagaagcaggcagccgtccaccactagcccgcaaacactcgctaaccaaaaacgactcatctccccagcgatgctccccggcccgagaaccacaggcctcagccccaagcccacctggcctgcacgtggacccaggaaggggcatgggccctctcccttgtgggtctccaagacttcagctgtctcctctcaccctctgccccctgggaagagaactggcccctcgagcacatgtgctctccaaactcgagggtaccaccgacccaggcctccccagatactcgcccaccaggagatggtctccaggtcaggccgagtcaccaccacggtcagcgccgccagggaagtgggccttggctgggccgggcagcccctcagcgggggagcatggcccaggcttggggctggccccacgggttctcttcccgcccgcgcctctacctcacaagctcctcagcagaagcccagagacctgcgcctccccgtggcagaaggccgagtcccgaagtccctcctgctcacccggccctgctcatcctctctcctcccgacccttctccgccctccatgacttccacggccacatcctggcccggacagaggagaacatcttcagccacctgcctctgcactcccagcacttgacccgtgccccatgtcccttgattcccatcggtgggatccagatggtgcaggcccggccaggagcccaccccaccctgctgccagggcccaccgcagcctgggtcagtggcttctccgggggtggcagcgacctgacaggggcccgggaggcccaggagcgaggccgctggagtcccactgagagctcgtcagcctccgtgtcgcctgtggctaaggtctccaaattcacactctcctcagagctggagggcagggactaccccaaggagagggagaggaccggcggaggcccgggcaggcctcctgactggacaccccatgggaccggggcacctgcagagcccacacccacgcacagcccctgcaccccacccgacaccttgccccggccgccccagggacgccgggcagcgcagtcctggagcccccgcttggagtccccgcgtgcaccggccaaccccgagccttctgccaccccgccgctggaccgcagcagctctgtgggctgcctggcagaggcctctgcccgcttcccagcccggacgaggaacctctccggggaatccaggaccaggcaggactcccccaagccctcaggaagtggggagcccagggcacatccacatcagcctgaggacagggttccccccaacgcttagcctctctccaactgcttcagcatctggcttccagtgtccagcaacagacgtttccagccactttcctcgaatcatcccacttcctcagccccatctgtccctccatccaggagctctcacggccccatctgttgtaccttcccatgtatgcagttacctgtgcctttttctacaccttttgttgcttaaaaagaaacaaaacaaatcacatacatacatttaaaaaaaaaacaacaacccacgaggagtctgaggctgtgaatagtttatggttttggggaaaggctgatggtgaagcctcctgaccctccccgctgtggttggcagccacccaccccagaggctggcagagggaaaggggtacactgagggagaaaggaaaaggaaacttcaaacaatatagaattaaatgtaaaaggcagcactcctgtgtacag

SEQ ID NO: 2 - protein, 2406 aa, Homo sapiens
MDPEQSVKGTKKAEGSPRKRLTKGEAIQTSVSSSVPYPGSGTAPTQESPAQELLAPQPFPGPSSVLREGSQEKTGQQQKPPKRPPIEASVHISHVPQHPLTPAFMSPGKPEHLLEGSTWQLVSPMRLGPSGSLLAPGLHPQSQLLPSHASIIPPEDLPGVPKVFVPRPSQVSLKPTEEAHKKERKPQKPGKYICQYCSRPCAKPSVLQKHIRSHTGERPYPCGPCGFSFKTKSNLYKHRKSHAHRIKAGLASGMGGEMYPHGLEMERIPGEEFEEPTEGESTDSEEETSATSGHPAELSPRPKQPLLSSGLYSSGSHSSSHERCSLSQSSTAQSLEDPPPFVEPSSEHPLSHKPEDTHTIKQKLALRLSERKKVIDEQAFLSPGSKGSTESGYFSRSESAEQQVSPPNTNAKSYAEIIFGKCGRIGQRTAMLTATSTQPLLPLSTEDKPSLVPLSVPRTQVIEHITKLITINEAVVDTSEIDSVKPRRSSLSRRSSMESPKSSLYREPLSSHSEKTKPEQSLLSLQHPPSTAPPVPLLRSHSMPSAACTISTPHHPFRGSYSFDDHITDSEALSRSSHVFTSHPRMLKPQPAIELPLGGEYSSEEPGPSSKDTASKPSDEVEPKESELTKKTKKGLKTKGVIYECNICGARYKKRDNYEAHKKYYCSELQIAKPISAGTHTSPEAEKSQIEHEPWSQMMHYKLGTTLELTPLRKRRKEKSLGDEEEPPAFESTKSQFGSPGPSDAARNLPLESTKSPAEPSKSVPSLEGPTGFQPRTPKPGSGSESGKERRTTSKEISVIQHTSSFEKSDSLEQPSGLEGEDKPLAQFPSPPPAPHGRSAHSLQPKLVRQPNIQVPEILVTEEPDRPDTEPEPPPKEPEKTEEFQWPQRSQTLAQLPAEKAPPKKKRLRLAEMAQSSGESSFESSVPLSRSPSQESNVSLSGSSRSASFERDDHGKAEAPDPSSDMRPKPLGTHMLTVPSHHPHAREMRRSASEQSPNVSHSAHMTETRSKSFDYGSLSLTGPSAPAPVAPPAGEAPPERRKCFLVRSPSLSRPPESELEVAPKGRQESEEPQPSSSKPSAKSSLSQISSAATSHGGPPGGKGPGQDRPALGPTVPYTEALQVFHHPVAQTPLHEKPYLPPPVSLFSFQHLVQHEPGQSPEFFSTQAMSSLLSSPYSMPPLPPSLFQAPPLPLQPTVLHPGQLHLPQLMPHPANIPFRQPPSFLPMPYPTSSALSSGFFLPLQSQFALQLPGDVESHLPQIKTSLAPLATGSAGLSPSQEYSSDIRLPPVAPPASSSAPTSAPPLALPACPDTMVSLVVPVRVQTNMPSYGSAMYTTLSQILVTQSQGSSATVALPKFEEPPSKGTTVCGADVHEVGPGPSGLSEEQSRAFPTPYLRVPVTLPERKGTSLSSESILSLEGSSSTAGGSKRVLSPAGSLELTMETQQQKRVKEEEASKADEKLELVKPCSVVLTSTEDGKRPEKSHLGNQGQGRRELEMLSSLSSDPSDTKEIPPLPHPALSHGQAPGSEALKEYPQPSGKPHRRGLTPLSVKKEDSKEQPDLPSLAPPSSLPLSETSSRPAKSQEGTDSKKVLQFPSLHTTTNVSWCYLNYIKPNHIQHADRRSSVYAGWCISLYNPNLPGVSTKAALSLLRSKQKVSKETYTMATAPHPEAGRLVPSSSRKPRMTEVHLPSLVSPEGQKDLARVEKEEERRGEPEEDAPASQRGEPARIKIFEGGYKSNEEYVYVRGRGRGKYVCEECGIRCKKPSMLKKHIRTHTDVRPYVCKHCHFAFKTKGNLTKHMKSKAHSKKCQETGVLEELEAEEGTSDDLFQDSEGREGSEAVEEHQFSDLEDSDSDSDLDEDEDEDEEESQDELSRPSSEAPPPGPPHALRADSSPILGPQPPDAPASGTEATRGSSVSEAERLTASSCSMSSQSMPGLPWLGPAPLGSVEKDTGSALSYKPVSPRRPWSPSKEAGSRPPLARKHSLTKNDSSPQRCSPAREPQASAPSPPGLHVDPGRGMGPLPCGSPRLQLSPLTLCPLGRELAPRAHVLSKLEGTTDPGLPRYSPTRRWSPGQAESPPRSAPPGKWALAGPGSPSAGEHGPGLGLAPRVLFPPAPLPHKLLSRSPETCASPWQKAESRSPSCSPGPAHPLSSRPFSALHDFHGHILARTEENIFSHLPLHSQHLTRAPCPLIPIGGIQMVQARPGAHPTLLPGPTAAWVSGFSGGGSDLTGAREAQERGRWSPTESSSASVSPVAKVSKFTLSSELEGRDYPKERERTGGGPGRPPDWTPHGTGAPAEPTPTHSPCTPPDTLPRPPQGRRAAQSWSPRLESPRAPANPEPSATPPLDRSSSVGCLAEASARFPARTRNLSGESRTRQDSPKPSGSGEPRAHPHQPEDRVPPNA